(19) United States
(12) Patent Application Publication
(10) Pub. No.: US 2025/0354037 A1
(43) Pub. Date: Nov. 20, 2025

(54) METHODS, SYSTEMS, DEVICES AND KITS FOR FORMULATING STRUCTURAL ADHESIVES

(71) Applicant: 3M INNOVATIVE PROPERTIES COMPANY, St. Paul, MN (US)

(72) Inventors: James J. Kobe, Goodyear, AZ (US); Adrain T. Jung, Kaarst (DE); Rolf W. Biernath, Wyoming, MN (US); Brianna L. McCord, Shoreview, MN (US)

(21) Appl. No.: 18/717,207

(22) PCT Filed: Dec. 7, 2022
(86) PCT No.: PCT/IB2022/061896

§ 371 Date: Jun. 6, 2024

Related U.S. Application Data
(60) Provisional application No. 63/265,209, filed on Dec. 10, 2021.

(51) Int. Cl. C09J 163/00; C08G 59/24; C08G 59/42; C08G 59/50; C08G 59/58; C09J 5/00

(52) U.S. Cl. CPC C09J 163/00; C08G 59/245; C08G 59/4207; C08G 59/4223; C08G 59/4284; C08G 59/5073; C08G 59/58; C09J 5/00

(57) ABSTRACT

Methods of tuning one or more properties of a multipart structural adhesive composition, the method including providing a Part 1 of the multipart structural adhesive; providing at least a first sub-Part 2 and a second sub-Part 2 of the multipart structural adhesive; and causing to be formed the multipart structural adhesive by combining the Part 1, the first sub-Part 2, and the second sub-Part 2, wherein the amount, ratio, or both of the first sub-part 2 and the second sub-Part 2 impact the one or more properties of the multipart structural adhesive composition, wherein the amounts or ratios of the Part 1, the first sub-Part 2 and the second sub-Part 2 affect the one or more properties of the multipart structural adhesive composition, and wherein the multipart structural adhesive has an overlap shear strength of at least about 0.75 MPa (109 psi).

### BACKGROUND

Systems for dispensing adhesives typically include an inlet or internal area for holding the adhesive, and an output or tip through which adhesive is dispensed to a surface. The flow rate of the adhesive can be directly controlled to meet needs of downstream manufacturing processes by using metering systems. Many systems dispense multiple components that mix together in a mixing chamber.

### SUMMARY

The standard approach to providing structural adhesives to customers today is to provide a fairly vast array of structural adhesives that have very specifically chosen properties based on relatively precise requirements provided by the customer. This approach results in a very large amount of specific multipart structural adhesives in inventories (which requires more room for inventories of products, knowledge about which adhesive number provides which properties, more cost, more types, etc.), the need to verify and qualify properties on a large number of specific structural adhesives, the need for customers to understand slight differences in the specific structural adhesives within a portfolio of structural adhesives, etc. Therefore, there remains a need for a basic rethinking of how structural adhesives can be provided to customers.

Disclosed herein are methods of tuning one or more properties of a multipart structural adhesive composition and systems and devices for making and utilizing such multipart structural adhesives.

Disclosed herein are methods of tuning one or more properties of a multipart structural adhesive composition, the method comprising: providing a Part 1 of the multipart structural adhesive; providing at least a first sub-Part 2 and a second sub-Part 2 of the multipart structural adhesive; and causing to be formed the multipart structural adhesive by combining the Part 1, the first sub-Part 2, and the second sub-Part 2, wherein the amount or ratio of the first sub-Part 2 and the second sub-Part 2 impact the one or more properties of the multipart structural adhesive composition, and wherein the multipart structural adhesive has an overlap shear strength of at least about 0.75 MPa (109 psi).

The methods, systems and devices disclosed herein can be utilized to impact one or more of a multitude of different properties, including for example, work life, pot life, rate of strength build up, structural strength, overlap shear strength, adhesion, elongation, creep resistance, impact resistance, temperature performance, moisture resistance, color, and other physical properties.

Disclosed herein are systems and devices for dispensing adhesives.

Disclosed herein are systems for dispensing an adhesive, the system comprising: a chamber that holds at least two flexible containment vessels, the at least two flexible containment vessels holding at least a Part 1 and a Part 2; at least two adhesive delivery channels, a first adhesive delivery channel connected to the containment vessel to receive Part 1 and a second adhesive delivery channel connected to the containment vessel to receive Part 2; a motor; at least a first variable positive displacement pump wherein the first variable positive displacement pump is actuated by the motor; and a mixing tip designed to receive Part 1 and Part 2 from the at least two adhesive delivery channels, mix at least Part 1 and Part 2 together and dispense the adhesive through a dispensing end, wherein when in operation, the at least Part 1, Part 2, or mixtures thereof are only in contact with the at least two flexible containment vessels, the at least two adhesive delivery channels and the mixing tip, wherein the at least one variable positive displacement pump forces the at least Part 1 and at least Part 2 respectively through the first adhesive delivery channel and the second adhesive delivery channel to the dispensing end of the mixing tip.

Disclosed herein are kits for dispensing multipart structural adhesives, the kit comprising: a system according to any of the preceding Embodiments; and at least a first flexible containment vessel holding a Part 1 composition and a second flexible containment vessel holding a Part 2 composition of a multipart structural adhesive, wherein the amounts, ratios, or both of the Part 1 and the Part 2 are controlled by the dispenser, and wherein the amounts, ratios, or both of the Part 1, and the Part 2 affect one or more properties of the multipart structural adhesive composition.

Throughout this disclosure, singular forms such as “a,” “an,” and “the” are often used for convenience; however, the singular forms are meant to include the plural unless the singular alone is explicitly specified or is clearly indicated by the context. When the singular alone is called for, the term “one and only one” is typically used.

Terms indicating a high frequency, such as (but not limited to) “common,” “typical,” and “usual,” as well as “commonly,” “typically,” and “usually” are used herein to refer to features that are often employed in the disclosure and, unless specifically used with reference to the prior art, are not intended to mean that the features are present in the prior art, much less that those features are common, usual, or typical in the prior art.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other claims may also be preferred, under the same or other circumstances. Furthermore, the recitation of one or more preferred claims does not imply that other claims are not useful and is not intended to exclude other claims from the scope of the disclosure.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

The term “in the range” or “within a range” (and similar statements) includes the endpoints of the stated range.

As used herein, the term “room temperature” refers to a temperature of about 20° C. (68° F.) to about 25° C. (77° F.) or about 22° C. (68° F.) to about 25° C. (77° F.).

Groupings of alternative elements or embodiments disclosed herein are not to be construed as limitations. Each group member may be referred to and claimed individually or in any combination with other members of the group or other elements found therein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the invention. Thus, the appearances of such phrases in various places throughout this specification are not necessarily referring to the same embodiment of the invention. Furthermore, the particular features, configurations, compositions, or characteristics may be combined in any suitable manner in one or more embodiments.

The above summary of the present disclosure is not intended to describe each disclosed embodiment or every implementation of the present invention. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF THE DRAWINGS

FIG. 1 is a schematic depiction of a flow diagram for the addition of a second mixing station to an in-line adhesive mixing system.

FIG. 2 is a depiction of a system that includes a controller, pumps and mixing nozzle for formation of a structural adhesive using a disclosed method or system.

FIG. 3 is a sectional view and circuit diagram of elements of a property sensor according to the present disclosure.

FIG. 4 is a sectional view and circuit diagram of elements of an alternative property sensor according to the present disclosure.

FIG. 5 is a side view of a property sensor according to the present disclosure, mounted to a dispenser and mixer.

FIG. 6 is a perspective view of a duct piece containing channel and electrodes of a property sensor according to the present disclosure.

FIG. 7 is a perspective cut-away view of the duct piece of FIG. 6.

FIGS. 8A-8B illustrate a single PCB material measurement flow sensor in accordance with embodiments herein.

FIGS. 9A-9B illustrate a sensor arrangement in an adhesive dispenser in accordance with embodiments herein.

FIG. 10 illustrates a method of forming a sensor system in accordance with embodiments herein.

FIG. 11 illustrates a method of removing an entrained air bubble from a fluid line in accordance with embodiments herein.

FIG. 12 illustrates a material characterization system in which example embodiments can be implemented.

FIGS. 13A-13C illustrates a material characterization system in which example embodiments can be implemented.

FIGS. 14-15 illustrate example conductivity signals that may be received from embodiments herein.

FIGS. 16A-16B illustrates an example system for detecting entrained air in a material dispensing system in accordance with embodiments herein.

FIGS. 17A-17F illustrate a stack of PCB electrodes in accordance with an embodiment herein.

FIG. 18A-18B illustrate an example of batch detail detection for a material dispensing system.

FIG. 19 illustrates a method of using a material measurement flow sensor in accordance with embodiments herein.

FIG. 20 illustrates a dispensing system in which example embodiments can be implemented.

FIG. 21 is a cross sectional view of a disclosed chamber that includes two flexible containment vessels.

FIG. 22 is a perspective view of a disclosed chamber that includes two flexible containment vessels.

FIG. 23 is a perspective view of a portion of a disclosed device that includes a single motor and a single pump.

FIGS. 24A, 24B, and 24C are an end on view (FIG. 24A) of the camshaft in an illustrative linear peristaltic pump; a perspective view (FIG. 24B) of the camshaft; and a cut out view (FIG. 24C) of the camshaft and disks in the housing of the illustrative linear peristaltic pump.

FIGS. 25A-25B are perspective views of the tubing of a fluid delivery channel with a compressive element not applying pressure (FIG. 25A) and applying pressure (FIG. 25B) on the tubing.

FIGS. 26A-26C are perspective and end on views (FIG. 26A) of a linear peristaltic pump housing and inner components that includes a tube having rigid members that interact with both the actuating element and the housing; the tube (FIG. 26B) having rigid members; and a cut out view of the linear peristaltic pump acting upon the tubing (FIG. 26C).

FIGS. 27A-27C are a cut out view (FIG. 27A) of a linear peristaltic pump housing and inner components that includes a tube including a flexible membrane and a rigid plate that interact with both the actuating element and the housing; a perspective view (FIG. 27B) of the linear peristaltic pump in its housing; and a cut out view of the linear peristaltic pump acting upon the tubing (FIG. 27C).

FIG. 28 is a perspective partial exposed view of an illustrative handheld device disclosed herein.

FIGS. 29A-29C are a perspective partial exposed view (FIG. 29A) of an illustrative handheld device disclosed herein; a partial cut out view of the same (FIG. 29B); and a partial cut out of the grip of the same (FIG. 29C).

### DETAILED DESCRIPTION

This invention describes methods, systems and devices for customizing properties of structural adhesives. An illustrative example of one property that can be controlled, customized, or both using methods, systems and devices includes work life. The typical work life for a two-part epoxy adhesive (it should be noted that work life and a two-part epoxy adhesive are both being utilized here for the purpose of this discussion, and in no way is meant to limit the scope of the present disclosure) can range between a few minutes up to an hour or more. The work life (WL) also correlates with the time to handling strength.

As a point of comparison, prior to the instant disclosure, two-part structural adhesives would have been provided as a system having a specific Part A and a specific Part B that would have been formulated to provide a desired WL. Part B, known as the hardener, can be formulated, and supplied with a specific catalyst, accelerator, as well as other components at a level which determines and controls the WL. Manufacturers can formulate Part B to provide a specific WL, and a dual cartridge system, for example, may be utilized to formulate the Part A and Part B into a structural adhesive. Each desired WL would have required a different two-part structural adhesive combination to be purchased, stored, and inventories thereof maintained.

The instant disclosure is based on formulating two Part Bs with different work lives and using equipment technology and standard adhesive components to customize the two-part work life for an application. The concept involves adding a volumetric dispensing and mixing station for two Part Bs with different work life to an automated dispensing line. In some embodiments, it only requires providing Part B with two levels: one each with a short WL and one with a long WL. Part B having a desired WL can be formulated by choosing the correct catalyst, accelerator, amounts thereof, or combinations thereof depending upon the adhesive system. For example, a higher catalyst or accelerator level can provide a short work life whereas a lower level provides a long work life. Current volumetric dispensing equipment and mixing technology can provide very precise and controlled quantities of two components—i.e. Part A and Part B. Based on this, it is possible to accurately blend two Part Bs to form a desired structural adhesive to provide a specific WL.

This invention has the potential to improve and control the mixed Pot Life, Open Time, Work Life and Cure Time which all contribute to an important Step “Open Time Requirement” in the Automated Assembly Process. The Open Time and Work Life of a structural adhesive can be critical to optimizing the process efficiency so that the product can be assembled in the desired time without extending the handling time. It also has the potential to optimize the Pot Life and decrease associated waste due to adhesive set up in the pot and static mixer.

One advantage to utilizing methods, systems, devices, and kits disclosed herein are that adhesive suppliers can make and supply less formulations. For example, in some embodiments, a supplier need only make two Part Bs-one with a short WL and one with a long WL—and an adhesive portfolio having a variable work like can be provided, instead of having to make and provide an infinite number of Part B compositions. Disclosed methods, systems and devices also allow the customer to better optimize the work life for their specific process and volume of parts. As such, disclosed methods, systems, devices, and kits should minimize process waste and ultimately lower the customer's cost for the relatively expensive adhesive and related disposable static mixer waste.

### Multipart Structural Adhesives

Disclosed herein are methods, systems, devices and structural adhesives that can include what are referred to herein as multipart adhesives or multipart structural adhesives. Multipart, as used herein can refer to any final adhesive that is formed by a user or applicator (e.g., anyone that is going to be using the adhesive) by combining two or more parts, e.g., two parts, three parts, four parts, five parts, etc., As such, multipart adhesives can include two-part adhesives, three-part adhesives, four-part adhesives, etc. It is noted that two-part adhesives can also be referred to in the industry as 2K adhesives.

In order to more conveniently and clearly refer to components making up a multipart adhesive, the phrases “Part 1”, “Part 2”, “Part 3”, etc. will be used herein. It is noted that nothing is meant or to be implied by referring to a component as Part 1 versus Part 2—for example, order of mixing is not meant and/or not meant to be implied by referring to a component as Part 1 versus Part 2.

Any “Part” may be composed of or formed by combining portions of that part. In order to more conveniently and clearly refer to such portions of parts, the phrase sub-Part will be used herein. Additionally, because more than one component can be composed of or formed by combining more than one portion of that part, in order to more conveniently and clearly refer to such portions, the phrases “first sub-Part 1”, “second sub-Part 1”, “third sub-Part 1”, and etc. will be used herein. In instances where two (or more) components can both (or all) be composed of or formed by combining more than one portion of that component, the phrases “first sub-Part 1”, “second sub-Part 1”, “third sub-Part 1”, and etc.; and “first sub-Part 2”, “second sub-Part 2”, “third sub-Part 2”, and etc. can be utilized at the same time. It is noted that nothing is meant or to be implied by referring to a component as first sub-Part 1 versus second sub-Part 1—for example, order of mixing is not meant and/or not meant to be implied by referring to a sub-Part of a component as first versus second.

In some embodiments, the amounts of the two (or more) Parts, the ratio of the two (or more) Parts, or both can be utilized to impact one or more specifically noted properties of the multipart adhesive being formed. The ratio of the two Parts can also be referred to as the mix ratio. It is to be noted that the two Parts may both be made of sub parts as well.

In some embodiments, at least one of Part 1, Part 2, or etc. is composed of or formed by combining more than one portion of that part. The amounts of the at least two sub-Parts, the ratios of the at least two sub-Parts, or both can be utilized to impact the one or more specifically noted property of the multipart adhesive being formulated.

Generally, the amounts of any of the components described herein (e.g., Parts or sub-Parts) are utilized in stoichiometric ratios based on the adhesive chemistry, the desired properties, other factors, or combinations thereof.

Structural adhesives or structural adhesive compositions as disclosed herein can include adhesive compositions that can be categorized as structural adhesives, semi-structural adhesives, or both.

“Structural adhesive” as used herein means an adhesive that binds by irreversible cure, typically with a strength when bound to its intended substrates, measured as stress at break (peak stress) using the overlap shear test described in the Examples herein, of at least 4.14 MPa (600 psi), more typically at least 5.52 MPa (800 psi), in some embodiments at least 6.89 MPa (1000 psi), and in some embodiments at least 8.27 MPa (1200 psi). Additionally, in some embodiments, these adhesives may provide at least one of 1) an overlap shear value of >5 MPa (>725 psi), 2) a cleavage value (plastic to glass of >40 N (>9.0 lbf), and 3) a creep of <500% strain, using the test methods described herein.

“Semi-structural Adhesive” refers to a cured adhesive having an overlap shear strength of at least about 0.75 MPa (109 psi), more preferably at least about 1.0 MPa (145 psi), and most preferably at least about 1.5 MPa (218 psi). However, these cured adhesives with particularly high overlap shear strength are called structural adhesives. Additionally, in some embodiments, these adhesives may provide at least one of 1) an overlap shear value of >5 MPa (>725 psi), 2) a cleavage value (plastic to glass of >40 N (>9.0 lbf), and 3) a creep of <500% strain, using the test methods described herein.

Structural adhesive compositions may be useful in many bonding applications. For example, structural adhesive compositions may be used to replace or augment conventional joining techniques such as welding or the use of mechanical fasteners such as nuts and bolts, screws, rivets, and the like.

### One or More Properties

Structural adhesive compositions can be characterized by any of a number of properties. In some embodiments, one or more than one property can be modified or tuned using disclosed methods, systems and devices. Illustrative properties that can be modified or tuned using disclosed methods, systems and devices can include for example work life, shelf life, pot life, gel time, rate of strength build up, elastic modulus (i.e., modulus of elasticity), elongation, bond strength (e.g., adhesion, peel strength, overlap shear strength, or impact strength), handling strength, structural strength, creep resistance, impact resistance, temperature performance, moisture resistance, color, and other physical properties.

As used herein, “gel time” refers to the time required for the mixed components to reach the gel point. As used herein, the “gel point” is the point where the mixture's storage modulus exceeds its loss modulus.

Generally, the bond strength (e.g., peel strength, overlap shear strength, or impact strength) of a structural adhesive continues to build well after the initial cure time. For example, it may take hours or even days for the adhesive to reach its ultimate strength.

“Handling strength” refers to the ability of the adhesive to cure to the point where the bonded parts can be handled in subsequent operations without destroying the bond. The required handling strength varies by application. As used herein, “initial cure time” refers to the time required for the mixed components to reach an overlap shear adhesion of 0.34 MPa (50 psi); which is a typical handling strength target. Generally, the initial cure time correlates with the gel time; i.e., shorter gel times typically indicate adhesives with shorter initial cure times.

The “pot life” refers to the amount of time it takes for the product's initial mixed viscosity to double. A product's pot life is dramatically different than its shelf life. Of course, this test has several variations that can occur, including the mass of the product and the temperature at which the test is conducted. Simply put, this is the length of time in which adhesives or coatings can be applied on a surface. Pot life begins when the mixing is complete and ends when the mix is unsuitable for application. Failure in pot life is due to inadequate mixing of the product or if the material sits for too long after mixing. Pot life also depends on different materials being bonded. Knowing the pot life of a product is useful for scenarios in which an adhesive must be mixed and let sit for a certain amount of time before application. This will impact the speed at which a project can be completed. The pot life is the amount of time you have after mixing to use the epoxy before it has doubled in viscosity—or simply how long you can leave it in the pot before use.

The “working life” or “work life” (which is also referred to as WL) of a product is the amount of time the viscosity stays low enough to be applied to a surface with accuracy before it begins to cure. Again, this depends on a multitude of factors, such as temperature, sun exposure, humidity levels, and more. The WL of a mixed Epoxy Adhesive can be increased or decreased with Temperature. Higher temperatures accelerate the cure and colder temperatures will slow the cure. In many applications, this isn't a practical way to control WL.

The “Shelf life” of a product is the period of time before the performance of the product falls under the values provided in the technical data sheet (TDS) for at least one of the critical values.

The modulus of elasticity of the cured adhesive is typically at least 100 MPa (14,500 psi). In some embodiments, the elastic modulus is 200 MPa (29,010 psi), or 300 MPa (43,510 psi), or 400 MPa (58,020 psi), or 500 MPa (72,520 psi) or greater. The elastic modulus is typically below 2000 MPa (290,080 psi). It is speculated that the elastic modulus (E′) at 25° C. (77° F.) is at least in part related to the maintenance and/or penetration of the luminance by aging.

In some embodiments, the average toughness at 25° C. (77° F.) and at a strain rate of 3%/min is typically greater than 1 MJ/m³. In some embodiments, the average toughness is 2, or 3, or 4, or 5 MJ/m³. The average toughness is typically less than 15 MJ/m³.

In some embodiments, the elongation of the cured adhesive composition is assumed to be at least in part related to the peel strength. In some embodiments, the average elongation at break at a strain rate of 25/minute and 3%/min is 15% or 20% or more, and in some embodiments, 25% or more, 50% or more, or about 100% or more. The average elongation at break is typically less than 300%.

The Shear Strength of a cured adhesive can be measured using the test method described in ASTM D 1002. Testing can be carried out by pulling the two ends of the overlap in tension causing the adhesive to be stressed in shear. Two variations can also be used: ASTM D 3165 and ASTM D 3528. Compression shear tests can also be utilized. ASTM D 2182 describes a compression specimen geometry and the compression shear test apparatus.

The creep resistance refers to the resistance to dimensional change occurring in a stressed adhesive over a long time period. With weak adhesives, creep may be so extensive that bond failure occurs premature. Creep testing can be done by loading a specimen with a pre-determined stress and measuring the total deformation as a function of time or measuring the time necessary for complete failure of the specimen. In some instances, the creep resistance of a cured adhesive can be measured using ASTM D 2294.

In some embodiments, the impact resistance of the cured adhesive can be determined. In some instances, the impact resistance can be determined by using ASTM D 950.

The temperature performance of a cured adhesive can be measured using ASTM C 920, which requires a maximum percentage of weight loss of 10-12% after heat aging for two weeks at 158° F. (70° C.). The conditioning generally specified is the application of accumulated time at temperature expected in service.

The moisture resistance of a cured adhesive can be measured using water immersion of the specimens. Generally, three weeks if the time period recommended for most immersion testing. ASTM D 1151 can be utilized to measure moisture resistance.

### Useful Multipart Structural Adhesives

Generally, structural adhesives may be divided into two broad categories: one-part adhesives and two-part adhesives. With a one-part adhesive, a single composition comprises all the materials necessary to obtain a final cured adhesive. Such adhesives are typically applied to the substrates to be bonded and exposed to elevated temperatures (e.g., temperatures greater than 50° C. (122° F.) to cure the adhesive. In contrast, two-part adhesives comprise two components. The first component, typically referred to as the “base resin component,” comprises the curable resin. The second component, typically referred to as the “accelerator component,” comprises the curing agent(s) and catalysts. Various other additives may be included in one or both components. In some embodiments, one-part adhesives are not included in the methods, systems and devices disclosed herein.

Two component adhesives are 100% solids systems that obtain their storage stability by separating the reactive components. They are supplied as “resin” and “hardener” in separate containers. It is important to maintain the prescribed ratio of the resin and hardener in order to obtain the desired cure and physical properties of the adhesive. The two components are only mixed together to form the adhesive a short time before application with cure occurring at room temperature. Since the reaction typically begins immediately upon mixing the two components, the viscosity of the mixed adhesive increases with time until the adhesive can no longer be applied to the substrate or bond strength is decreased due to diminished wetting of the substrate. Formulations are available with a variety of cure speeds providing various working times (work life) after mixing and rates of strength build-up after bonding. Final strength is reached in minutes to weeks after bonding depending on the formulation. Adhesive must be cleaned from mixing and application equipment before cure has progressed to the point where the adhesive is no longer soluble. Depending on work life, two component adhesives can be applied by trowel, bead or ribbon, spray, or roller. Assemblies are usually fixtured until sufficient strength is obtained to allow further processing. If faster rate of cure (strength build-up) is desired, heat can be used to accelerate the cure. This is particularly useful when parts need to be processed more quickly after bonding or additional work life is needed but a slower rate of strength build-up cannot be accommodated. When cured, two component adhesives are typically tough and rigid with good temperature and chemical resistance.

Two component adhesives can be mixed and applied by hand for small applications. However, this requires considerable care to ensure proper ratio of the components and sufficient mixing to insure proper cure and performance. There is usually considerable waste involved in hand mixing as well. As a result, adhesive suppliers have developed packaging that allows the components to remain separate for storage and also provides a means for dispensing mixed adhesive, e.g. side-by-side syringes, concentric cartridges. The package is typically inserted into an applicator handle and the adhesive is dispensed through a disposable mixing nozzle. The proper ratio of components is maintained by virtue of the design of the package and proper mixing is insured by use of the mixing nozzle. Adhesive can be dispensed from these packages multiple times provided the time between uses does not exceed the work life of the adhesive. If the work life is exceeded, a new mixing nozzle must be used. For larger applications, meter-mix equipment is available to meter, mix, and dispense adhesive packaged in containers ranging from quarts to drums.

Two-part adhesives consist of a resin and a hardener component which cure once the two components are mixed together. They remain stable in storage as long as the two components are separate from each other. Two-part adhesives are typically designed to be dispensed in a set ratio to gain the desired properties from the specifically formulated adhesive; common ratios include, 10:1, 2:1, 1:1 and so on. The reaction between the two components normally begins immediately once they are mixed and the viscosity increases until they are no longer usable. This can be described as work life, open time and pot life, as discussed above. Once cured, two component adhesives are tough and rigid with good temperature and chemical resistance.

### Two Part Epoxy Adhesives

Like their one-part cousins, two-part epoxies are formulated from epoxy resins. Two-part epoxies are widely used in structural applications and are used to bond many materials including, for example: metal, plastic, fiber reinforced plastics (FRP), glass and some rubbers. They are generally fast to cure and provide a relatively rigid bond. Some compositions can often be brittle although toughening agents and elastomers can be utilized to reduce this tendency.

Two-part structural epoxy adhesives are made up of a Resin (Part A or Part 1) and Hardener (Part B or Part 2). An accelerator or chemical catalyst can speed up the reaction between the resin and hardener.

A two-part epoxy can cure at room temperature, so heat is not necessarily required when using one. Two-part epoxies generally achieve handling strength anywhere between five minutes and eight hours after mixing, depending on the curing agents. A chemical catalyst or heat can be applied to speed the reaction between the resin and hardener.

The resin that is the basis for many epoxies is the diglycidyl ether of bisphenol A (DGEBA). Bisphenol A is produced by reacting phenol with acetone under suitable conditions. The “A” stands for acetone, “phenyl” means phenol groups and “bis” means two. Thus, bisphenol A is the product made from chemically combining two phenols with one acetone. Unreacted acetone and phenol are stripped from the bisphenol A, which is then reacted with a material called epichlorohydrin. This reaction sticks the two (“di”) glycidyl groups on ends of the bisphenol A molecule. The resultant product is the diglycidyl ether of bisphenol A, or the basic epoxy resin. It is these glycidyl groups that react with the amine hydrogen atoms on hardeners to produce the cured epoxy resin. Unmodified liquid epoxy resin is very viscous and unsuitable for most uses except as a very thick glue.

Chemical raw materials used to manufacture curing agents, or hardeners, for room-temperature cured epoxy resins are most commonly polyamines. They are organic molecules containing two or more amine groups. Amine groups are not unlike ammonia in structure except that they are attached to organic molecules. Like ammonia, amines are strongly alkaline. Because of this similarity, epoxy resin hardeners often have an ammonia-like odor, most notable in the air space in containers right after they are opened.

Reactive amine groups are nitrogen atoms with one or two hydrogen atoms attached to the nitrogen. These hydrogen atoms react with oxygen atoms from glycidyl groups on the epoxy to form the cured resin—a highly crosslinked thermoset plastic. Heat will soften, but not melt, a cured epoxy. The three-dimensional structure gives the cured resin excellent physical properties.

The ratio of the glycidyl oxygens to the amine hydrogens, taking into account the various molecular weights and densities involved, determines the final resin to hardener ratio. The proper ratio produces a “fully-crosslinked” thermoset plastic. Varying the recommended ratio will leave either unreacted oxygen or hydrogen atoms depending upon which is in excess. The resultant cured resin will have lower strength, as it is not as completely crosslinked. Excess Part B results in an increase in moisture sensitivity in the cured epoxy and generally should be avoided.

Amine hardeners are not “catalysts”. Catalysts promote reactions but do not chemically become a part of the finished product. Amine hardeners mate with the epoxy resin, greatly contributing to the ultimate properties of the cured system. Cure time of an epoxy system is dependent upon the reactivity of the amine hydrogen atoms. While the attached organic molecule takes no direct part in the chemical reaction, it does influence how readily the amine hydrogen atoms leave the nitrogen and react with the glycidyl oxygen atom. Thus, cure time is set by the kinetics of the particular amine used in the hardener. Cure time for any given epoxy system can only be altered by adding an accelerator in systems that can accommodate one, or by changing the temperature and mass of the resin/hardener mix. Adding more hardener will not “speed things up” and adding less will not “slow things down”.

The epoxy curing reaction is exothermic. The rate at which an epoxy resin cures is dependent upon the curing temperature. The warmer it is the faster it goes. The cure rate will vary by about half or double with each 18° F. (10° C.) change in temperature. For example, if an epoxy system takes 3 hours to become tack free at 21° C. (70° F.), it will be tack free in 1.5 hours at 31° C. (88° F.) or tack free in 6 hours at 11° C. (52° F.). Everything to do with the speed of the reaction follows this general rule. Pot life and working time are greatly influenced by the initial temperature of the mixed resin and hardener. On a hot day for example, the two materials can be cooled before mixing in order to increase the working time.

The gel time of the resin is the time it takes for a given mass held in a compact volume to solidify. Gel time depends on the initial temperature of the mass and follows the above rule. One hundred grams (about three fluid ounces) of Silver Tip Laminating Epoxy with Fast Hardener (as an illustrative example) will solidify in 25 minutes starting at 25° C. (77° F.); at 15.6° C. (60° F.) the gel time is about 50 minutes. If the same mass were spread over 4 square feet at 25° C. (77° F.) the gel time would be a little over three hours. Cure time is surface area/mass sensitive in addition to being temperature sensitive.

As the reaction proceeds it gives off heat. If the heat generated is immediately dissipated to the environment (as occurs in thin films) the temperature of the curing resin does not rise and the reaction speed proceeds at a uniform pace. If the resin is confined (as in a mixing pot) the exothermic reaction raises the temperature of the mixture, accelerating the reaction.

Working time or Work Life (WL) of an epoxy formulation is about 75% of the gel time for the geometry of the pot. It can be lengthened by increasing the surface area, working with a smaller mass, or cooling the resin and hardener prior to mixing. Material left in the pot will increase in absolute viscosity (measured at 24° C. (75° F.), for example) due to polymerization but initially decrease in apparent viscosity due to heating. Material left in the pot to 75% of gel time may appear quite thin (due to heating) but will actually be quite thick when cooled to room temperature. Experienced users either mix batches that will be applied almost immediately or increase the surface area to slow the reaction.

Although the cure rate of an epoxy is dependent upon temperature, the curing mechanism is independent of temperature. The reaction proceeds most quickly in the liquid state. As the cure proceeds, the system changes from a liquid to a sticky, viscous, soft gel. After gelation the reaction speed slows down as hardness increases. Chemical reactions proceed more slowly in the solid state. From the soft sticky gel the system gets harder, slowly losing its stickiness. It becomes tack free and continues to become harder and stronger as time passes.

At normal temperatures the system will reach about 60 to 80% of ultimate strength after 24 hours. Curing then proceeds slowly over the next several weeks, finally reaching a point where no further curing will occur without a significant increase in temperature. However, for most purposes room temperature cured systems can be considered fully cured after 72 hours at 25° C. (77° F.). High modulus systems like Phase Two epoxy, for example, must be post-cured at elevated temperatures to reach full cure.

It is usually more efficient to work with as fast a cure time as practical for the application at hand if the particular system being used offers this choice. This allows the user to move along to the next phase without wasting time waiting for the epoxy to cure. Faster curing films with shorter tack times will have less chance to pick up fly tracks, bugs, and other airborne contaminants.

Epoxy resin compositions generally comprise a first liquid part comprising an epoxy resin and a second liquid part comprising a curing agent. Although the first and second part are liquids at ambient temperature, the liquid parts can comprise solid components dissolved or dispersed within the liquid.

The first part of the two-part composition comprises at least one epoxy resin. Epoxy resins are low molecular weight monomers or higher molecular weight polymers which typically contain at least two epoxide groups. An epoxide group is a cyclic ether with three ring atoms, also sometimes referred to as a glycidyl or oxirane group. Epoxy resins are typically liquids at ambient temperature.

Various epoxy resins are known including for example a bisphenol A type epoxy resin, a bisphenol F type epoxy resin, a bisphenol S type epoxy resin, a phenol novolac type epoxy resin, an alkyl phenol novolac type epoxy resin, a cresol novolac type epoxy resin, a biphenyl type epoxy resin, an aralkyl type epoxy resin, a cyclopentadiene type epoxy resin, a naphthalene type epoxy resin, a naphthol type epoxy resin, an epoxy resin of condensate of phenol and aromatic aldehyde having a phenolic hydroxy group, a biphenyl aralkyl type epoxy resin, a fluorene type epoxy resin, a Xanthene type epoxy resin, a triglycidyl isocianurate, a rubber modified epoxy resin, a phosphorous based epoxy resin, and the like.

Blends of various epoxy-containing materials can also be utilized. Suitable blends can include two or more weight average molecular weight distributions of epoxy-containing compounds such as low molecular weight epoxides (e.g., having a weight average molecular weight below 200 g/mole), intermediate molecular weight epoxides (e.g., having a weight average molecular weight in the range of about 200 to 1000 g/mole), and higher molecular weight epoxides (e.g., having a weight average molecular weight above about 1000 g/mole). Alternatively, or additionally, the epoxy resin can contain a blend of epoxy-containing materials having different chemical natures such as aliphatic and aromatic or different functionalities such as polar and nonpolar.

In one embodiment, the first part of the two-part composition comprises at least one bisphenol (e.g., A) epoxy resin. Bisphenol (e.g., A) epoxy resins are formed from reacting epichlorohydrin with bisphenol A to form diglycidyl ethers of bisphenol A. The simplest resin of this class is formed from reacting two moles of epichlorohydrin with one mole of bisphenol A to form the bisphenol A diglycidyl ether (commonly abbreviated to DGEBA or BADGE). DGEBA resins are transparent colorless-to-pale-yellow liquids at ambient temperature, with viscosity typically in the range of 5-15 Pa's at 25° C. (77° F.). Industrial grades normally contain some distribution of molecular weight, since pure DGEBA shows a strong tendency to form a crystalline solid upon storage at ambient temperature. This same reaction can be conducted with other bisphenols, such as bisphenol F. The choice of the epoxy resin used depends upon the end use for which it is intended. Epoxides with flexibilized backbones may be desired where a greater amount of ductility is needed in the bond line. Materials such as diglycidyl ethers of bisphenol A and diglycidyl ethers of bisphenol F can provide desirable structural adhesive properties that these materials attain upon curing, while hydrogenated versions of these epoxies may be useful for compatibility with substrates having oily surfaces.

Aromatic epoxy resins can also be prepared by reaction of aromatic alcohols such as biphenyl diols and triphenyl diols and triols with epichlorohydrin. Such aromatic biphenyl and triphenyl epoxy resins are not bisphenol epoxy resins.

There are two primary types of aliphatic epoxy resins, i.e. glycidyl epoxy resins and cycloaliphatic epoxides. Glycidyl epoxy resins are typically formed by the reaction of epichlorohydrin with aliphatic alcohols or polyols to give glycidyl ethers or aliphatic carboxylic acids to give glycidyl esters. The resulting resins may be monofunctional (e.g., dodecanol glycidyl ether), difunctional (diglycidyl ester of hexahydrophthalic acid), or higher functionality (e.g. trimethylolpropane triglycidyl ether). Cycloaliphatic epoxides contain one or more cycloaliphatic rings in the molecule to which the oxirane ring is fused (e.g., 3,4-epoxycyclohexylmethyl-3,4-epoxycyclohexane carboxylate). They are formed by the reaction of cyclo-olefins with a peracid, such as peracetic acid. These aliphatic epoxy resins typically display low viscosity at ambient temperature (10-200 mPa·s) and are often used as reactive diluents. As such, they are employed to modify (reduce) the viscosity of other epoxy resins. This has led to the term ‘modified epoxy resin’ to denote those containing viscosity-lowering reactive diluents. In some embodiments, the resin composition may further comprise a reactive diluent. Examples of reactive diluents include diglycidyl ether of 1, 4 butanediol, diglycidyl ether of cyclohexane dimethanol, diglycidyl ether of resorcinol, p-tert-butyl phenyl glycidyl ether, cresyl glycidyl ether, diglycidyl ether of neopentyl glycol, triglycidyl ether of trimethylolethane, triglycidyl ether of trimethylolpropane, triglycidyl p-amino phenol, N,N′-diglycidylaniline, N,N,N′,N′,-tetraglycidyl meta-xylylene diamine, and vegetable oil polyglycidyl ether. The resin composition may comprise at least 1, 2, 3, 4, or 5 wt.-% and typically no greater than 15 or 20 wt-% of such reactive diluent(s).

In some embodiments, the resin composition comprises (e.g., bisphenol A) epoxy resin in an amount of at least about 50 wt.-% of the total resin composition including the mixture of boron nitride particles and cellulose nanocrystals. In some embodiments, the amount of (e.g., bisphenol A) epoxy resin is no greater than 95, 90, 80, 85, 80, 75, 70, or 65 wt.-% of the total resin composition.

Epoxies are typically cured with stoichiometric or near-stoichiometric quantities of curative. In the case of two-part epoxy compositions, the second part comprises the curative, also referred to herein as the curing agent. The equivalent weight or epoxide number is used to calculate the amount of co-reactant (hardener) to use when curing epoxy resins. The epoxide number is the number of epoxide equivalents in 1 kg (2.2 lbs) of resin (eq/kg); whereas the equivalent weight is the weight in grams of resin containing 1 mole equivalent of epoxide (g/mol). Equivalent weight (g/mol)=1000/epoxide number (eq/kg).

Common classes of curatives for epoxy resins include amines, amides, ureas, imidazoles, and thiols. In typical embodiments, the curing agent comprises reactive-NH groups or reactive —NR¹R² groups wherein R¹ and R² are independently H or C₁ to C₄ alkyl, and most typically H or methyl.

The curing agent is typically highly reactive with the epoxide groups at ambient temperature. Such curing agents are typically a liquid at ambient temperature. However, the first curing agent can also be a solid provided it has an activation temperature at or below ambient temperature.

One class of curing agents are primary, secondary, and tertiary polyamines. The polyamine curing agent may be straight-chain, branched, or cyclic. In some favored embodiments, the polyamine crosslinker is aliphatic. Alternatively, aromatic polyamines can be utilized.

Useful polyamines are of the general formula R⁵—(NR¹R²), wherein R¹ and R² are independently H or alkyl, R⁵ is a polyvalent alkylene or arylene, and x is at least two. The alkyl groups of R¹ and R² are typically C₁ to C₁₈ alkyl, more typically C₁ to C₄ alkyl, and most typically methyl. R¹ and R² may be taken together to form a cyclic amine. In some embodiment x is two (i.e. diamine). In other embodiments, x is 3 (i.e. triamine). In yet other embodiments, x is 4.

Examples include hexamethylene diamine; 1,10-diaminodecane; 1,12-diaminododecane; 2-(4-aminophenyl)ethylamine; isophorone diamine; 4,4′-diaminodicyclohexylmethane; and 1,3-bis(aminomethyl) cyclohexane. Illustrative six member ring diamines include for example piperzine and 1,4-diazabicyclo [2.2.2]octane (“DABCO”).

Other useful polyamines include polyamines having at least three amino groups, wherein the three amino groups are primary, secondary, or a combination thereof. Examples include 3,3′-diaminobenzidine, hexamethylene triamine, and triethylene tetramine.

The specific composition of the epoxy resin can be selected based on its intended end use. For example, in one embodiment, the resin composition can be for insulation, as described in US PAP No. 2014/0080940, the disclosure of which is incorporated herein by reference thereto.

The resin composition may optionally further comprise additives including (e.g. silane-treated or untreated) fillers, impact modifiers and the like, anti-sag additives, thixotropes, processing aids, plasticizers, waxes, antioxidants and UV stabilizers and other additives which can improve the performance of a structural adhesive. Examples of typical fillers include glass bubbles, fumed silica, mica, feldspar, and wollastonite. In some embodiments, the resin composition further comprises other thermally conductive fillers such as aluminum oxide, boron nitride, aluminum hydroxide, fused silica, zinc oxide, aluminum nitride, silicon nitride, magnesium oxide, beryllium oxide, diamond, and copper.

### Two Part Methyl Methacrylates (MMA) Adhesives

Two-part methyl methacrylates (MMA) adhesives have a faster strength build up than epoxies. MMA adhesives are commonly used for bonding plastics and bonding metals to plastics. They are also extremely effective in joining solid surface materials together, and as they can be colored, they are used extensively in worktop manufacture and installation.

Methyl methacrylate adhesives are structural acrylic adhesives that are made of a Part A (Part 1) resin and Part B (Part 2) hardener. Most MMAs also contain rubber and additional strengthening agents. MMAs cure quickly at room temperature and have full bond strength soon after application. The adhesive is resistant to shear, peel, and impact stress. Looking at the bonding process more technically, these adhesives work by creating an exothermic polymerization reaction. Polymerization is the process of reacting monomer molecules together, in a chemical reaction, to form polymer chains. What this means is that the adhesives create a strong bond while still being flexible. These adhesives are able to form bonds between dissimilar materials with different flexibility, like metal and plastic. Unlike some other structural adhesives like two-part epoxies, most MMAs do not require heat to cure. There are MMAs available with a range of working times to suit your specific needs.

MMAs develop strength faster allowing parts to be used sooner. It is also worth noting the different processing conditions used for MMAs. For example, the two components of MMAs can each be applied separately to one of the materials being bonded together, and the MMA will not begin to cure until the joints are brought together, combining the components. This means that you do not have to deal with precise mixing ratios to get a good bond. It is important to remember that MMAs do tend to have a strong smell, meaning you should have good ventilation when applying them and they are flammable, so some care is needed.

MMAs are formulated to have a Work Life between 5 minutes and 20 minutes.

Generally, all of these acrylic structural adhesive types provide exceptional bond strength and durability—nearly that of epoxy adhesives—but with the advantages of having faster cure speed, being less sensitive to surface preparation, and bonding more types of materials

### Two Part Silicone Adhesives

Two-part silicone adhesives are generally used when there is a large bond area or when there is not enough relative humidity to complete the cure. Common applications for these are; electronics applications including the manufacture of household appliances, in automotive and window manufacture.

Suitable silicone resins include moisture-cured silicones, condensation-cured silicones, and addition-cured silicones, such as hydroxyl-terminated silicones, silicone rubber, and fluoro-silicone. Examples of suitable commercially available silicone PSA compositions comprising silicone resin include Dow Corning's 280A, 282, 7355, 7358, 7502, 7657, Q2-7406, Q2-7566 and Q2-7735; General Electric's PSA 590, PSA 600, PSA 595, PSA 610, PSA 518 (medium phenyl content), PSA 6574 (high phenyl content), PSA 529, PSA 750-D1, PSA 825-D1, and PSA 800-C. An example of two-part silicone resin commercially available is that sold under the trade designation “SILASTIC J” from Dow Chemical Company, Midland, Mich.

### Two Part Urethane Adhesives

Two-part urethane adhesives can be formulated to have a wide range of properties and characteristics when cured. They are often used when bonding dissimilar materials such as glass to metal or aluminum to steel, for example.

Most polyurethane adhesives are either polyester or polyether based. They are present in the isocyanate prepolymers and in the active hydrogen containing hardener component (polyol). They form the soft segments of the urethane, whereas the isocyanate groups form the hard segments. The soft segments usually comprise the larger portion of the elastomeric urethane adhesive and, therefore, determine its physical properties. For example, polyester-based urethane adhesives have better oxidative and high temperature stability than polyether-based urethane adhesives, but they have lower hydrolytic stability and low-temperature flexibility. However, polyethers are usually more expensive than polyesters.

Many urethane adhesives are sold as two-component urethane adhesives. The first component contains the diisocyanates and/or the isocyanate prepolymers (Part 1), and the second consists of polyols (and amine/hydroxyl chain extenders) (Part 2). A catalyst is often added, usually a tin salt or a tertiary amine, to speed up cure. The reactive ingredients are often blended with additives, and plasticizers to achieve the desired processing and/or final properties, and to reduce cost.

Polyurethanes may be prepared, for example, by the reaction of one or more polyols and/or polyamines and/or aminoalcohols with one or more polyisocyanates, optionally in the presence of non-reactive component(s). For applications where weathering is likely, it is typically desirable for the polyols, polyamines, and/or aminoalcohols and the polyisocyanates to be free of aromatic groups.

Suitable polyols include, for example, materials commercially available under the trade designation DESMOPHEN from Bayer Corporation, Pittsburgh, Pa. The polyols can be polyester polyols (for example, Desmophen 631A, 650A, 651A, 670A, 680, 110, and 1150); polyether polyols (for example, Desmophen 550U, 1600U, 1900U, and 1950U); or acrylic polyols (for example, Demophen A160SN, A575, and A450BA/A).

Suitable polyamines include, for example: aliphatic polyamines such as, for example, ethylene diamine, 1,2-diaminopropane, 2,5-diamino-2,5-dimethylhexane, 1,11-diaminoundecane, 1,12-diaminododecane, 2,4- and/or 2,6-hexahydrotoluylenediamine, and 2,4′-diamino-dicyclohexylmethane; and aromatic polyamines such as, for example, 2,4- and/or 2,6-diaminotoluene and 2,4′- and/or 4,4′-diaminodiphenylmethane; amine-terminated polymers such as, for example, those available from Huntsman Chemical (Salt Lake City, Utah), under the trade designation JEFFAMINE polypropylene glycol diamines (for example, Jeffamine XTJ-510) and those available from Noveon Corp., Cleveland, Ohio, under the trade designation Hycar ATBN (amine-terminated acrylonitrile butadiene copolymers), and those disclosed in U.S. Pat. No. 3,436,359 (Hubin et al.) and U.S. Pat. No. 4,833,213 (Leir et al.) (amine-terminated polyethers, and polytetrahydrofuran diamines); and combinations thereof.

Suitable aminoalcohols include, for example, 2-aminoethanol, 3-aminopropan-1-ol, alkyl-substituted versions of the foregoing, and combinations thereof.

Suitable polyisocyanate compounds include, for example: aromatic diisocyanates (for example, 2,6-toluene diisocyanate; 2,5-toluene diisocyanate; 2,4-toluene diisocyanate; m-phenylene diisocyanate; p-phenylene diisocyanate; methylene bis (o-chlorophenyl diisocyanate); methylenediphenylene-4,4′-diisocyanate; polycarbodiimide-modified methylenediphenylene diisocyanate; (4,4′-diisocyanato-3,3′,5,5′-tetraethyl) diphenylmethane; 4,4′-diisocyanato-3,3′-dimethoxybiphenyl (o-dianisidine diisocyanate); 5-chloro-2,4-toluene diisocyanate; and 1-chloromethyl-2,4-diisocyanato benzene), aromatic-aliphatic diisocyanates (for example, m-xylylene diisocyanate and tetramethyl-m-xylylene diisocyanate); aliphatic diisocyanates (for example, 1,4-diisocyanatobutane; 1,6-diisocyanatohexane; 1,12-diisocyanatododecane; and 2-methyl-1,5-diisocyanatopentane); cycloaliphatic diisocyanates (for example, methylenedicyclohexylene-4,4′-diisocyanate; 3-isocyanatomethyl-3,5,5-trimethylcyclohexyl isocyanate (isophorone diisocyanate); 2,2,4-trimethylhexyl diisocyanate; and cyclohexylene-1,4-diisocyanate), polymeric or oligomeric compounds (for example, polyoxyalkylene, polyester, polybutadienyl, and the like) terminated by two isocyanate functional groups (for example, the diurethane of toluene-2,4-diisocyanate-terminated polypropylene oxide glycol); polyisocyanates commercially available under the trade designation MONDUR or DESMODUR (for example, Desmodur XP7100 and Desmodur N 3300A) from Bayer Corporation (Pittsburgh, Pa.); and combinations thereof.

In some embodiments, the polyurethane comprises a reaction product of components comprising at least one polyisocyanate and at least one polyol. In some embodiments, the at least one polyisocyanate comprises an aliphatic polyisocyanate. In some embodiments, the at least one polyol comprises an aliphatic polyol. In some embodiments, the at least one polyol comprises a polyester polyol or a polycarbonate polyol.

Typically, the polyurethane(s) is/are extensible and/or pliable. For example, the polyurethane(s), or any layer containing polyurethane, may have a percent elongation at break (at ambient conditions) of at least 10, 20, 40, 60, 80, 100, 125, 150, 175, 200, 225, 250, 275, 300, 350, or even at least 400 percent, or more.

In certain embodiments, the polyurethane has hard segments, typically segments corresponding to one or more polyisocyanates, in any combination, in an amount of from 35, 40, or 45 percent by weight up to, 50, 55, 60, or even 65 percent by weight.

As used herein: wt % means percent by weight based on the total weight of material, and

Hard Segment wt %=(weight of short chain diol and polyol+weight of short chain di- or polyisocyanate)/total weight of resin
wherein: short chain diols and polyols have an equivalent weight≤185 g/eq, and a functionality≥2; and short chain isocyanates have an equivalent weight≤320 g/eq and a functionality ≥2.

One or more catalysts are typically included with two-part urethanes. Catalysts for two-part urethanes are well known and include, for example, aluminum-, bismuth-, tin-, vanadium-, zinc-, tin-, and zirconium-based catalysts. Tin-based catalysts have been found to significantly reduce the amount of outgassing during formation of the polyurethane. Examples of tin-based catalysts include dibutyltin compounds such as dibutyltin diacetate, dibutyltin dilaurate, dibutyltin diacetylacetonate, dibutyltin dimercaptide, dibutyltin dioctoate, dibutyltin dimaleate, dibutyltin acetonylacetonate, and dibutyltin oxide. If present, any catalyst is typically included at levels of at least 200 parts per million by weight (ppm), 300 ppm, or more; however, this is not a requirement.

Additional suitable two-part urethanes are described in U.S. Pat. No. 6,258,918 B1 (Ho et al.) and U.S. Pat. No. 5,798,409 (Ho), the disclosures of which are incorporated herein by reference.

In general, the amounts of polyisocyanate to polyol, polyamine, and/or aminoalcohol in a two-part urethane are selected in approximately stoichiometrically equivalent amounts, although in some cases it may be desirable to adjust the relative amounts to other ratios. For example, a slight stoichiometric excess of the polyisocyanate may be useful to ensure a high degree of incorporation of the polyol, polyamine, and/or aminoalcohol, although any excess isocyanate groups present after polymerization will typically react with materials having reactive hydrogens (for example, adventitious moisture, alcohols, amines, etc.).

### Combining the Parts

In some embodiments, methods include causing the multipart structural adhesive to be formed by combining the Part 1 and the Part 2. Additionally, one or more of the Parts (e.g., one or more of the Part 1 and the Part 2) can be composed of sub-Parts. In such embodiments, the Part 1 can be combined with the first sub-Part 2, the second sub-Part 2 (or vice versa, and alternatively so on). In some embodiments, the first sub-Part 2 can be combined with the second sub-Part 2 before being combined with the Part 1. In some such embodiments, the first sub-Part 2 and the second sub-Part 2 are combined to form the Part 2 in automated dispensing equipment, and in some such embodiments, the first sub-Part 2 and the second sub-Part 2 are combined to form the Part 2 in a handheld dispenser. In some such embodiments, the first sub-Part 2 and the second sub-Part 2 can be mixed in a mixing nozzle. In some embodiments, the Part 1, the first sub-Part 2 and the second sub-Part 2 are simultaneously combined.

In some embodiments, Part 1 comprises a curable resin and the Part 2 comprises a curing agent. In some embodiments, the opposite is the case, such that Part 1 comprises a curing agent and the Part 2 comprises a curable resin.

In some embodiments, where the Part 2 is composed of two components, e.g., from a first sub-part 2 and a second sub-Part 2, the ratio of the first sub-Part 2 to the second sub-Part 2 is from 100:1 to 1:1, from 10:1 to 1:1, from 4:1 to 1:1, or even from 2:1 to 1:1.

In some embodiments, where the Part 1 is composed of two components, e.g., from a first sub-Part 1 and a second sub-Part 1 the ratio of the first sub-Part 1 to the second sub-Part 1 is from 100:1 to 1:1, from 10:1 to 1:1, from 4:1 to 1:1, or even from 2:1 to 1:1.

In some embodiments, the ratio of the Part 1 to the combination of the first sub-Part 2 and the second sub-Part 2 is from 100:1 to 1:1, from 10:1 to 1:1, from 4:1 to 1:1, or even from 2:1 to 1:1.

In some embodiments, the ratio of the Part 2 to the combination of the first sub-Part 1 and the second sub-Part 1 is from 100:1 to 1:1, from 10:1 to 1:1, from 4:1 to 1:1, or even from 2:1 to 1:1.

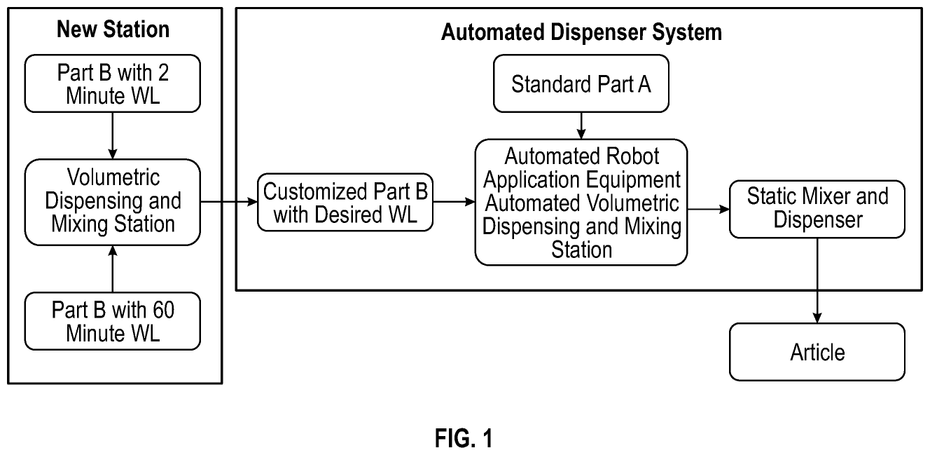

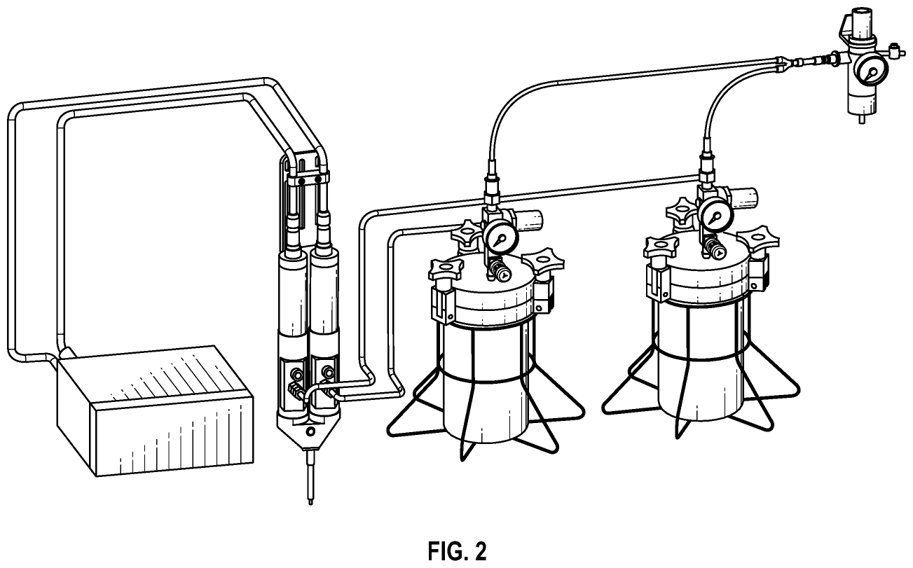

In some embodiments, a Part 2 (for example) that was formed from two (or more) sub-Parts can be stable and could be either stored in a reservoir or could be inline processed on automated dispensing equipment. In this case, the formed Part 2 can then be used and dispensed as a standard Part 2 in a standard automated process. The concept of customizing the Work Life of a two-part structural adhesive can easily be added to an automated dispenser system with the addition of a separate mixing station. FIG. 1 shows a schematic concept of how this could be accomplished by adding a New Mixing Station for the Customized Part B to an Automated Dispenser System to provide this capability. FIG. 2 depicts a more specific example of such a system.

Alternatively, for example, the Part 1 and Part 2 and related sub-parts allow a customer to customized their 2K structural adhesive. Equipment could be developed for the customer to customize and fill the cartridges of a manual applicator like an EPX cartridge. For example, the customer could fill one cartridge with the Part 1 and then customize, blend and mix the two sub-Parts 2 and fill the other cartridge. This system would allow the customer to essentially customize their structural adhesive to the needs of a manual application. It would allow the customer a process to refill their cartridges as a sustainability advantage and only have to inventory a minimal number of components for inventory management and cost advantages.

Generally, the two components of a two-part adhesive can be mixed prior to being applied to the substrates to be bonded. After mixing, the two-part adhesive gels, reaches a desired handling strength, and ultimately achieves a desired final strength. Some two-part adhesives must be exposed to elevated temperatures to cure, or at least to cure within a desired time. However, it may be desirable to provide structural adhesives that do not require heat to cure (e.g., room temperature curable adhesives), yet still provide high performance in peel, shear, and impact resistance.

### Mixing Nozzles

Whether the amounts of Part 1 and Part 2 (as well as any additional parts) are provided via an electronically controlled or handheld type dispenser, the two parts still must be mixed before being utilized. Alternatively, or additionally, two or more sub-Parts may have to be combined and mixed thoroughly. Often two component epoxy adhesives have one color for the resin and another color for the hardener—in these cases it is fairly easy to visualize when you've mixed the adhesive thoroughly. When both the resin and hardener are the same color, it may be more difficult.

Mixing nozzles or mixing tips may be useful to provide mixing of the two Parts (as well as any sub-Parts that need to be mixed to form the Parts). In general, there are two types of mixing nozzles, static mixers and turbo mixers (also known as Quadro mixers). Standard static mixers are the oldest technology in two-part adhesive dispensing. These nozzles are round and come in a wide range of connection types. Standard mixers typically require longer nozzles and more mixing elements to create the same mixing quality as Quadro mixers.

Quadro mixers are generally square in shape. Quadro mixers allow for more complete mixing in a shorter nozzle. The advantage of Quadro style nozzles is that there is less wasted adhesive left over in the nozzle and users can get closer to their substrates when dispensing.

Static mixers can take any number of forms, each suited to particular applications and with unique advantages and disadvantages. These include in-line mixers, where components are placed as a permanent part of the dispensing line, and static dynamic mixers, which have moving parts but are not powered. Disposable bayonet mixers, however, are by far the most common and widely applicable. Disposable static mixers take the form of a nozzle that attaches to either meter mix and dispense (MMD) or handheld dispensing equipment. Their internal components can vary greatly depending on the needs of the application. The most common are the helical type and the box chamber type. Disposable static mixers are designed to be thrown away after use which can be cost effective compared to the flushing and cleaning necessary in non-disposable mixers. They also make sense for equipment which will handle multiple adhesive types.

There are many different varieties of static mix nozzles. It is important to use the one specified by the manufacturer to ensure proper mixing occurs. The number of elements in the nozzle dictate the number of stirs the adhesive gets while passing. Nozzles can range from 24 to 56 elements so the nozzle with 24 elements only stirs the adhesive 24 times—the one with 56 has more than double the number of stirs, for example.

### Automated Dispensers

The disclosed methods, systems and devices can be very useful to high volume applications requiring larger quantities. In these applications, handheld dispensers may be impractical due to large quantities used or being part of an automated manufacturing line. Automated dispensing equipment can be used to control the amounts of the two parts and then the two parts can be dispensed through a mixing tip to form the two-part (for example) adhesive.

Various companies can provide various components, systems, etc. that can be capable of electronically controlling and mixing Parts 1 and 2 (or more) of a two-part structural adhesive and could additionally provide for mixing of one or more of those Parts that may have sub-Parts that need to be mixed as well. For example, a system can be configured and programmed to control the dispense time (e.g., milliseconds), the volume of the materials (e.g., in milliliters), or the weight of the material (e.g., in grams), or any combination thereof. Additionally, the ratios of Part 1 and Part 2 (for example) can also be controlled, programmed, or both. In some embodiments, the amounts, ratios, or both of the various Parts, sub-Parts, or both being dispensed can be controlled to +1% (volumetric, for example).

In some embodiments, piston pumps can be utilized. Piston pumps can be useful because they can be fitted and designed to include both metering and mixing dispensing equipment. Piston pumps can also be electronically controlled using a programmable or programmed controller.

Illustrative commercially available systems can include, for example Nordson EFD's 797PCP-2K series progressive cavity pump system (Nordson Corporation Inc., Wixom, MI, USA), which provides volumetric meter mix dispensing for two-part fluids. Various optional components that can be utilized with the Nordson EFD cavity pumps can include, for example mixers (e.g., Series 190 Spiral Bayonet Mixers, Series 295 Square Turbo Bayonet Mixers), controllers (e.g., 7197PCP Controllers), and additional components not specifically disclosed or referred to herein. An additional optional component that can be utilized along with the pump system above, or other pump systems can include a bulk unloader, for example for loading a Part 1 and a Part 2 into a pump system such as that noted above as being commercially available can include Rhino Bulk Unloader (Nordson Corporation Inc., Wixom, MI, USA)

In some embodiments, gear pump metering and mixing dispensing equipment may be preferable for lower viscosity adhesives and may be especially useful in fully automated high production environments.

Automated or programmable pumps such as piston pumps, gear pumps, etc. can also be useful because they can optionally be controlled to vary the amounts, ratios, or components as the structural adhesive is being formed and utilized. For example, the amount of one Part (or vice versa) can be varied during application by an automated system to account for various environmental parameters (e.g., temperature, humidity, etc.), to form a structural adhesive having at least one different property than the structural adhesive that was formed before varying the amount, ratio or both of the specific Part of the composition, to create a structural adhesive that has at least one changing property for use in a specific application, or any combination thereof (or for other reasons not specifically indicated herein).

In some embodiments, illustrative systems that can be used along with disclosed structural adhesives to control, vary, or both various amounts of components (e.g., Part 1, Part, 2, sub-Parts 1, sub-Parts 2, additives, etc.) can include devices, components, systems, etc. disclosed in EP Application Serial No. 20186305.7 (also PCT application number IB2021/056362). Such systems can offer the advantage of changing one or more properties of the structural adhesive while it is being dispensed. Some such systems can additionally utilize sensors that measure one or more properties of the adhesive and utilize such measurements, at least in part, to control the amounts, ratios, or both of the various components.

In some disclosed embodiments, such systems can include, for example: property sensors for determining a property value of a property of a liquid, such as a two-component curable adhesive, the property sensor comprising a channel comprising a sensing zone through which—in use—the liquid flows; two electrodes for generating an electric field of one or more sensing frequencies in the sensing zone; a data storage device comprising a pre-stored set of calibration data representing calibration impedance responses measured previously at the one or more sensing frequencies and at different property values of the property of an identical liquid; and a property value deriver, electrically connected to the electrodes, and operable to repeatedly generate, while the liquid flows through the sensing zone, between the electrodes an electric field of the one or more sensing frequencies in the sensing zone; sense between the electrodes, at the one or more sensing frequencies, while the liquid flows through the sensing zone and while the electric field is present, a response impedance; and derive from the response impedance a property value of the property of the liquid, using the pre-stored set of calibration data representing calibration impedance responses.

In some embodiments, the channel can comprise a first longitudinal section having a first open cross section available for the flow of the liquid, and a second longitudinal section, downstream from the first longitudinal section, having a second open cross section available for the flow of the liquid, wherein the second open cross section is larger than the first open cross section, and wherein the sensing zone is comprised in the second longitudinal section. In some embodiments, the channel may comprise a bypass, arranged such that a first portion of the liquid flows through the sensing zone, and a second portion of the liquid flows through the bypass bypassing the sensing zone.

In some embodiments, one or both of the electrodes is/are arranged such as to be in contact with the liquid when the liquid flows through the sensing zone. In some such embodiments, the sensing zone can be arranged between the electrodes. In some such embodiments, one of the electrodes is arranged between the sensing zone and the bypass.

In some embodiments such a system can comprise a temperature sensor for sensing a temperature of the liquid in the channel or in the sensing zone. In some embodiments such a system can comprise a flow speed sensor for sensing a flow speed of the liquid through the channel or through the sensing zone.

Some such systems can provide sensored mixing by utilizing a system that comprises a mixing device for mixing two or more components (A, B) to produce a mixed liquid at a mixer output, and a property sensor such as those described above, in fluid communication with the mixer output such that the mixed liquid can flow from the mixer output through the sensing zone.

Also provided herein and by such systems are processes of determining a property value of a property of a liquid, comprising the steps, in this sequence, of providing a liquid and a property sensor such as those described above, and having the liquid flow through the sensing zone; generating, while the liquid flows through the sensing zone, between the electrodes an electric field of the one or more sensing frequencies in the sensing zone; sensing between the electrodes, at the one or more sensing frequencies, while the liquid flows through the sensing zone and while the electric field is present, a response impedance; and deriving from the response impedance a property value of the property of the liquid, using the pre-stored set of calibration data representing calibration impedance responses.

In some embodiments, such processes can utilize sensing frequencies at a frequency of between 1 Hertz and 10000 Hertz, and wherein the amplitude of the electric field is between 100 Volt per meter and 20000 Volt per meter.

In some such embodiments, the liquid has a dynamic viscosity of between 10 Pascalseconds and 40,000.0 Pascalseconds, measured at 25° C. according to standard ASTM D7042-12a in its version in force on 1 Jul. 2020.

Additionally, such methods, systems or both may provide a set or sets of calibration data. Illustrative sets of calibration data representing calibration impedance responses for use in the process described above can include those wherein the set of calibration data further represents a property value of a property of a calibration liquid at which property value one of the calibration impedance response was sensed. In some such cases, the set of calibration data representing calibration impedance responses discussed immediately above, wherein the set of calibration data further represents a sensing frequency at which sensing frequency one of the calibration impedance responses was sensed, and/or wherein the set of calibration data further represents a temperature of the liquid in the sensing zone at which temperature one of the calibration impedance responses was sensed.

### Method, Data Set and Sensor to Sense a Property of a Liquid

The present disclosure relates to sensors that can determine properties of liquids and to methods for determining properties of liquids. The disclosure also relates to data sets useable in such sensors and methods.

Many industrial processes use liquid materials such as liquid adhesives, liquid food ingredients, liquid coolants, or liquid reaction products, to name a few examples. Certain properties of such liquids vary over time: adhesives may cure, an oil may become less viscous as temperature rises, a coolant may age and have a lower heat capacity than initially.

Many industrial processes, however, rely on certain properties of a liquid being within a specified range or being unchanged compared to the property in an initial state.

Electrical sensors have been used for many years to determine properties of liquids or identify any deviations from desired values of those properties. The U.S. patent application US 2010/0188110 A1, for example, describes a sensor having integrated electrodes in a single sensor configuration, which is operated by alternating current including periodic electrical excitation signals of the respective multiple frequencies with the same amplitude for detecting analytes in fluids.

A further U.S. patent application, US 2009/0309615 A1, explains a method for measurement of mixing ratio of a substance mixture of at least two substances, wherein the substance mixture is brought into the measurement range of a capacitive sensor, especially moved past or through it, and wherein the mixing ratio is determined from the change in capacitance of the sensor caused by the substance mixture.

There remains a need, however, for sensors that can sense values of more properties of a liquid than mixing ratio.

The present disclosure provides, in a first aspect, a property sensor for determining a property value of a property of a liquid, such as a viscous adhesive, the property sensor comprising
a) a channel comprising a sensing zone through which—in use—the liquid flows; b) two electrodes for generating an electric field of one or more sensing frequencies in the sensing zone;
c) a data storage device comprising a pre-stored set of calibration data representing calibration impedance responses measured previously at the one or more sensing frequencies and at different property values of the property of an identical liquid; and
d) a property value deriver, electrically connected to the electrodes, and operable to repeatedly
i) generate, while the liquid flows through the sensing zone, between the electrodes an electric field of the one or more sensing frequencies in the sensing zone;
   ii) sense between the electrodes, at the one or more sensing frequencies, while the liquid flows through the sensing zone and while the electric field is present, a response impedance;
iii) derive from the response impedance a property value of the property of the liquid, using the pre-stored set of calibration data representing calibration impedance responses.

Property sensors as described herein may be used to sense properties of a liquid resulting from a mixing process. They may also be used to sense properties of input liquids for a mixing process or for an industrial manufacturing process. Advantageously, separate property sensors for respective input liquids are placed just in front of the mixer. Data from these property sensors measuring the input liquids can be processed along with data from a property sensor measuring the mixed liquid, e.g. in an integrated materials property monitoring system. Where, for example, a liquid composition is mixed from three input liquids, a property of each of the three liquids before mixing can be determined using three property sensors at the respective outlets of the three containers containing the three input liquids. This may help in quality control and reduce waste that might otherwise occur due to one of the input liquids being outside a specification for the property.

The sensor according to the present disclosure can determine various properties of a liquid, like, for example, mixing ratio of a two-component adhesive or curing status of a curable composition or ageing status. The number of properties which were varied previously to establish the set of calibration data representing calibration impedance responses measured previously at the different property values determines the number of properties that can later be determined by the property sensor. The pre-stored set of calibration data representing calibration impedance responses measured previously at the one or more sensing frequencies and at different property values of a property of the liquid forms, or represents, a multi-dimensional data field which is specific for the liquid. This data field allows the property value deriver to determine, from a response impedance actually measured, a value of the property of the liquid.

A liquid has many properties: for example, viscosity, density, colour, content of volatile components, water content, chemical composition, boiling point, but also ageing status, curing status in case of liquid curable compositions, or mixing ratio in case of the liquid being a mixture, to name only some.

Not all properties of a liquid can be determined using the sensors or methods according to the present disclosure. Certain properties of certain liquids, however, vary with time and/or with other parameters such that the response impedance in a property sensor described herein varies with time and/or with the other parameters, too. Values of these properties can be derived via the present property sensor.

Variation with time includes variation of the property between different production lots of the liquid. The property sensor described herein can thus be used to detect differences in a certain property (e.g. chemical composition) of a suitable liquid between a later production lot and an earlier production lot of the liquid.

The term “property” of the liquid, according to the present disclosure, is not particularly limited. In certain embodiments, a property is a mixing ratio of two or more components of the liquid. In certain of these embodiments, the liquid is a two-component adhesive, and a property of the liquid is a mixing ratio of the components. In other embodiments, a property is a curing degree or a curing status. In certain of these embodiments the liquid is a curable composition, and a property of the liquid is the degree of curing of the composition.

In other embodiments, a property is an ageing degree or an ageing status. In certain of these embodiments the liquid is an ageing liquid, i.e. a liquid in which certain characteristics change over time once the ageing liquid has been created. The property sensor may determine a change in the response impedance of the ageing liquid after some ageing, compared to response impedances of an identical liquid recorded before ageing and at certain times after ageing. The property sensor may thereby determine an ageing degree or an ageing status of the liquid.

A property of the liquid may take different values, such as, for example, a property “dynamic viscosity” of the liquid “water” can take values like 1.30 mPa·s or 0.31 mPa·s. Such values are referred to herein as property values.

Certain properties may not be related to only numerical property values. A property “curing degree”, for example, may have property values like, for example, “uncured”, “partially cured” or “fully cured”. A property “curing status”, for example, may have property values like, for example, “uncured” or “fully cured”.

A liquid according to the present disclosure may be a viscous liquid.

Independent of its viscosity, the liquid may be a flowing liquid. The liquid may be a continuously flowing liquid.

In certain embodiments, a liquid is a liquid adhesive. In certain of these embodiments, a liquid is a curable liquid adhesive. In certain of these embodiments, a liquid is a curable two-part liquid adhesive. “Two-part” refers to the adhesive being composed of a first component and a second component which are mixed, e.g. in a static or dynamic mixer, to form the adhesive.

In other embodiments, the liquid is, or comprises, a void filler, a sealant, a dielectric fluid such as a 3M™ Novec™ engineered fluid, a thermally conductive interface material such as a thermally conductive gap filler, or a liquid chemical composition to produce any of the aforementioned liquids.

The channel of the property sensor facilitates flowing of the liquid through the sensing zone. The liquid may flow through the channel and through the sensing zone.

The channel may define a flow direction of the liquid. The channel may have, at any point along the flow direction, a cross section, e.g. a cross section determined orthogonally to the flow direction. The channel may have a length, measured along the flow direction. The cross section may be constant over the length of the channel. The channel may have, for example, a circular cross section, an elliptical cross section, a rectangular or a square cross section, over the length of the channel, wherein the cross section is constant over the length of the channel.

The channel may be, for example, a passageway in a static mixer or a passageway in an extruder, through which passageway the liquid can flow.

The channel of the property sensor according to the present disclosure comprises a sensing zone. When the property sensor is in use, the liquid flows through the sensing zone. The electric field generated by the property value deriver via the electrodes extends into the sensing zone. The liquid flowing through the sensing zone is exposed to the electric field and provides a specific impedance in the electric field between the electrodes.

The property sensor may be designed such that the sensing zone is delimited by the channel.

In certain embodiments the sensing zone is a longitudinal section of the channel.

The shape of the electrodes is not of great importance, as long as they can generate an electric field of appropriate strength and geometry in the sensing zone. The strength and geometry of the field must be chosen such that there is a field strength available in the sensing zone sufficient to determine a response impedance.

In certain embodiments the sensing zone is arranged between the electrodes. Such an arrangement may provide for a stronger electric field in the sensing zone and to a more accurate sensing of the response impedance.

In certain embodiments the electrodes are opposed parallel plates, forming a plate capacitor. The dielectric of this plate capacitor may comprise the liquid flowing through the sensing zone.

In certain other embodiments the electrodes are, or comprise, parallel plates, arranged side by side in a same geometric plane. This is a potentially space-saving arrangement of the electrodes, which furthermore allows arranging both electrodes on the same side of the sensing zone. In such arrangements a fringe field between the electrodes may extend into the sensing zone.

In certain embodiments the electrodes are arranged outside of the channel. This avoids direct contact between the liquid and the electrodes, which may help protect the electrodes from mechanical or chemical impact by the liquid.

In certain other embodiments the electrodes are arranged inside the channel. In some of these embodiments the electrodes are immersed in the liquid. Such arrangements may provide for a stronger response impedance signal.

In certain embodiments one or both of the electrodes is/are arranged such as to be in contact with the liquid when the liquid flows through the sensing zone. Again, such an arrangement may provide for a stronger response impedance signal and less noise.

In certain embodiments, an electrode comprises a flat plate, oriented parallel to the flow direction of the liquid at the location of the electrode. The parallel arrangement may result in a smoother flow of the liquid at the location of the electrode and to less mechanical force exerted on the electrode. In certain of these embodiments, each electrode comprises a flat plate, oriented parallel to the flow direction of the liquid at the location of the respective electrode.

In certain embodiments an electrode is a conductive path or a conductive patch on a front surface of a printed circuit board (PCB). Areas on the front surface of the PCB adjacent to the conductive path or patch forming the electrode may be covered with a further, separate conductive layer to act as a shielding which limits the effective capacitor plate electrode area to the area of the conductive path or patch. A similar conductive layer can be applied on the rear surface of the PCB, forming a shielding to reduce impact of external electrical fields on the electrode and thereby to help improve the overall accuracy of the property sensor.

A property sensor according to the present disclosure may have further electrodes for generating the electric field of one or more sensing frequencies in the sensing zone. A property sensor according to the present disclosure may have a third electrode for generating the electric field of one or more sensing frequencies in the sensing zone. A property sensor according to the present disclosure may have a third and a fourth electrode for generating the electric field of one or more sensing frequencies in the sensing zone. Further electrodes may help in strengthening or shaping the electric field in the sensing zone. This may result in stronger response impedance signals and enhanced accuracy in sensing the property of the liquid. A further electrode may also allow to increase the maximum allowable flow rate of the liquid through the sensor.

Hence in certain embodiments, the property sensor comprises a third electrode for generating the electric field of one or more sensing frequencies in the sensing zone. The third electrode may be on a voltage different from the voltage of the two electrodes. In certain embodiments, the property sensor comprises a third electrode and a fourth electrode for generating the electric field of one or more sensing frequencies in the sensing zone. The third electrode and/or the fourth electrode may be on a voltage different from the voltage of the two electrodes.

The electric field between the electrodes is an alternating (AC) electric field. It causes displacement currents in the liquid in the sensing zone. By precisely measuring the voltage applied between the electrodes and the resulting current in the time domain, response impedances can be sensed. For sensing response impedances at different sensing frequencies, the electric field generated between the electrodes in the sensing zone can be generated, for example, such that it oscillates with a first constant amplitude at a first sensing frequency for a certain time during which the response impedance at that first sensing frequency is sensed, then oscillates with a second constant amplitude at a second sensing frequency for a certain time during which the response impedance at that second sensing frequency is sensed. If a third sensing frequency is used, the electric field is then made to oscillate with a third constant amplitude at a third sensing frequency for a certain time during which the response impedance at that third sensing frequency is sensed, and so on.

Instead of generating the sensing frequencies sequentially and sequentially measuring a response impedance at each sensing frequency separately, all amplitudes and all desired sensing frequencies can be generated at the same time, overlaid with each other via, e.g., Fourier synthesis, to form a single pulse or “burst” of a specific shape in a time-amplitude diagram. The resulting of an overlay of many frequencies can be a kind of electromagnetic noise. Where a plurality of sensing frequencies are overlaid with each other for an extended time, they may form a repetitive shape in a time-amplitude diagram.

Where a plurality of sensing frequencies are overlaid with each other, the resulting response impedance signal can be separated, i.e. filtered, into frequencies, e.g. via Fourier analysis, to obtain a response impedance for each individual sensing frequency.

Depending on the type of liquid, a useful sensing frequency may be, for example, a frequency of 32 Hertz (Hz), of 100 Hz, 1000 Hz, 5000 Hz or of 8000 Hz. Generally, a sensing frequency may be a frequency between 1 Hertz and 10000 Hertz (10 kHz), or even up to 100000 Hz (100 kHz). In certain preferred embodiments, the sensing frequency is a frequency between 200 Hz and 2000 Hz, because small differences in values of important properties of certain industrial liquids result in particularly strong differences in response impedance in this frequency range.

The voltage between the electrodes may be a voltage between 0.1 Volt and 100 Volt. It is typically between 1 Volt and 20 Volt, preferably between 1 Volt and 10 Volt. Voltages above 1 Volt were found to provide for an acceptable signal-to-noise ratio with certain liquids. Voltages below 100 Volt are well below the dielectric strength of many typical liquids that may be used in the property sensor described herein, assuming a typical distance between the electrodes of a few millimeters.

In certain embodiments the amplitude of the electric field is between 100 Volt per meter and 20000 Volt per meter. Such field strengths, at sensing frequencies in the range explained above, have shown to facilitate reliable sensing of response impedances at adequate accuracy. These amplitudes are low enough to avoid electrolysis in the liquid and the associated change its chemical composition, but were found high enough for obtaining sufficiently strong response impedance signals for many liquids.

Values for a property of the liquid are obtained using the set of calibration data representing calibration impedance responses, stored previously. Calibration data representing a set of calibration impedance responses for a specific property of a specific liquid can be obtained, for example, by recording, for each of several values of the property, impedance responses at different sensing frequencies measured on an identical liquid in the same, or an identical, property sensor. The impedance responses thus measured are the calibration impedance responses which are later, at the time of a “real” measurement, used to relate response impedances of the “real” measurement to the calibration impedance responses and derive a property value from this relation. Alternatively, the impedance responses thus measured can, for example, be used to compute a set of parameters that mathematically describe a multi-dimensional data field, e.g. a set of polynomials or a parameterized multi-dimensional surface, which can be used to derive from a measured response impedance a property value of the liquid. The parameters may be derived in a calibration procedure using an identical liquid in the property sensor, they may be stored on the data storage device and can during the measurement be used to compute the polynomials or the multi-dimensional surface at specific response impedance values.

Generally, calibration impedance responses may vary with variables like, for example, the value of the property of the liquid, the sensing frequency, the temperature of the liquid in the sensing zone, and potentially other parameters such the degree of curing, where the liquid is a curable composition. The calibration impedance response (CIR) is thus a function of a number of variables:

CIR=f(value of property,sensing frequency,temperature, . . . )
and correspondingly the value of the property of the liquid is the inverse function

value of property=f−1(CIR,sensing frequency,temperature, . . . )

To obtain a set of calibration data representing calibration impedance responses, all variables are varied in a controlled way, simultaneously or sequentially, within respective intervals that reflect potential values of these variables in a measurement. For each combination of variables, the calibration impedance response is recorded, yielding eventually a multi-dimensional data field. This data field either is the set of calibration impedance responses which is later used to derive from response impedances taken in a measurement a value of the property of the liquid, or this data field is used to compute a set of calibration data representing these calibration impedance responses, such as a set of parameters for a set of polynomials fitting the calibration impedance responses. For this step, some of the variables are determined and fixed during the measurement, such that eventually the only unknown variable is the value of the property. This unknown variable can then be derived from the set of calibration impedance responses, or from the set of calibration data representing the calibration impedance responses, by taking into account the fixed or determined values of the other variables and the impedance response recorded in the measurement.

During the calibration process, a calibration impedance response that corresponds to a specific response impedance may not have been recorded. In such a case an interpolation may be performed on the set of calibration impedance responses to compute a property value for the specific response impedance, or the set of calibration data representing calibration impedance responses may be used to compute a property value for a specific response impedance.

The term “interpolation process” as used herein refers to any kind of mathematical process that provides a property value for a response impedance that is between two or more calibration impedance responses in the set of calibration impedance responses represented by the set of calibration data.

Calibration impedance responses may, for example, be represented by a set of calibration data in a similar manner as a set of z-values over an x-y-plane can be represented by a set of parameters a, b, c of a two-dimensional polynomial p a, b, c (x, y) which fits or approximates these z-values. Calibration data may thus be parameters of a function or set of functions which contain, approximate, or best-fit the calibration impedance responses measured previously in a calibration procedure.

Alternatively, calibration impedance responses may, for example, be represented by themselves. In such cases it may have been found beneficial to not fit or approximate the measured calibration impedance responses by a function, but use the calibration impedance responses as such.

In order to speed up an interpolation process, the set of calibration impedance responses may have the form of a multi-dimensional data field. which is represented by the set of calibration data. The calibration impedance responses may have the form of a parametrized multi-dimensional data field, which is represented by the set of calibration data. A parameter in the parametrized multi-dimensional data field may be response impedance. Alternatively, or in addition, a parameter in the parametrized multi-dimensional data field may be the temperature of the liquid in the sensing zone.

Generally, different liquids will have different values of a certain property, under otherwise identical conditions. To optimize sensing accuracy, the calibration impedance responses should be generated using a liquid that is identical, i.e. sufficiently similar, to the liquid of which a property is to be sensed later. In certain embodiments, however, the calibration impedance responses may be generated using a different liquid and adjusting mathematically the impedance values thus obtained for differences between the liquids to obtain a set of calibration impedance responses.

Generally, different property sensors will output slightly different values of a certain property, even for identical liquids and under otherwise identical conditions. This is due to uncontrollable tolerances, e.g. in geometries of the channel and of the electrodes. To improve sensing accuracy, the set of calibration impedance responses should be generated using the property sensor that is later used to sense response impedances, or an identical property sensor. In certain embodiments, however, the calibration impedance responses may be generated using a different property sensor and adjusting mathematically the impedance values thus obtained for differences between the property sensors to obtain calibration impedance responses.

The set of calibration data representing calibration impedance responses is stored in the data storage device before the property value deriver uses the calibration data representing calibration impedance responses and the response impedance of the current measurement to derive a value of a property of the liquid.

In certain embodiments, the property sensor is used in an industrial manufacturing process, e.g. an extrusion process, a co-extrusion process or a mixing process. The set of calibration data representing calibration impedance responses may have been stored in the data storage device in a separate calibration process some time before the industrial manufacturing process is performed.

The pre-stored set of calibration data representing calibration impedance responses is stored on the data storage device, e.g. in a digital format. The data storage device comprising the pre-stored set of calibration data representing calibration impedance responses may be, for example, a random-access memory (RAM), a hard-disk, a USB removable media, an optical disc such as a CD-ROM or a DVD, a cloud server, a network server, a computer in a network, or any other suitable storage device.

The property value deriver accesses the data storage device to obtain the set of calibration data representing calibration impedance responses stored thereon. The data storage device is therefore operationally connected to the property value deriver. It may be operationally connected to the property value deriver at least before the property value deriver derives from the response impedance a property value of the property of the liquid. It may be operationally connected to the property value deriver at least while the property value deriver derives from the response impedance a property value of the property of the liquid.

The data storage device may include the property value deriver. The data storage device may be arranged inside the property value deriver. Alternatively, the data storage device may be arranged outside the property value deriver, e.g. remote from the property value deriver.

In certain embodiments the property value deriver is a computerized property value deriver. A computerized property value deriver has a digital processor and memory. In such embodiments, the data storage device may be a mass storage device or a removable media connected to the computerized property value deriver. A computerized property value deriver may be operationally connected to a mixer or an extruder through which the liquid flows into the channel.

The property value deriver performs at least the functions of i) generating an electric field between the electrodes, ii) sense a response impedance, and iii) derive from the response impedance a value of a property of the liquid using the set of calibration data representing calibration impedance responses. The property value deriver therefore may comprise a first functional unit for generating a voltage of one or more frequencies between the electrodes.

The property value deriver may comprise a second functional unit for sensing an impedance. The second functional unit may comprise a current sensor.

The property value deriver may comprise a third functional unit for deriving a value of a property from the response impedance and the set of calibration data representing calibration impedance responses. This third functional unit may be a computerized functional unit, i.e. it has a digital processor and memory. In such embodiments, the data storage device may be a mass storage device or a removable media connected to the computerized third functional unit. A computerized third functional unit may be operationally connected to a mixer or an extruder through which the liquid flows into the channel.

The electrical field is generated between the two electrodes and extends into the sensing zone. Depending on the geometry of the electrodes and their arrangement relative to each other, the electric field extends into areas which are not necessarily located geometrically between the electrodes.

The electric field may be homogenous or comprise a homogenous portion, for example where the electrodes are flat, of equal size, parallel and opposed to each other, forming a classic plate capacitor. Generally, it is not required that the field be homogenous in the sensing zone, so the electric field can be homogenous or nonhomogenous in the sensing zone.

Generally, an electrical impedance is a frequency-dependent resistance, i.e. a ratio of voltage to current, and a measure of the opposition to time-varying electric current in an electric circuit. The property value deriver in a property sensor according to the present disclosure generates an alternating electric field and thereby an AC voltage between the electrodes and senses a response impedance by sensing the electric current caused by the applied AC voltage. Dividing the voltage at a sensing frequency by the current at the sensing frequency yields the impedance at the sensing frequency.

The property deriver can derive from a response impedance a property value of the property of the liquid, using the pre-stored set of calibration data representing calibration impedance responses. In one aspect, the property value deriver operates such as to use the dependency of the calibration impedance response on the value of a property. This dependency is mirrored in the calibration impedance responses and in the set of calibration data representing the calibration impedance responses.

Each set of CIR, sensing frequency, temperature and other parameters defines a point in a multi-dimensional parameter space, at which point the associated value of the property was present in the calibration process. After calibration the actual measurement may be performed at different parameters, e.g. a different sensing frequency, a different temperature, etc., yielding a different response impedance MRI. To identify the property value using the measured response impedance (MRI)

value of property=f−1(MRI,sensing frequency,temperature, . . . )
the parameters of the calibration process may have to be interpolated in order to match with the parameters of the measurement, and to be able to derive a value of the property at the exact point in the parameter space at which the measurement was performed.

The calibration data, in turn, represent the calibration impedance responses, i.e. the CIR values as dependent on the parameters:

CIR=f(value of property,sensing frequency,temperature, . . . )

The calibration data may thereby help to find the inverse function f-lor help to find CIR values that are closest to measured response impedance values MRI and their associated value of the property of the liquid. Indicating interpolated values for the parameters with an asterisk, a value of the property may be identified by using the inverse function with the interpolated values:

Value of property=f−1(CIR*,sensing frequency*,temperature*, . . . )
CIR values taken during calibration would be interpolated to yield the MRI sensed during measurement, a sensing frequency used during the calibration process would be interpolated to yield the sensing frequency used during the measurement, and temperatures used in the calibration process would be interpolated to yield the temperature in the actual measurement. A value of the property of the liquid can thus be derived from the response impedances using the pre-stored set of calibration data representing calibration impedance responses.

Sometimes, neither f nor its inverse f−1 are explicitly known. Instead, a multi-dimensional data field representing f (CIR, . . . ) may then be numerically examined to find the best matching value for f−1 (MRI, . . . ). The multi-dimensional data field may be the result of a mathematical operation, such as, for example, a regression operation, a minimization operation, or an interpolation. This mathematical operation may use calibration impedance response data measured in a previous calibration run as an input.

Neural Network modelling is one approach that can be used to understand this multi-dimensional data field.

In certain embodiments the property value deriver comprises a machine learning device, operable to derive from the response impedance a property value of the property of the liquid, using the pre-stored set of calibration impedance responses. In certain of these embodiments the pre-stored set of calibration impedance responses may be, or may be comprised in, a set of training data for training the machine learning device.

Finding a best matching value may involve interpolation between several data points in the set of calibration impedance responses or interpolation between data points in the set of calibration data. For example, in calibration, a mixing ratio might have been determined at two calibration impedance responses. In measurement, the response impedance might fall between these two calibration impedance responses. In order to identify a mixing ratio in measurement, the resulting mixing ratio is obtained from interpolating between the mixing ratios of the respective calibration impedance responses.

In certain embodiments, using the pre-stored set of calibration data representing calibration impedance responses comprises comparing a measured response impedance to calibration impedance responses. In certain embodiments, using the pre-stored set of calibration impedance responses comprises determining calibration impedance responses closest to the response impedance. In certain embodiments, using the pre-stored set of calibration data representing calibration impedance responses comprises determining a property value of the property of the liquid by interpolating between two property values of the property comprised in the calibration impedance responses represented by the set of calibration data.

In certain embodiments, using the pre-stored set of calibration data representing calibration impedance responses comprises identifying a calibration impedance response data point at which at least the response impedance is closest to a calibration impedance response and at which the sensing frequency at which the calibration impedance response was recorded is closest to the sensing frequency generated.

Calibration impedance responses may include calibration impedance responses taken at different values of a property of the liquid and taken at one sensing frequency. However, it may not be sufficient for the set of calibration impedance responses to include calibration impedance responses of a variable property at one single sensing frequency. For example, when sensing response impedances of a curable two-component adhesive at one given sensing frequency and at a given temperature of the adhesive in the sensing zone, a combination of a first mixing ratio of the components and a first curing degree may yield the same response impedance as a combination of a second mixing ratio and a second curing degree. When attempting to derive values of the property “mixing ratio”, this potential ambiguity can often be resolved by performing calibration measurements at various different sensing frequencies, because mixing ratio and curing degree often vary differently with sensing frequency. Hence it may be advantageous to include in the set of calibration impedance responses data points of impedance responses at different mixing ratios at different curing degrees at different sensing frequencies. Therefore generally, calibration impedance responses may include calibration impedance responses taken at different values of a property of the liquid and taken at two or more sensing frequencies.

The property sensor described herein may be used to determine a mixing ratio of the components of a two-component liquid, e.g. a two-component adhesive. The channel of the property sensor may be connected to an output of a mixer, so that the mixed liquid flows through the channel. To dispense the two components into the mixer, a dual-cartridge dispenser may be used that can provide arbitrary mixing ratios of the components. In such a dispenser two motors with microprocessor-controlled rotation speed move two pistons into the cartridge (e. g. a standard two-component 4:1 cartridge like Sulzer MIXPAC™ F-System). The motor speed may be controlled by pulse-width modulation. To extend the motor speed range, the voltage supply for each motor is adjustable. For various mixing ratios the first motor rotates with a given speed and the speed of the second motor follows with a factor based on the desired mixing ratio. The rotation speed and the absolute linear position of the pistons define the dispensed volume of the respective component. The property sensor may be arranged at the output end of the mixer to sense the mixing ratio there. The sensed value of the property “mixing ratio” can be used to control the motors to keep or achieve a desired mixing ratio in the two-component liquid.

The motors driving the respective pistons can be monitored by using the feedback from the actuator of the motor to monitor motor rotation speeds. The feedback loop uses information from the motor control system and does not need additional sensors. The motors can be monitored through a rolling average as they are running. When the speed of a motor falls below a set threshold, the system can determine that there is likely to be a blockage. This blockage can be caused by plungers inside the cartridge at setting up the dispenser or during dispensing by something preventing the free flow of liquid through the system.

The dispenser can be enhanced by using a third motor to drive a conveyor pump between the cartridges and the mixer. To relieve the cartridge pressure such a conveyor pump can pump the components from a common output nozzle of the two cartridges through the mixer. This will enable a much better and precise conveying especially for high viscosity liquids with different mixing ratios.

In certain embodiments the electrodes form a capacitor. The electrodes may be, for example, opposed parallel plates, such as opposed parallel square plates of 13 mm side length, spaced by about 1 millimeter. Generally, the distance between the electrodes may be at least 0.2 millimeter (mm). More viscous liquids generally require a larger distance between the electrodes to not impede the flow. Preferably, the distance between the electrodes is between 1.0 mm and 10.0 mm. Depending on the required throughput and the type of liquid, the distance between the electrodes may be, for example, 0.5 mm or more, 2.0 mm or more, 5.0 mm or more, 8.0 mm or more, 15.0 mm or more, or even a few centimeters.

In use, the dielectric of the capacitor comprises the liquid flowing through the sensing zone. The capacitor may have a capacitance of between 1 picofarad and 10 picofarad when the sensing zone is filled with air and does not contain liquid. Capacitors of such a capacitance achieve good signal-to-noise ratios in property sensors as described herein.

Ageing is known to change electric properties of certain liquids. Ageing may cause loss of water from a liquid, resulting in a lower number of polar molecules. Ageing may also cause chemically instable liquids to form new molecules. These changes over time may be detectable using a property sensor as described herein. Similarly, open time of an adhesive, which can be considered a form of short-term ageing, can be determined with a property sensor according to the present disclosure.

In certain embodiments the property of a liquid is an age of the liquid. The property sensor can derive a value for the age of the liquid. As is known in chemistry and process engineering, ageing of a liquid refers to a change in properties of the liquid occurring over time under normal storage conditions. “Age” of the liquid hence refers to a state of the liquid which it acquires, under its normal storage conditions, in the time span since it contained all its components for the first time.

It may occur that the pre-stored set of calibration data representing calibration impedance responses was recorded for a liquid that is not identical to the liquid used in the actual measurement, potentially resulting in a gross mismatch between calibration impedance responses and response impedances actually measured. The property sensor may thus also be used to detect that—e.g. erroneously—a considerably different type of liquid, or a liquid with considerably different properties, is run through the property sensor than the liquid that was intended.

In certain embodiments of the property sensor according to the present disclosure, the property sensor comprises a duct piece comprising the channel and the electrodes. The duct piece comprises an inlet for the liquid and an outlet for the liquid, facilitating flow of the liquid from the inlet to the outlet. The inlet is connectable with an output end of a tube conducting the liquid such as to let the liquid flow from the tube into the duct piece. The tube may be, for example, an output tube of a mixer or of an output hose of an extruder.

The inlet may have an inlet open cross section through which the liquid can enter the duct piece. The outlet may have an outlet open cross section through which the liquid can exit the duct piece. The size of the inlet open cross section and the size of the outlet open cross section may be equal. Alternatively, the size of the inlet open cross section may be greater than the size of the outlet open cross section. This would result in a faster flow of the liquid at the outlet of the duct piece than at the inlet, which may be desirable in certain cases. Yet alternatively, the size of the inlet open cross section may be smaller than the size of the outlet open cross section. This would result in a slower flow of the liquid at the outlet of the duct piece than at the inlet, which may be desirable in certain other cases.

The channel, e.g. in a duct piece, may comprise a widened portion through which the liquid can flow. The widened portion has an enlarged open cross section, the size of the enlarged open cross section being larger than the size of an open cross section of a portion of the channel located upstream of the widened portion. The larger cross section may help reduce the liquid pressure in the widened portion of the channel and may thereby reduce the risk of mechanical deformation of the channel. Also, the wider open cross section may help reduce the flow speed of the liquid in the widened portion of the channel.

The channel may comprise a single available flow path or a plurality of parallel available flow paths. Parallel flow paths allow the liquid to flow through different sub-channels. An open cross section of the channel, e.g. in the widened portion, may then be the sum of all open cross sections of all available flow paths of the channel at a given position of the channel along the flow direction.

The sensing zone may be comprised in the widened portion, or the widened portion may form the sensing zone. The reduced pressure and the reduced flow speed in the sensing zone may improve the accuracy of the property sensor and may help reduce the risk of mechanical deformation of the electrodes.

Hence, generally, in certain embodiments the channel comprises a first longitudinal section having a first open cross section available for the flow of the liquid, and a second longitudinal section, downstream from the first longitudinal section, having a second open cross section available for the flow of the liquid, wherein the second open cross section is larger than the first open cross section, and wherein the sensing zone is comprised in the second longitudinal section.

Generally, the duct piece may define a plurality of different parallel flow paths for flow of the liquid from inlet to outlet. One flow path of this plurality of flow paths is the flow path through the sensing zone. The other flow paths may be referred to as bypasses, as the liquid flowing through them bypasses the sensing zone.

In certain embodiments, the channel is shaped such that all of the liquid entering the duct piece through the inlet flows through the sensing zone. This arrangement may be beneficial because it allows sensing, in the sensing zone of the channel, of the property on the full volume of the liquid, which may result in a stronger response impedance signal.

In other embodiments, however, the duct piece is shaped such that a first portion of the liquid entering the duct piece through the inlet flows through the sensing zone to the outlet, and a second portion of the liquid entering the duct piece through the inlet flows to the outlet through a bypass or through a plurality of bypasses.

Hence in certain embodiments the channel comprises a bypass, arranged such that a first portion of the liquid flows through the sensing zone, and a second portion of the liquid flows through the bypass bypassing the sensing zone.

In certain embodiments one of the electrodes is arranged between the sensing zone and the bypass. In certain embodiments in which the channel comprises two or more bypasses, one of the electrodes is arranged between the sensing zone and a bypass. In other words, a/the bypass and the sensing zone may be arranged on opposite sides of one of the electrodes. Such arrangements may help improve the mechanical stability of the property sensor, as the same pressure in the liquid is exerted onto opposite sides of the electrode, which can help avoid deformation of the electrode. Deformation would otherwise result in variations in the capacitance of the capacitor formed by the electrodes and correspondingly in uncontrolled variations in the response impedances measured. These variations may even depend on the flow speed of the liquid.

Generally, both electrodes may benefit from pressure on both sides, in particular where the electrodes are flat conductive areas on surfaces of respective printed circuit boards. Hence in some embodiments, the duct piece is shaped such that a first portion of the liquid entering the duct piece through the inlet flows through the sensing zone to the outlet, a second portion of the liquid entering the duct piece through the inlet flows through a first bypass to the outlet, and a third portion of the liquid entering the duct piece through the inlet flows through a second bypass to the outlet. The sensing zone may be arranged between the electrodes. The first bypass and the sensing zone may be arranged on opposite sides of a first electrode of the two electrodes, and the second bypass and the sensing zone may be arranged on opposite sides of the second electrode of the two electrodes.

A property sensor as described herein may comprise a second sensing zone, arranged in a bypass, through which in use the liquid flows, two bypass electrodes for generating an electric field of one or more sensing frequencies in the second sensing zone. The property value deriver may be electrically connected to the bypass electrodes and operable to repeatedly i) generate, while the liquid flows through the second sensing zone, between the bypass electrodes an electric field of the one or more sensing frequencies in the second sensing zone; ii) sense between the bypass electrodes, at the one or more sensing frequencies, while the liquid flows through the second sensing zone and while the electric field is present, a second response impedance; iii) derive from the response impedances sensed in the (first) sensing zone and the second response impedance sensed in the second sensing zone a property value of the property of the liquid, using the pre-stored set of calibration data representing calibration impedance responses.

A property sensor comprising a first and a second sensing zone in a bypass may allow for a greater flow rate of the liquid through the sensor and/or lower pressure in the channel and may provide a stronger response impedance signal and a higher signal-to-noise ratio.

A property sensor according to the present disclosure may further comprise a temperature sensor for sensing a temperature of the liquid in the channel or in the sensing zone. Response impedances may depend strongly on the temperature of the liquid, hence knowledge of the temperature of the liquid in the channel, and in particular of the liquid in the sensing zone, may increase the accuracy of the derivation, from the response impedance, of a value of the property of the liquid, using the pre-stored set of calibration data representing calibration impedance responses. It is desirable that the temperature of the liquid in the sensing zone be known to an accuracy of about 0.2° C.

The temperature sensor may be arranged in the duct piece. The temperature sensor may be arranged such that two opposed outer surfaces of the temperature sensor are in surface contact with the liquid. This arrangement may help improve the precision of the temperature sensing.

A property sensor according to the present disclosure may further comprise a flow speed sensor for sensing a flow speed of the liquid through the channel or through the sensing zone. A flow speed sensor may be useful in identifying partial or complete blockages in the channel or in other devices through which the liquid flows before it is dispensed. Where the liquid is a curable composition, a flow speed sensor may help determine the time elapsed since curing started and thereby help estimate a curing status or curing degree of the curable composition.

In certain embodiments, the flow sensor comprises an upstream temperature sensor and a downstream temperature sensor as well as a heating resistor, arranged close to the downstream temperature sensor. Current applied to the heating resistor heats up the surrounding liquid. The flow rate of the liquid can be derived in known ways from the temperature difference of the liquid determined between the temperature sensors. The upstream and downstream temperature sensors are in good thermal contact with the liquid. They may, for example, be arranged in the duct piece, e.g. in a housing of the duct piece. Where the property sensor comprises a duct piece, the flow sensor may be arranged in the duct piece.

For detachably connecting the duct piece to an existing mounting bayonet of a dual-cartridge dispenser mentioned above, a fastening device is slipped over the inlet of the duct piece before attaching the duct piece to the dispenser and then rotated to attach the duct piece to the dispenser. The fastening device comprises a bayonet-nut with an integrated hexagonally-shaped hole at an opposite end of the bayonet opening in combination with a hexagonally-shaped end of the duct piece inlet.

After attaching the duct piece to the cartridge, the bayonet-nut can be rotated so the duct piece is fixed in position. During the rotation of the nut the flat areas of the hexagonal hole of the nut will be placed in front of the hexagonal edges of the duct piece. This avoids axial movement of the duct piece.

In certain industrial dispensing systems for liquid curable compositions, such as curable adhesives, it may be advantageous to place a first property sensor at an upstream location of the flow of the liquid, and to place a second sensor at a downstream location of the flow. Each property sensor may use its own set of calibration data representing calibration impedance responses. Each property sensor senses a value of a property “curing degree” of the curable liquid. Since the liquid continues to cure while it travels from the first sensor to the second sensor, the sensors can determine the curing speed of the liquid. For fast-curing liquids a short distance of travel from the first sensor to the second sensor may be appropriate. For slower-curing liquids it may be advantageous to have more time between the two measurements and hence a longer distance to travel. A tube or hose of an appropriate length, through which the curable liquid travels from the upstream sensor to the downstream sensor can help provide sufficient time between the two measurements to have a detectable difference in the degree of curing detected by the two property sensors.

Also, in a calibration process for a curable liquid, an arrangement of an upstream property sensor and a downstream property sensor can provide calibration impedance response data for two different curing degrees of the liquid and hence a more complete set of calibration impedance responses in a short time.

A property sensor as described herein may be connected with a mixing device to form a sensored mixer. The property sensor can thereby determine a value of a property of a mixed liquid flowing out of the mixing device.

The mixing device may be operable to mix two or more components to produce a mixed liquid at a mixing device output. The property sensor may determine, for example, a value of the mixing ratio of the mixed liquid flowing out of the mixing device output. Should the mixing ratio thus determined be outside a desired bandwidth of allowable mixing ratios, the property sensor generates a warning signal to prompt an operator action or generates a control signal to cause a change in the relative input volumes of the components entering the mixing device.

The present disclosure thus also provides a sensored mixer, comprising a mixing device for mixing two or more components to produce a mixed liquid at a mixer output, and a property sensor as described herein, in fluid communication with the mixer output such that the mixed liquid can flow from the mixer output through the sensing zone.

In a further aspect, the present disclosure also provides a process of determining a property value of a property of a liquid, comprising the steps, in this sequence, of
i) providing a liquid and a property sensor as described herein, and having the liquid flow through the sensing zone;
ii) generating, while the liquid flows through the sensing zone, between the electrodes an electric field of the one or more sensing frequencies in the sensing zone;
iii) sensing between the electrodes, at the one or more sensing frequencies, while the liquid flows through the sensing zone and while the electric field is present, a response impedance; and
iv) deriving from the response impedance a property value of the property of the liquid, using the pre-stored set of calibration data representing calibration impedance responses.

This determination process allows to determine a property of a liquid, like, for example, a mixing ratio of a two-component adhesive or a curing status of a curable composition or an ageing status. The calibration impedance responses measured previously at the one or more sensing frequencies and at different property values of a property of the liquid forms a multi-dimensional data field which is specific for the liquid. This data field is represented by the set of calibration data. It allows a property value deriver as explained above to determine, from a response impedance actually measured, a value of the property of the liquid.

The property sensor described above is operable to perform steps ii), iii), and iv) of the determination process.

When describing the property sensor according to the present disclosure, several variations that can be implemented for generating the electric field, for sensing a response impedance and for deriving a property value, were disclosed herein. These variations can equally be implemented for the determination process described in the preceding paragraph and will generally yield the same benefits and advantages.

The first step i) of the determination process may be preceded by a calibration process, i.e. by a preceding step of measuring calibration impedance responses and pre-storing, in the data storage device, a set of calibration data representing the calibration impedance responses, measured in the same property sensor using an identical liquid. The identical liquid has properties identical to the properties of the liquid that is later to be measured in the property sensor to determine a value for one of its properties. It might also be referred to as a “calibration liquid”, as it is used to generate calibration impedance responses and the calibration data representing the calibration impedance responses.

This preceding step may comprise the substeps of m) providing a property sensor comprising a channel comprising a sensing zone through which—in use—the identical liquid flows, comprising two electrodes for generating an electric field of one or more sensing frequencies in the sensing zone; n) providing an identical liquid having a property of a known property value, o) generating, while the identical liquid flows through the sensing zone, between the electrodes an electric field of the one or more sensing frequencies in the sensing zone; and p) sensing between the electrodes, at the one or more sensing frequencies, while the identical liquid flows through the sensing zone and while the electric field is present, a calibration impedance response.

This preceding step can be repeated several times to generate, for a plurality of property values of the property of the calibration liquid, a set of calibration data representing the calibration impedance responses, useable in the determination process described above.

In certain embodiments of the determination process, at least one of the one or more sensing frequencies is a frequency of 32 Hertz (Hz), of 100 Hz, 1000 Hz, 5000 Hz or of 8000 Hz. Generally, at least one of the one or more sensing frequencies may be a frequency of between 1 Hertz and 10000 Hertz (10 kHz). At least one of the one or more sensing frequencies may be a frequency between 1 Hertz and 100000 Hertz (100 kHz). In certain preferred embodiments of the determination process, the sensing frequency is a frequency between 200 Hz and 2000 Hz, because small differences in values of important properties of certain industrial liquids result in particularly strong differences in response impedance in this frequency range.

The voltage between the electrodes may be a voltage between 0.1 Volt and 100 Volt. It is typically a few volts, for example a voltage of between 1 Volt and 20 Volt, preferably between 1 Volt and 10 Volt, for certain liquids and certain arrangements of the electrodes the voltage between the electrodes may be 0.1 Volt, for other liquids and other electrode arrangements the voltage between the electrodes may be 100 Volt, or any voltage between 0.1 Volt and 100 Volt.

In certain embodiments the amplitude of the electric field is between 100 Volt per meter and 20000 Volt per meter. Such amplitudes, at sensing frequencies in the range explained above, have shown to facilitate reliable sensing of response impedances at adequate accuracy, while avoiding electrolysis or electrical discharges through the liquid.

Hence in certain of these embodiments, at least one of the one or more sensing frequencies is a frequency of between 1 Hertz and 10000 Hertz, and the amplitude of the electric field is between 100 Volt per meter and 20000 Volt per meter.

The determination process and the property sensor can be used for determining a property value of a broad spectrum of liquids. Almost any liquid which yields different response impedances at different values of a property can, in principle, be used. In certain embodiments of the determination process the liquid is an adhesive or a curable adhesive or a two-component adhesive or a multi-component adhesive or a curable two-component adhesive. In certain embodiments, a liquid is a liquid adhesive. In certain of these embodiments, a liquid is a curable liquid adhesive. In certain of these embodiments, a liquid is a curable two-component liquid adhesive. “Two-component” refers to the adhesive being composed of a first component and a second component which are mixed, e.g. in a static or dynamic mixer, to form the adhesive. Similarly, “multi-component” refers to the adhesive being composed of a plurality of components, e.g. two, three, four or more components, which are mixed, e.g. in a static or dynamic mixer, to form the adhesive.

A liquid referred to herein in the context of the property sensor or of the determination process may have a dynamic viscosity of between 10 Pa·s (Pascalseconds) and 40,000.0 Pa·s, measured at a temperature of 25° C. The term “viscous liquid” used herein refers to a liquid having a dynamic viscosity of between 10 Pa·s and 40,000 Pa·s. Liquids of a higher dynamic viscosity may flow through the sensing zone of the property sensor only under excessive pressure which risks to damage the sensor. Dynamic viscosities can be determined according to ASTM D7042-12a using a Stabinger viscometer.

Hence in certain embodiments of the property sensor and of the determination process the liquid has a dynamic viscosity of between 10 Pascalseconds and 40,000.0 Pascalseconds, measured at 25° C. according to standard ASTM D7042-12a in its version in force on 1 Jul. 2020.

The present disclosure also provides a set of calibration data representing calibration impedance responses for use in the determination process described above, wherein the set of calibration data further represents a property value of a property of a calibration liquid at which property value one of the calibration impedance response was sensed.

A value of a specific property of the liquid can only be determined if a set of calibration impedance responses had been recorded for a plurality of values of that specific property of an identical liquid. Such a set of calibration impedance responses can be generated by running a calibration liquid of a known value of a property in the determination process and in the property sensor and recording the response impedance for this value of the property of the calibration liquid, and by repeating this run for several values of the same property of the calibration liquid. The resulting set of calibration impedance responses is stored on the data storage device of the property sensor before running the actual liquid to be measured through the property sensor or the determination process. The “pre-” in “pre-stored” refers to this “before”.

The calibration liquid is an identical liquid, identical to the liquid that is later run in the property sensor or the determination process to determine a value of the property.

The set of calibration data representing calibration impedance responses may be pre-stored in any format on the data storage device. It may, for example, be pre-stored in the format of n-tuples having n elements, wherein an element of the n-tuple is a property value, and another element of the n-tuple is a calibration impedance response determined at that property value.

A property value may be determinable only through measurements at different sensing frequencies. In certain scenarios, in which two properties of the liquid vary over time, e.g. mixing ratio in a two-component curable liquid and curing degree, a 1:4 mixing ratio of the uncured liquid may cause the same response impedance at a specific sensing frequency as a 1:3 mixing ratio of the liquid after five minutes of curing. If a single sensing frequency is used, this ambiguity may not be resolvable. However, when sensing response impedances at two different sensing frequencies, the response impedances may be different and can help distinguish between the mixing ratios.

Sensing a response impedance at different sensing frequencies may therefore help resolve ambiguities and derive the property value with a greater precision and reliability. To do this, the pre-stored set of calibration data representing calibration impedance responses needs to contain data sets recorded for different sensing frequencies, and each data set contains a value, e.g. as an element in an n-tuple, for the sensing frequency.

Hence in certain embodiments of the set of calibration data representing calibration impedance responses, the set of calibration data may further represent a sensing frequency at which sensing frequency one of the calibration impedance responses was sensed.

Temperature of the liquid in the sensing zone normally has a significant impact on the response impedances measured. A calibration impedance response data point advantageously contains a value of the temperature of the liquid in the sensing zone at which temperature the calibration impedance response was recorded. The pre-stored set of calibration data representing calibration impedance responses then needs to represent this temperature, facilitating the use of the calibration impedance responses for deriving from response impedances sensed at similar temperatures a property value of the property of the liquid.

Hence in certain embodiments of the set of calibration data representing calibration impedance responses, the set of calibration data further represents a temperature of the liquid in the sensing zone at which temperature one of the calibration impedance responses was sensed.

Certain sets of calibration data combine representation of sensing frequency and temperature. In certain embodiments of the set of calibration data representing calibration impedance responses, the set of calibration data further represents a sensing frequency at which sensing frequency one of the calibration impedance responses was sensed, and/or the set of calibration data further represents a temperature of the liquid in the sensing zone at which temperature one of the calibration impedance responses was sensed.

Property sensors and related processes described herein may find use in a variety of different applications like, for example, double checking an adhesive material in safety critical bonds in the rail, automotive or aerospace industry that gets on the critical parts and documenting the measurements. A second potential application is in response-based purging: automated systems for dispensing curable materials often work with cycle-times which include breaks for readjusting, joining, part exchange, etc. During those breaks material cures in the mixing nozzles and needs to be purged at a certain level of cure. The sensor can sense a current curing state and, when necessary, initiate curing, resulting in less waste and optimized cycle times. A further application may be in dispensing: At the start and at the end of the usage of static mixer systems often deviation occur in mixing ratio and mixing quality. The property sensor can reveal those and trigger adjustments in the dynamic parameters of the dispensing system, e.g. in flow rates, pre-pressure, timings. In this way also hose and reservoir ballooning effects might be mitigated. A further application may be in working samples/material twins where a sensor can be filled at a certain process step and then follow all process conditions like the material on the part undergoing curing oven, painting environment, etc. and regularly be checked to control the curing of adhesives or fillers during complex processes. The property sensor and the processes according to the present disclosure can also be used for shelf-life indication: Materials that have condition-based shelf-life specifications can be tested with a comparison of sensor data with calibration data on material that was shelved under controlled conditions.

Aspects of the present disclosure will now be described in more detail with reference to the Figures exemplifying particular embodiments.

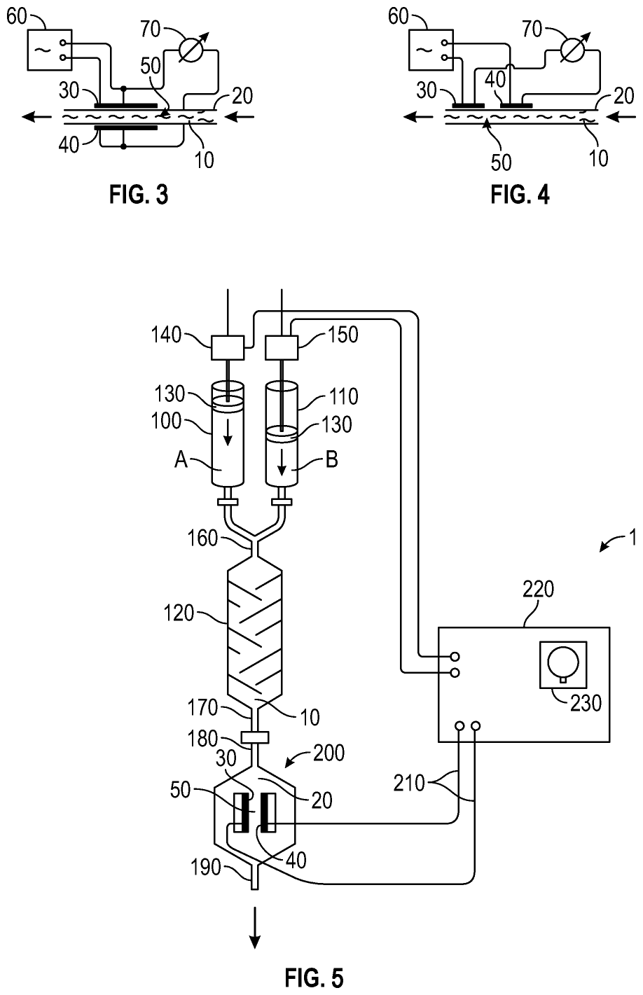

FIG. 3 illustrates, in a combined sectional view and circuit diagram, some key elements of a property sensor according to the current disclosure. A liquid 10 flows through a channel 20. A first electrode 30 and a second electrode 40 are arranged opposite to each other and can create an electric field between the electrodes 30, 40. The section of the channel 20 in the electric field between the electrodes 30, 40 is a sensing zone 50, in which a property value of a property of the liquid 10 can be determined.

For creating an electric field between the electrodes 30, 40 in the sensing zone 50, the electrodes 30, 40 are electrically connected to a voltage source 60 which applies an alternating (AC) voltage of one or more frequencies, the “sensing frequencies”, to the electrodes 30, 40, so that the liquid 10 in the sensing zone 50 is exposed to an alternating electric field.

A current meter 70 is connected to the electrodes 30, 40 to measure current through the electrodes 30, 40 and thereby sense the impedance between the electrodes 30, 40. This impedance is sensed in response to the electric field applied between the electrodes 30, 40, and is influenced by the properties of the liquid 10 in the sensing zone 50, the impedance is therefore also referred to herein as “response impedance”.

Useful sensing frequencies are frequencies that may range, for example, from 1 Hertz (Hz) to 10000 Hz. For an arrangement as shown in FIG. 3, a sensing frequency of 250 Hertz has been successfully used.

In the embodiment of FIG. 3 the electrodes 30, 40 are opposed flat parallel square plates of 13 mm side length, spaced at about 1 mm from each other, which form a plate capacitor. The resulting capacitance of the plate capacitor in air is approximately two picofarad (pF).

While the plate capacitor arrangement of the electrodes 30, 40 in the embodiment of FIG. 3 creates a homogenous electrical field between the plates, other field geometries can be useful, for example the arrangement illustrated in FIG. 4, showing elements of an alternative property sensor according to the present disclosure. In this embodiment, the flat electrodes 30, 40 are located on the same side of the channel 20. Arranging the electrodes 30, 40 side by side on the same side of the channel 20 creates a highly inhomogeneous electric field. Certain field lines of that electric field, in the fringe field, extend through the sensing zone 50 so that the electric field can be used to sense properties of the liquid 10 in the sensing zone 50.

FIG. 5 is a side view of a property sensor 1 according to the present disclosure mounted to a dispenser and mixer for a viscous two-component adhesive. First component A and second component B of the adhesive are pushed out of respective cartridges 100, 110 into and through a static mixer 120. At the output 170 of the static mixer, the mixed adhesive passes through a property sensor 1 according to the present disclosure before being dispensed at the output of the duct piece of the property sensor 1. The property sensor 1 senses the mixing ratio of components A and B in the mixed adhesive.

The cartridges 100, 110 contain the viscous components A and B, respectively. A respective piston 130 is moved further into the cartridge 100, 110 and pushes the component A, B out. The pistons 130 are driven by respective motors 140, 150 which are individually controllable, and the pressure generated by the pistons 130 moves the unmixed components and—after mixing—the mixed viscous adhesive 10 through the static mixer 120 and the channel 20 of the property sensor 1. The motors 140, 150 are connected to the property sensor 1 in order to establish a feedback loop: When the property sensor 1 senses a mixing ratio outside an acceptable band of desired mixing ratios, the motors 140, 150 can be individually controlled such as to push more of component A and/or less of component B (or vice versa) into the static mixer 120 in order to adjust the mixing ratio towards the desired mixing ratio. Both motors 140, 150 can be controlled separately to obtain a desired total throughput per second of mixed adhesive to be dispensed.

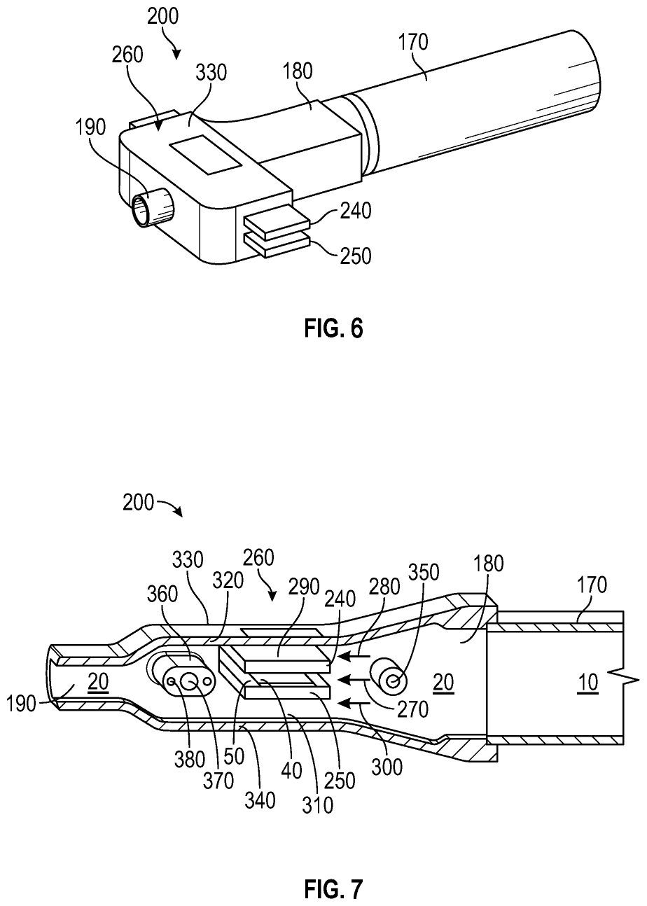

The static mixer 120 receives the unmixed components A and B of the two-component adhesive at an input end 160. Lamellae inside the static mixer 120 redirect the flow of the input materials many times and introduce shear forces that help mix the components A and B with each other. The output end 170 of the static mixer 120 is connected to an inlet 180 of a duct piece 200 (shown in longitudinal sectional view) containing the channel 20, the sensing zone 50 and the electrodes 30, 40, as described in the context of FIGS. 1 and 2, of the property sensor 1. The mixed adhesive 10 can thus exit the static mixer 120 and enter the duct piece 200. The duct piece 200 will be explained in more detail in FIG. 6. At the outlet 190 of the duct piece 200, the mixed adhesive 10 is dispensed.

The electrodes 30, 40 are flat, parallel plates facing each other. They are connected via wires 210 to a computerized control system 220, which provides an AC voltage of 6 Volt to the electrodes 30, 40 to generate the electric field at a sensing frequency of 250 Hertz in the sensing zone 50. The control system also measures current through the electrodes 30, 40 and senses a response impedance between the electrodes 30, 40, taking into account the current, the voltage and the sensing frequency.

The computerized control system 220 has an internal data storage device 230, namely a harddisk 230, on which a set of calibration data representing calibration impedance responses is stored. These calibration impedance responses were recorded previously, i.e. before the measurements, in a calibration process using the same duct piece 200 and identical components A, B resulting in an identical mixed viscous adhesive 10. During the calibration process the mixing ratio A/B was adjusted to certain fixed calibration mixing ratios (CMR), and for each of these calibration mixing ratios the calibration impedance response (CIR) was sensed at five different calibration sensing frequencies (CSF). These data sets, e.g. in the form of triples of (CMR, CSF, CIR), are recorded on the harddisk 230. They form a three-dimensional data field, which is specific for the viscous adhesive. The data sets are used to build a parametrized multi-dimensional model, based on multi-dimensional polynomials, of the data sets. This parametrized model facilitates quick interpolation by a computer between individual data sets and quick derivation of a property value of a property of the liquid in the subsequent measurement. The parameters of the parametrized model form a set of calibration data which represents the data sets recorded during the calibration process.

Later, when running an actual measurement of the value of the property “mixing ratio” of a viscous two-component adhesive of components A and B in the property sensor 1, the measured impedance responses (MIR), each measured at certain measurement sensing frequencies (MSF), are recorded in the control system 220. In order to derive a value for the mixing ratio from the measured impedance responses at the measurement sensing frequencies, software running on the control system 220 identifies, within the set of calibration impedance response triples, those triples having the closest calibration response impedances, closest to the measured impedance responses, and the closest calibration sensing frequencies, closest to the measurement sensing frequencies. This identification and a potential interpolation can be performed easily by using the parametrized multi-dimensional polynomials modelling the plurality of data sets, i.e. the plurality of triples of (CMR, CSF, CIR). From those calibration data, the software derives a value for the (sofar unknown) mixing ratio in the actual measurement.

The same sensing frequencies used for calibration will often be used also for the measurement. There may, however, occur a mixing ratio in the measurement for which no calibration impedance response had been determined in calibration. So there may be not an exact match in both sensing frequency and response impedance between a triple in the calibration data set. In such a case, an interpolation between two suitably chosen calibration triples, containing two calibration impedance responses close to the measured response impedance, yields an interpolated calibration mixing ratio which can then be considered the mixing ratio in the measurement. The interpolation is performed by software on the control system 220, using the parametrized multi-dimensional polynomials.

The result of the interpolation and derivation is a value of the mixing ratio of components A and B in the mixed two-component adhesive 10 in the sensing zone 50 during the measurement.

In the present embodiment, the calibration impedance responses were measured in their dependence on two parameters, namely on the sensing frequency and on the mixing ratio. In other embodiments, dependence of impedance responses on further parameters may be taken into account, such as, for example, dependence on the temperature of the adhesive in the sensing zone. A data set of the calibration impedance responses would then be a quadruple of values, such as (CMR, CSF, CIR, Temperature), and the pre-stored set of calibration impedance responses would be a set of quadruples forming a four-dimensional data field, which is specific for the viscous adhesive. Taking further parameters into account could make a data set be a quintuple of values, or high-order tuples of values, so that the data sets of calibration impedance responses is a multi-dimensional data field of more dimensions and can be represented by different parametrized multi-dimensional polynomials.

The control system 220 records the values for mixing ratio, with a time stamp, for quality assurance. In the particular embodiment shown in FIG. 3, the motors 140, 150 pushing the respective components A and B into the static mixer 120 are connected to, and controlled by, the control system 220. The mixing ratio derived during the actual measurement is checked continuously against a desired mixing ratio. If its deviation from the desired mixing ratio is larger than acceptable, the control system 220 changes the speed of one or both of the motors 140, 150 suitably to adjust the measured mixing ratio towards the desired mixing ratio.

FIG. 6 is a perspective view of the duct piece 200 of the property sensor 1 of FIG. 5. A housing 330 of the duct piece 200 forms an inlet 180 and an outlet 190, the inlet 180 being connected to the output end 170 of the static mixer 120 (not shown). The viscous adhesive 10 is dispensed through the outlet 190. The duct piece 200 thereby forms a channel 20 for the viscous adhesive 10 flowing from inlet 180 to outlet 190. In operation, the duct piece 200 is completely filled with the mixed viscous adhesive 10.

As the shape of the housing 330 indicates, the duct piece 200 comprises a widened middle portion 260. The channel 20 is wider in the middle portion 260 of the duct piece 200 than it is at the inlet 180, so that the adhesive 10 has, in the middle portion 260, a larger open cross section available to flow through. The size of the widened open cross section in the middle portion 260 is larger than the size of the open cross section of the inlet 180. This reduces the pressure and the flow speed of the adhesive 10 in the middle portion 260 of the duct piece 200, which in turn facilitates precise sensing of response impedance in the duct piece 200.

In this embodiment, the electrodes 30, 40 of FIG. 5 are formed by conductive layers on two respective printed circuit boards (PCBs) 240, 250, which extend laterally through the duct piece 200 and stick out on the sides of the duct piece 200. The first electrode 30 is a conductive layer on the lower surface of the first, upper PCB 240. It faces the second electrode 40, which is a further conductive layer on the upper surface of the second, lower PCB 250. The electrodes 30, 40 are thus parallel conductive plates, separated by a gap through which a portion of the adhesive 10 flows from inlet 180 to outlet 190.

It is generally advantageous to keep the extension of the electrodes 30, 40 short in direction of the flow path 270, as this reduces the flow resistance and the pressure of the liquid 10 on the electrodes 30, 40.

FIG. 7 is a perspective cut-away side view of the duct piece 200 of FIG. 6. Through the output end 170 of the static mixer, liquid adhesive 10 is conveyed through the duct piece 200 via the channel 20 and is dispensed through the outlet 190.

The upper PCB 240 and the lower PCB 250 are arranged parallel to each other and parallel to the flow direction of the liquid adhesive 10 in the channel 20 between inlet 180 to outlet 190. Each PCB 240, 250 has, on the surface facing the other PCB 240, 250, a flat conductive patch forming an electrode 30, 40, of the property sensor 1. In FIG. 7, only the electrode 40 on the upper surface of the lower PCB 250 is visible, the opposed electrode 30 on the lower surface of the upper PCB 240 is not visible. An electric field is generated between the electrodes 30, 40, as explained above. The electrodes 30, 40 are embedded in the flow of liquid adhesive 10 and in contact with the liquid adhesive 10. The electrodes 30, 40 can be electrically connected via conductive traces (not shown) on the surface of the respective PCB 240, 250, extending through the walls of housing 330 to outside the housing 330.

The sensing zone 50 is the portion of the channel 20 between the electrodes 30, 40. A first portion 270 of the liquid adhesive 10 flows through the sensing zone 50 between the electrodes 30, 40 and is used to sense a response impedance between the electrodes 30, 40. In the embodiment illustrated in FIG. 7, the duct piece 200 defines three different parallel flow paths for flow of the liquid adhesive 10 from inlet 180 to outlet 190. The first flow path 270 is through the sensing zone 50 between the electrodes 30, 40. A second flow path for a second portion 280 of the adhesive 10 is through an upper bypass 290 between the upper surface of the upper PCB 240 and the upper wall 320 of the housing 330 of the duct piece 200, a third flow path for a third portion 300 of the adhesive 10 is through a lower bypass 310 between the lower surface of the lower PCB 250 and the lower wall 340 of the housing 330. All three flow paths, including the bypasses 290, 310, are part of the channel 20 through which the adhesive 10 flows from inlet 180 to outlet 190.

Each of the bypasses 290, 310 has an open cross section for the flow of the liquid adhesive 10 that is roughly equal to the open cross section of the flow path through the sensing zone 50 between the electrodes 30, 40. The pressure difference between upper and lower surface of a PCB 240, 250 is therefore small, which helps reduce or even avoid deformation of the PCBs 240, 250 and a related error in the response impedance sensing.

The duct piece 200 comprises a temperature sensor 350, arranged in the middle of the channel 20 before the channel 20 divides into different flow paths 50, 290, 310. The temperature sensor 350 senses the temperature of the adhesive 10 before a portion 270 of it enters the sensing zone 50. Some response impedances and calibration impedance responses measured to derive a value of certain properties of the adhesive 10 vary strongly with temperature of the adhesive 10, so it is important to measure the temperature with high accuracy, e.g. an accuracy of +/−0.1° C. In certain property sensors 1, however, in which it may be guaranteed that adhesives 10 entering the duct piece 200 have a well-defined temperature, the temperature sensor may not be needed.

The duct piece 200 also comprises a flow sensor 360 for determining a flow rate of the adhesive 10 through the channel 20. Where the adhesive 10 changes its property within the short time during which it travels through the mixer 120 and into the channel 20, the flow sensor 360 may allow to determine approximately the flow time through the mixer 120 and into the duct piece 200, and thereby to estimate an approximate value of the property. Also, the flow sensor 360 can help detect an interruption in dispensing and related curing of the adhesive 10 in the duct piece 200, which could render certain measurement results meaningless. The flow sensor 360 is arranged downstream from the sensing zone 50 and comprises a heating resistor 370 and a second temperature sensor 380, arranged close to the heating resistor 370. A suitable electric current applied to the heating resistor 370 heats the surrounding adhesive 10, and a flow rate can be derived from the temperature difference between the first temperature sensor 350 upstream of the sensing zone 50 and the second temperature sensor 380.

Processor Controlled System and Method for formulating Multiple Structural Adhesives using a limited number of Components

Disclosed systems and methods could be controlled and/or programmed, for example by a programmable logic controller (PLC) to dispense the desired adhesive formulation based on a customer's requirements—for example, desired physical properties for an application (i.e. working life, adhesion, strength, etc.). The dispensing system could be supplied with multiple Parts 1, Parts 2, sub-Parts 1, sub-Parts 2, compatible additives, or any combinations thereof based on the specific adhesive system, application requirements, or combinations thereof. Once the required properties were selected, the PLC could determine a formulation that would provide those properties based on the right combination of Parts, sub-Parts, compatible additives, or any combinations thereof. The combination could be based on past design of experiment (DOE) results and artificial intelligence and machine learning (AI/ML) technology, for example. Because structural adhesive performance is impacted by chemistry and stoichiometry of the adhesive, the computer would control the amount of each of the components needed to provide the desired adhesive performance properties and then determine the right amounts of each to have the right stoichiometry. These components would be dispensed and thoroughly mixed in the right amounts for the desired adhesive performance properties

The structural adhesive performance properties are based on the Part 1 and Part 2 compositions used. Part 1 can be made up of a combination of two or more compatible sub-part 1s, Part 2 could be made up of two or more compatible sub-parts 2, or any combination thereof. In some embodiments, each of the parts (sub-parts, or any combination thereof) can provide and impact one or more specific performance properties. In addition, other additives could be added based on the specific application needs and requirements such as color/pigments, UV and antioxidant stabilizers, fillers, etc., for example. Therefore, the adhesive formulation could be formed by combining more than three components based on the application requirements. For more complicated structural adhesive applications, the dispensing system could allow even additional inputs to meet all customer needs.

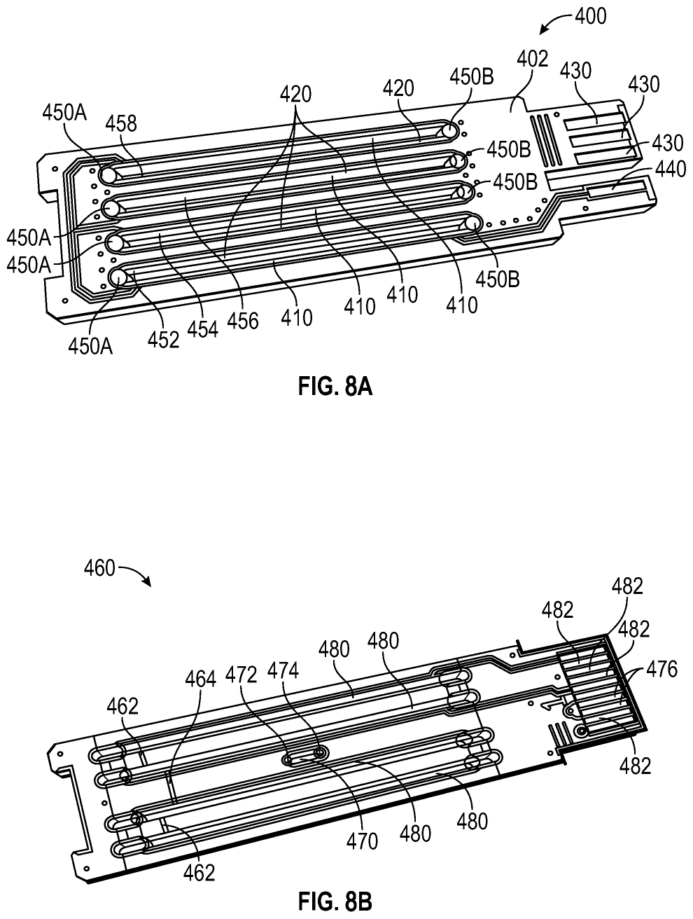

FIGS. 8A-8B illustrate material measurement flow sensors in accordance with embodiments herein. FIG. 8A illustrates a PCB material measurement flow sensor 400. As illustrated in FIG. 8A, a sensing system 400 includes a PCB board 402 with one or more grounds 430 and a TX contact 440. The TX contact provides a transmitting signal to each transmitting electrode 410. Four RX contacts (not shown), located on the reverse side of the PCB, receive the indication of a sensed impedance from each of the electrode pairs. The electrical potential of each receiving electrode 420 is electronically regulated to ground potential separately. The regulator action for each receiving electrode, in some embodiments, is interpreted as an impedance signal for each electrode pair. In the illustrated embodiment, four separate measurements channels can provide information, each through its own TX contact 440 and RX contact (not shown).

In the illustrated embodiment, a sensing system 400 has four electrode pairs, with four transmitting electrodes 410, each paired with one of four receiving electrodes 420. However, it is expressly contemplated that more, or fewer, electrode pairs may be present, depending on available area on a PCB board and sensing needs.

Each of the electrode pairs are decoupled from the adjacent pair such that four separate conductivity measurements are received, one from each electrode pair 410, 420. Sensing system 400 is placed, in some embodiments, perpendicularly to the flow of material, such that a first sensing area 452 receives a first portion of material flow, a second sensing area 454 receives a second portion of material flow, a third sensing area 456 receives a third portion of material flow, and a fourth sensing area 458 receives a fourth portion of material flow. Therefore, system 400 can simultaneously generate four different signals relative to a single material flow, providing a better picture of whether a mixing ratio (or other measured parameter) is consistent across an entire sensing area.

In comparison to previous sensing systems, such as system 3, conductivity measurements required both a positive and a negative pole, which would require two PCBs per electrode pair. System 200 could be modified, but would require 5 PCB boards in a stack, with precise spacing between each adjacent PCB board. In contrast, system 400 allows for four measurements to be taken simultaneously with a single PCB. It also provides a larger surface area for material flow, through a shorter sensor distance.

FIG. 8A illustrates an embodiment where each electrode pair is part of a slot 452, 454, 456, 458. However, it is also contemplated that, instead of being closed on both sides, a sensing area may include a pair of electrodes on a protrusion, or within an aperture, in a “comb”-like structure. However, it may be preferred for both ends to be closed from a structural standpoint, especially with viscous fluids.

As described further herein, the electrodes 410, 420 may be formed by metallization on the interior surface of slides 452, 454, 456, 458, using copper for example. The metallization process may cause electrodes 420 to be connected to electrodes 410. Therefore, a decoupling or disconnecting step is needed. This can be done by breaking the connection, for example by drilling a hole in the positions 450A and 450B as illustrated, by punching out a perforated component, milling, nibbling, etching, laser cutting or another suitable method.

Systems and methods herein may be used for a variety of materials being dispensed. PCB boards often have a maximum operating temperature less than 170° C., which limits the temperature of materials that can be dispensed through a sensor system 400. Materials may have a range of viscosities, for example up to around 105 Pas. Higher viscosity might result in a dispensing pressure being insufficient to force the material through slots 452-458 without breaking the sensor. However, higher viscosity materials may be accommodated by increasing the width of slots 452-458. However, sensing system 400 may be less sensitive. Similarly, for materials with particulates, such as suspensions for example, particle sizes have to be smaller than the width of slots 452-458. Additionally, systems herein may be limited to solvents that do not cause corrosion or otherwise damage the PCB 402 or electrodes 410, 420.

FIG. 8B illustrates another embodiment of a sensing system 460, which includes a built-in temperature sensor 470. Temperature sensor 470 sits within a slot with a connection point 472 for a ground signal and a connection point 474 for a temperature signal. Ground signal connection point 472 connects to a ground signal communicator 482. Temperature signal communication point 474 connects to a temperature signal communicator 476. Similar to the embodiment of FIG. 3A, four impedance or conductivity sensor slots 480 are also present, each connected to a ground signal 482. However, it is noted that two different spacings between slots are present in the embodiment of FIG. 8B. A first spacing, 462 is present between a first and second slot 480, and between a third and fourth slot 480, while a second spacing 464 is present between second and third slots 480. Increased spacing 464 may provide improved shielding against interference between electromagnetic fields generated by each electrode pair.

Many mixing processes are at least partially temperature dependent, with material properties like viscosity changing with temperature. Temperature sensors inserted from an external point are often fragile and need to be in the middle of the flow of the material being tested. In the embodiment of FIG. 8B, a temperature sensor is sealed within a housing, which keeps it isolated from the material. The seal layer may be a layer of varnish, for example, which may allow for the thermal contact to be improved relative to other housing materials. As illustrated, the temperature sensor connects via contacts 482 on the edge connector.

FIGS. 8A-8B illustrates an embodiment where slots 452-458, 470 and 480 are ovular in shape, with a generally straight body and rounded ends. However, other configurations are possible. Electrodes 410, 420 may be curved, for example, or otherwise shaped to accommodate an available volume of a dispensing system.

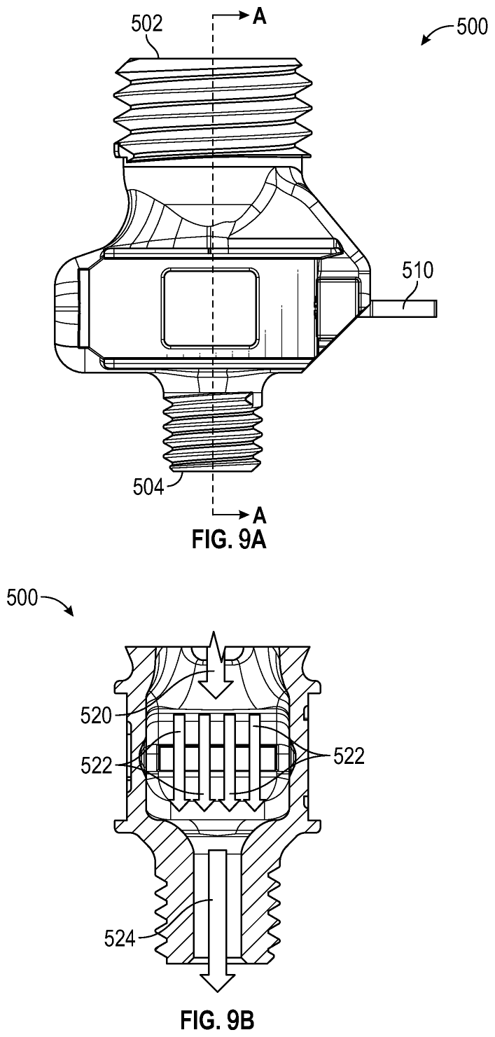

FIGS. 9A-9B illustrate a sensor arrangement in an adhesive dispenser in accordance with embodiments herein. FIGS. 9A-9B illustrate an embodiment where four electrode pairs are present on a single PCB. However, as discussed herein, it is expressly contemplated that more, or fewer, electrode pairs may be used.

A sensor housing may couple to a fluid container, e.g. at the bottom of cartridge 100 or 110 of the dispenser illustrated in FIG. 5, or at the end of mixer 120, for example.

A material mixture may enter sensor housing 500 at input 502, and may exit at output 504. A sensing system 510 may be received by, or positioned within sensing area 500. In some embodiments, sensing system 510 is a replaceable sensing system that can be removed from housing 500 when an operation is complete. In some embodiments, housing 500 includes a self-sealing material to seal sensing system 510 in place. In some embodiments, an O-ring, gasket, or other compressible material is used as a seal. However, it is also expressly contemplated that sensing system 510 may be integrated into housing 500 or sealed into housing 500 such that it is not removeable, for example using adhesive.

Sensing system 510 may be a PCB with a number of slots, protrusions, or apertures, each of which may include a pair of electrodes that can sense a conductivity of the material mixture when in direct contact with the material mixture. As illustrated in FIG. 9B, a cross-sectional view of the sensing area 500 of FIG. 9A, a material stream 520 may be forced through a number of channels 522, each of which includes a transmitting and receiving electrode and, therefore, can take a separate conductivity measurement of the material flow. A recombined material stream 524 may exit sensing area 500 through outlet 524.

Sensing area 500 may receive sensor system 510, for example in a slot as illustrated in FIG. 9A. However, other configurations are possible. Sensor system 510 may be a single use sensor system, discarded after use in the event that a material flow cures or otherwise degrades components of system 510.

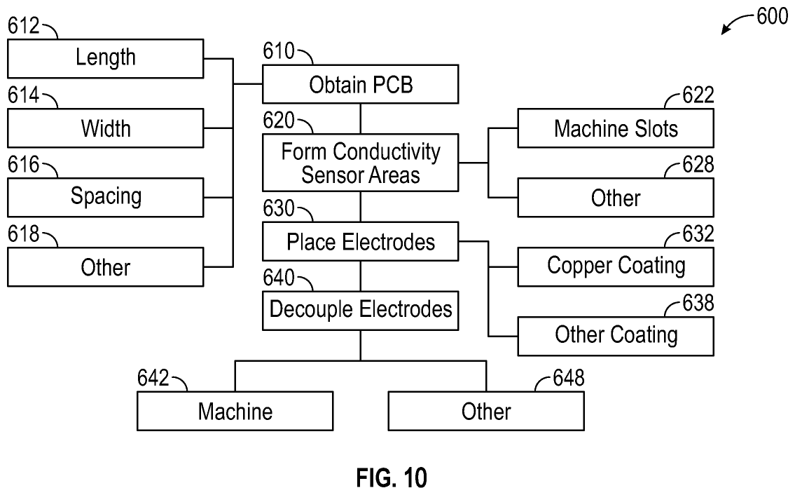

FIG. 10 illustrates a method of forming a sensor system in accordance with embodiments herein. Method 600 may be used, for example, to form a sensor system such as sensor system 510 or 400, or another suitable sensor system. Similarly, while method 600 may illustrate some ways that sensor systems 400 or 510 may be formed, it is expressly contemplated that said systems may be manufactured according to other suitable methods.

In block 610, a template is obtained. The template may have one or more grounds, one or more contacting electrodes for receiving commands and communicating signals and/or other features. As described herein, in some embodiments, a PCB is used. However, while PCBs are inexpensive, it may be preferable to use 3D-printing technology to form a template. In some embodiments, blocks 610 and 620 are performed simultaneously as a 3D-printed template is constructed with conductivity sensor areas in place.

In block 620, conductivity sensor areas are formed in the template. The conductivity sensor areas may be slots, or apertures in which positive and negative electrodes can be placed or attached. Each area may have a length 612 and a width 614. The width 614 may be selected based on the viscosity or particle size present in a material that will pass through the sensing system, for example. The length 612 may be selected in order to increase a surface area available for sensing conductivity. A spacing 616 between adjacent conductivity sensor areas may also be present. In embodiments where conductivity sensor areas are slots, spacing 616 may be dictated in part by the need for structural soundness of the template when under pressure from a viscous material. Other considerations may also be taken into account, as indicated in block 618.

The conductivity sensor areas may be machined into the template, as indicated in block 622. However, other methods are expressly contemplated, as indicated in block 628.

In block 630, electrodes are placed. In some embodiments, electrodes are placed through a metallization step in which a conductivity sensor area is coated with a metal. It may be a copper coating, as indicated in block 632, or another metal coating, as indicated in block 638. The metal coating may be placed through electroplating, for example, or another suitable connection. However, other electrode placing methods are also possible, such as adhering electrodes in place, for example.

In block 640, in some embodiments, electrodes are decoupled from one another, such that each conductivity sensor area includes a positive and a negative electrode, and that adjacent conductivity sensors are decoupled from one another. In embodiments where electrodes are placed through electroplating, it is necessary to remove unwanted connections between positive and negative electrodes. In some embodiments, the conductive part at the end of each slot is milled out. In some embodiments, each edge is milled out further than the edge of the conductive portion. Because the material exchange occurs perpendicular to the slots, it is slower at the end of each slot. It is preferred to avoid measuring the slower moving material as it may make the measurement inaccurate.

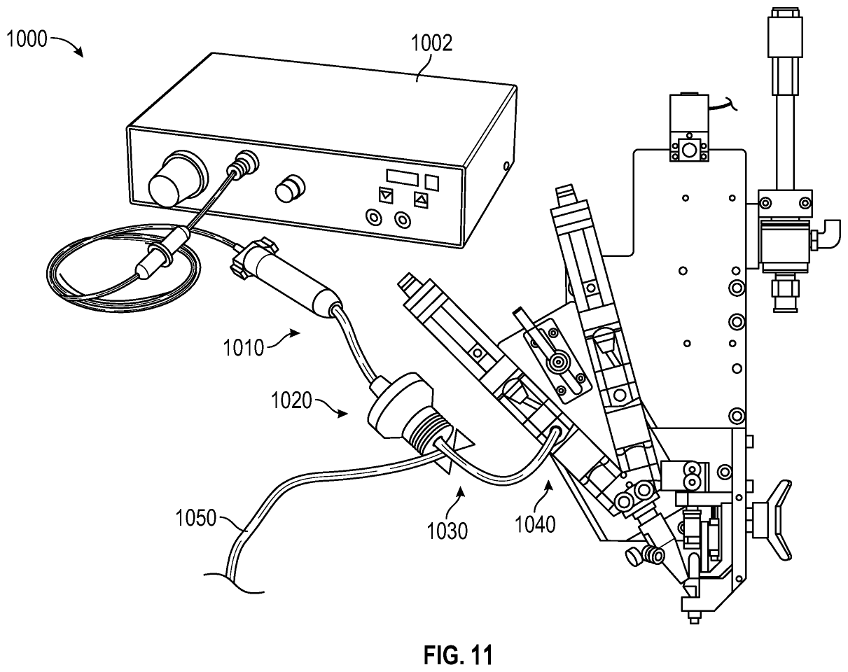

FIG. 11 illustrates another embodiment of a dispensing system in which embodiments herein may be useful. System 1000 illustrates a smaller dispensing system 1000 with a controller 1002, which may include a motor that provides pressure for dispensing a fluid through dispenser 1010. Dispenser 1010 may have entrained air bubbles. In small volumes, the presence of air bubbles can significantly affect the amount of material dispensed by displacing material with air. For a dispensed mixture, this can result in an incorrect mixing ratio being dispensed. For viscous fluids, this may result in an area of a worksurface not receiving dispensed fluid.

It is important to detect, and remove, air from a dispensing system. Therefore, in some embodiments, before reaching a dispensing system 1040, material passes through a sensing area 1020, which includes a PCB-based sensor as described herein. The sensor detects an air bubble and, in response, a valve 1030 is opened, allowing for the air bubble to leave through stream 1050. When the air bubble has passed, valve 1030 closes, and the material continues on to dispensing system 1040. In some embodiments, another sensing area 1020 is present after valve 1030 to confirm that the air bubble has been removed. As illustrated in FIG. 10, valve 1030 is located immediately downstream from a sensing system 1020. Valve 1030 automatically opens and closes, in some embodiments, based on an indication from either sensing system 1020 directly, controller 1002, or another controlling system that, based on a conductivity measurement received from system 1020, sends a command to automatically purge the material line.

FIG. 11 is a schematic of a system 1000 with components for one material line clearly illustrated. However, it is expressly contemplated that, as illustrated, a mixture may be formed from two components, and a similar set of components are necessary to provide the second component, free of air bubbles, to a mixing chamber (not clearly shown).

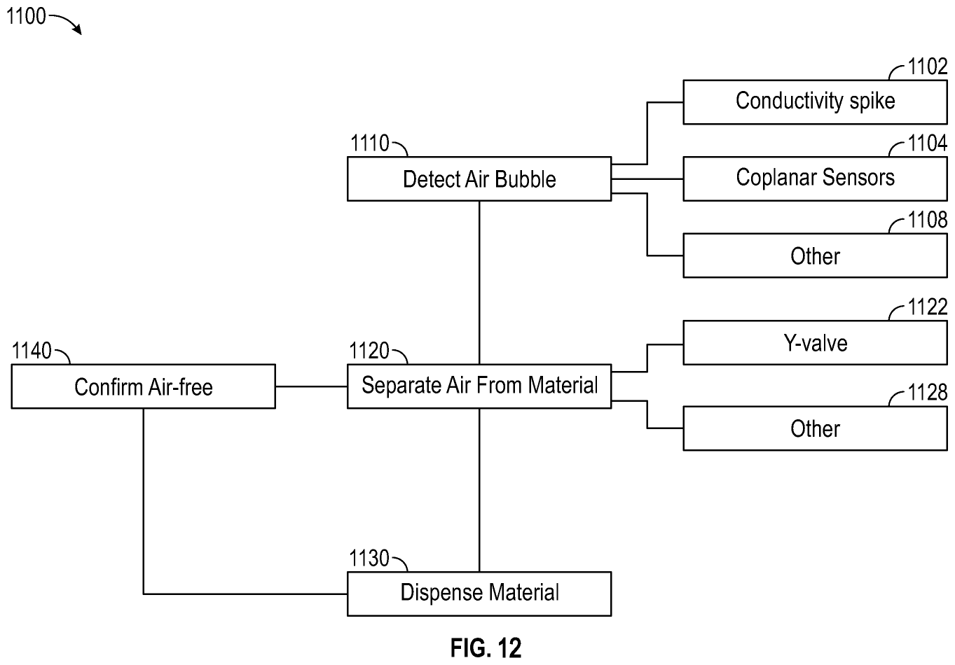

FIG. 12 illustrates a method of removing an entrained air bubble from a fluid line in accordance with embodiments herein. Method 1100 may be practiced using sensor systems such as those described herein, or other suitable sensors. In block 1110, an air bubble is detected using a conductivity sensor in contact with a flowing material. The conductivity sensor may be a disposable sensor intended to be thrown out after use, in some embodiments. The conductivity sensor may include one or more pairs of electrodes in a coplanar arrangement 1104 such that the dispensed material flows through the electrode pairs. The inclusion of multiple electrode pairs helps to detect air bubbles of smaller sizes as they flow through a dispenser. In some embodiments, an air bubble is detected by an identifiable conductivity spike 1102. Other dispenser features are contemplated, as indicated in block 1108.

In block 1120, a detected air bubble is removed from a flowable material. Particularly for mixtures, it is important to ensure that a correct material volume is dispensed. A Y-valve 1122 may be used to divert material flow when an air bubble is detected. Other purge mechanisms 1128 may be used, in some embodiments. In some embodiments, it may be possible to mitigate a detected air bubble without purging, for example by instead sending a signal to the motor controlling fluid flow to increase speed and dispense an amount of material needed to replace the volume of air occupied by the bubble. However, while a detected spike may be proportional to the size of the air bubble, it is not immediately detectable whether the detected air bubble is one large bubble, several smaller ones, etc. Additionally, for embodiments where dispensed fluid must be a certain volume, or have a certain shape, it is preferable to remove the bubble. For example, where dispensed adhesive must be conductive, an air bubble could cause a break in conductivity if dispensed.

In block 1130, material is dispensed. In some embodiments, as indicated in block 1140, it is first confirmed that the material flow is free of air bubbles. This can be done, for example, using a second conductivity sensor in some embodiments.

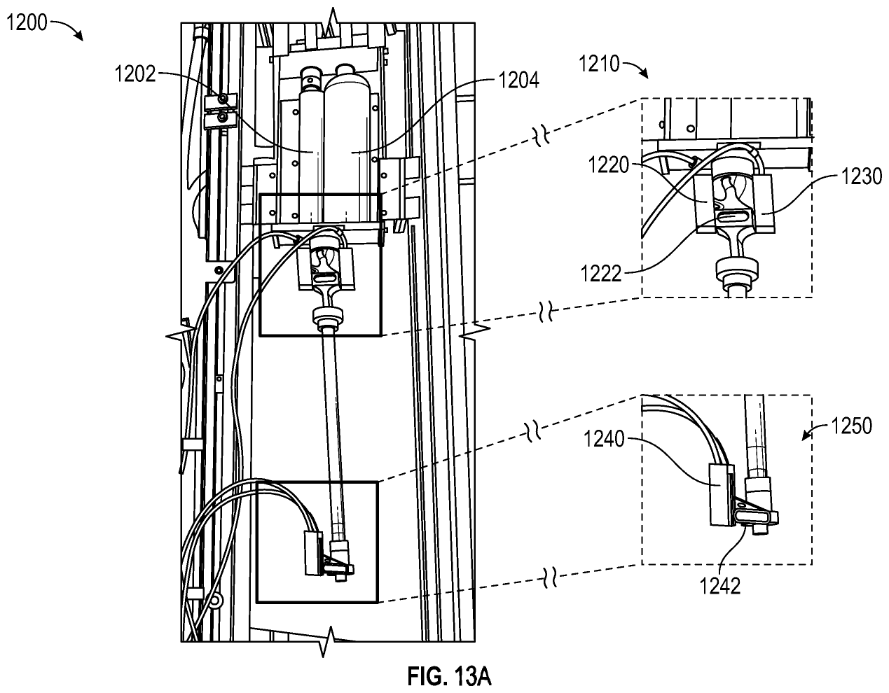

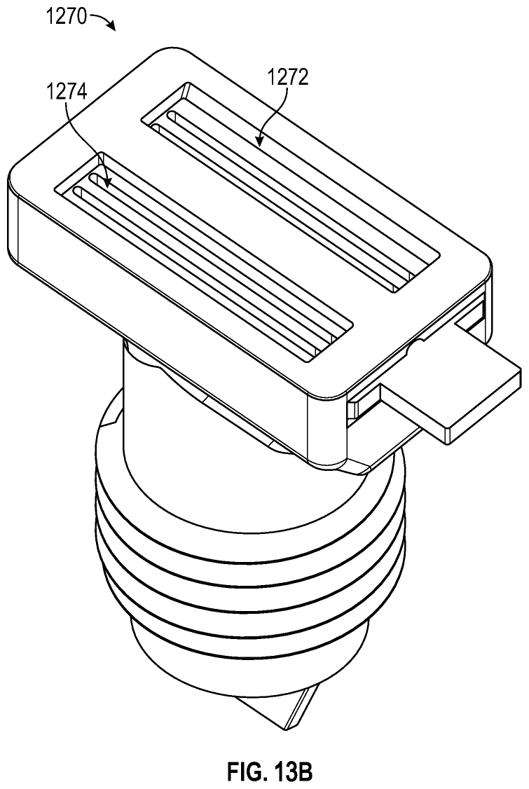

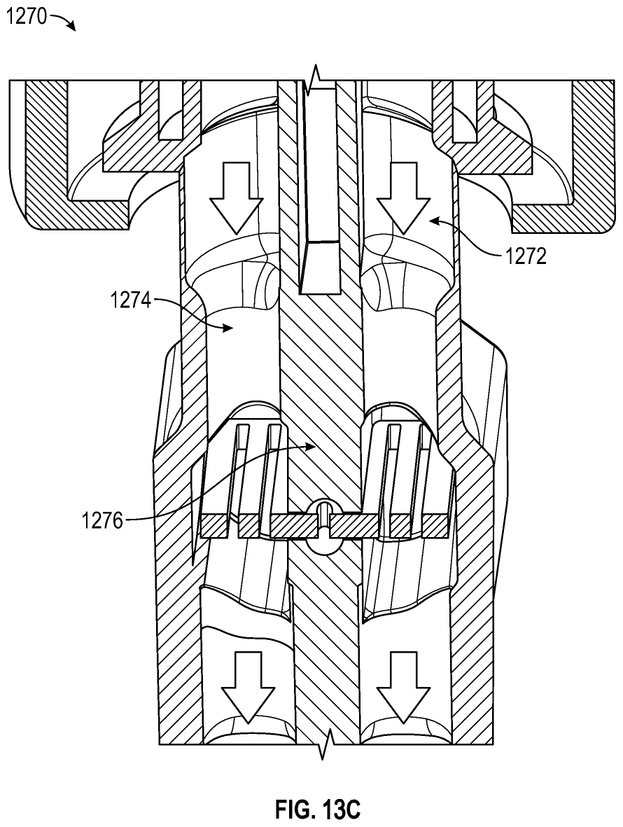

FIG. 13A illustrates a material characterization system in which example embodiments can be implemented. System 1200 is a 2-part material dispenser that is configured to dispense a Part A component 1202 and a part B component 1204. System 1200 may be useful for characterizing a mixture. As illustrated in callout 1210, which illustrates a close-up view of a portion of dispensing system 1200, as each of components A and B are dispensed, they pass through a sensing system 1220, 1230, respectively. Sensing systems 1220, 1230 each include a PCB sensor, within housing 1222, perpendicular to the flow of material, such that the material flows through a number of slots, each containing an electrode pair that measures a conductivity of the material. Housing 1222 may, in some embodiments, receive a PCB sensor, which can be replaced periodically. PCB sensor is in direct contact with component A 1202.

Sensing system 1220 can be used to verify a material 1202, for example by comparing actual conductivity values to expected conductivity values. For example, values from a previous lot may be compared to currently sensed values to determine quality of a new bath of material. Lot to lot variation may therefore be captured. Additionally, values may be compared from operation to operation to detect aging or other factors that may change how Component A may vary over time. Similarly, sensing system 1230 may be used to verify a material 1204. Sensing systems 1220, 1230 may be connected to a control system which may provide an indication to an operator if sensed conductivity values are outside of an expected range.

A third sensing system 1240 may be present after a mixer, as illustrated in callout 1250, which shows a second enlarged portion of system 1200. Sensing system 1240 has a PCB sensor within a housing 1242. The conductivity sensor includes a plurality of slots perpendicular to the flow of the mixed material. Sensing system 1240 may provide a number of indications, including mixing ratio indications, curing indications, and other information relevant to the quality of mixing.

Figures herein illustrate embodiments where sensing systems for incoming components—e.g. 1220, 1230 of FIG. 13A—are separate components. However, it is expressly contemplated that a single sensor could also be used, in some embodiments, that receives both components simultaneously.

As illustrated in FIG. 13B, a housing 1270 may receive material from both parts A and B simultaneously. Because each of the apertures of a PCB-based sensor herein can be decoupled from each other, it is possible to use a single sensor within 1270 to take conductivity measurements from two different materials. In the embodiment illustrated, a first channel 1272 receives a first component and a second channel 1272 receives a second component. While only two component channels are illustrated, it is expressly contemplated that a third channel could receive a third material, etc. Similarly, while two slots are illustrated in each channel of FIG. 9B, it is expressly contemplated that more, or fewer, may be present in other embodiments.

FIG. 13C illustrates a cutaway view of the system of FIG. 13B. As illustrated, channel 1272 receives a Component A and provides it to one or more electrode pairs, through which it flows. Similarly, channel 1274 receives a Component B and provides it to one or more other electrode pairs, on the same PCB sensor. Components A and B flow through housing 1270, with a wall 1276 preventing premature mixing.

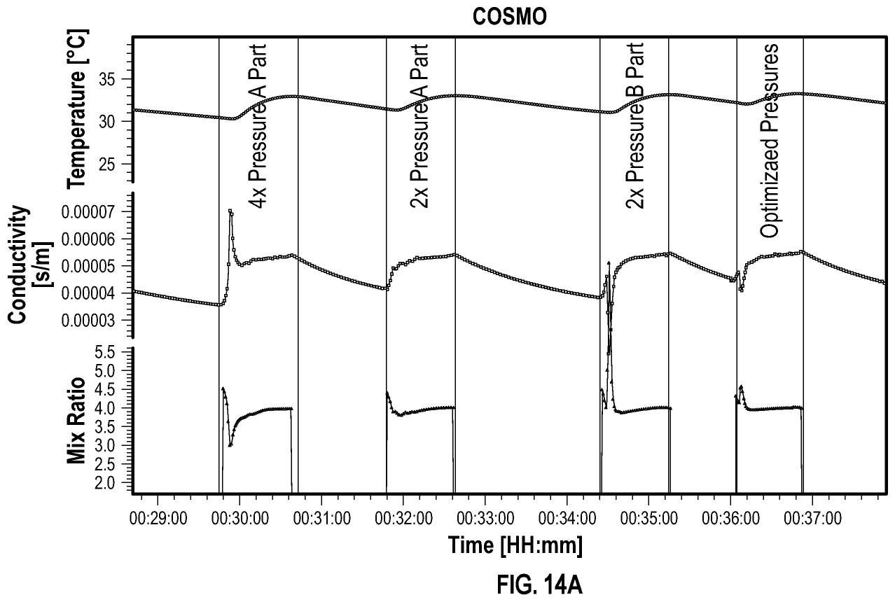

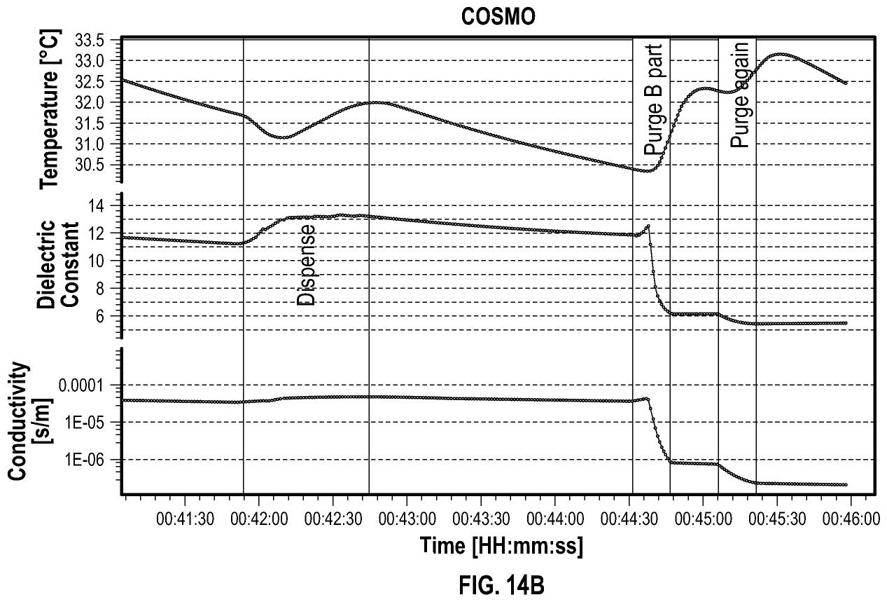

FIGS. 14-16 illustrate example conductivity signals that may be received from embodiments herein. The displays of FIGS. 13-15 may be presented to a user on a display associated with a dispensing system, or on a display remote from a sensing system.

FIGS. 14A-14B illustrate conductivity sensor signals that may be presented during optimization or configuration of a dispensing process. FIG. 14A illustrates a mix ratio, conductivity and temperature measured over time. A series of four dispensing operations are illustrated, with different pressure provided on the A and B components. Operation 1302 is operated at a 4× pressure on component A. Operation 1304 is operated at a 2× pressure on component A. Operation 1306 is operated at a 2× pressure on component B. The preferred pressure is then set for operation 1308. The preferred pressure is selected to reduce the spike seen in the mixing ratio.

FIG. 14B illustrates conductivity sensor signals that may be presented when a purge is either indicated or automatically initiated. In between dispensing operations, material may sit in a dispenser. In the case of adhesives or other components that experience curing or aging, it may be necessary to purge the system so that the material does not cure and cause system damage. Purge thresholds 1350 may be set based on when a material or mixture will have cured either past the point of being useable or past a threshold safe for dispensing machinery. Thresholds 1350 may be set by a manufacturer of components, a curing profile, or another source. When a sensed conductivity reaches a threshold after an operation, a purge 1352 is initiated. For example, one component may be pushed through a mixer until all of the previously mixed components are flushed through the system. As illustrated, a second purge 1354 may be initiated to ensure that the mixture is fully purged, e.g. when a purge threshold 1360 is reached.

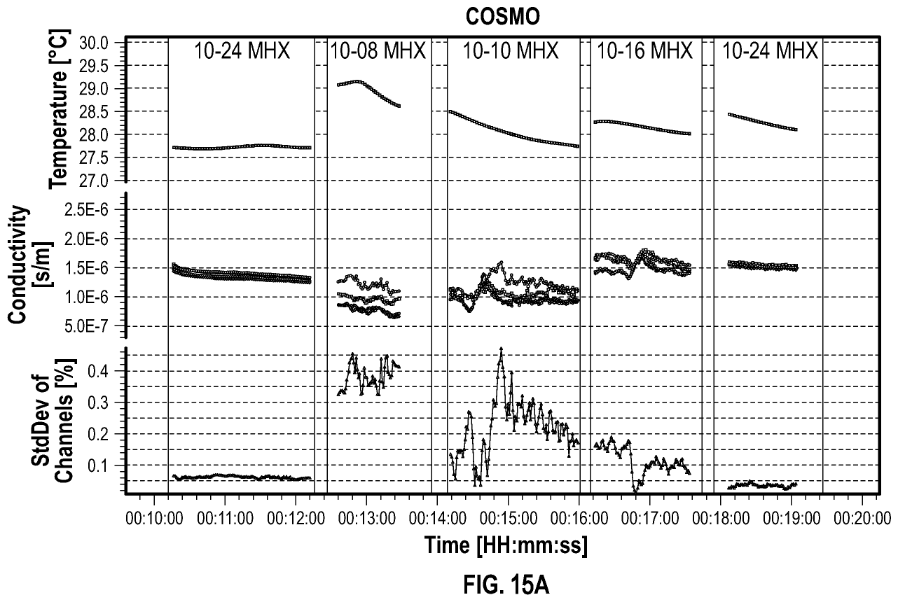

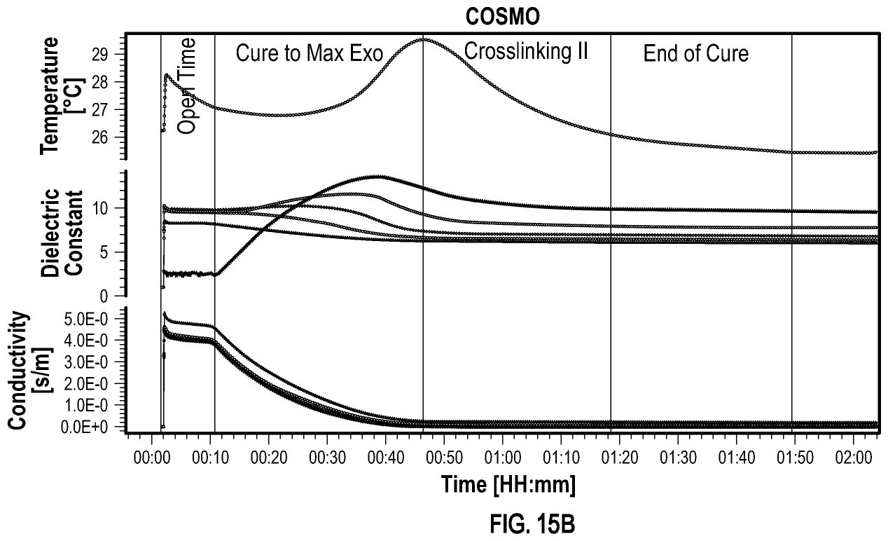

FIG. 15A illustrates mix quality measurements taken over time. Mixing ratios for each of a two-component mixture are varied for each of five different dispensing operations, 1402, 1404, 1406, 1408 and 1410. The temperature, conductivity, and standard deviation is measured across a set of electrodes in a sensing system. If the standard deviation is above a high threshold 1420, it may indicate that a mixture is not sufficient for dispensing. Below a low threshold 1430, it may indicate that the mixture is sufficient. Between thresholds 1420 and 1430, a mixing ratio may be adjusted.

FIG. 15B illustrates a measured curing progress for a mixture. One advantage of a disposable sensor system is the ability to use it to measure cure progress. A dielectric constant, conductivity and temperature are measured over time for a number of operational runs. A cure to max exo 1452 and an end of cure 1454 can be detected using sensor systems described herein, as illustrated. A pot life 1456 may be measureable as well.

The GUIs of FIGS. 14-15 can be provided by a smart phone or other user device. The GUIs can also display information regarding the adhesive being dispensed. Example information can include product name, product color, an image of a tube or other container of the product, lot number and other manufacturing information, and expiration date, among other information.

The GUIs of FIGS. 14-15 can display one or more parameters, for example, a desired flow rate of dispensing. In some embodiments, the parameters are user-editable, such that a user can suggest a desired flow rate based on, for example needs of processes downstream of the adhesive process being controlled.

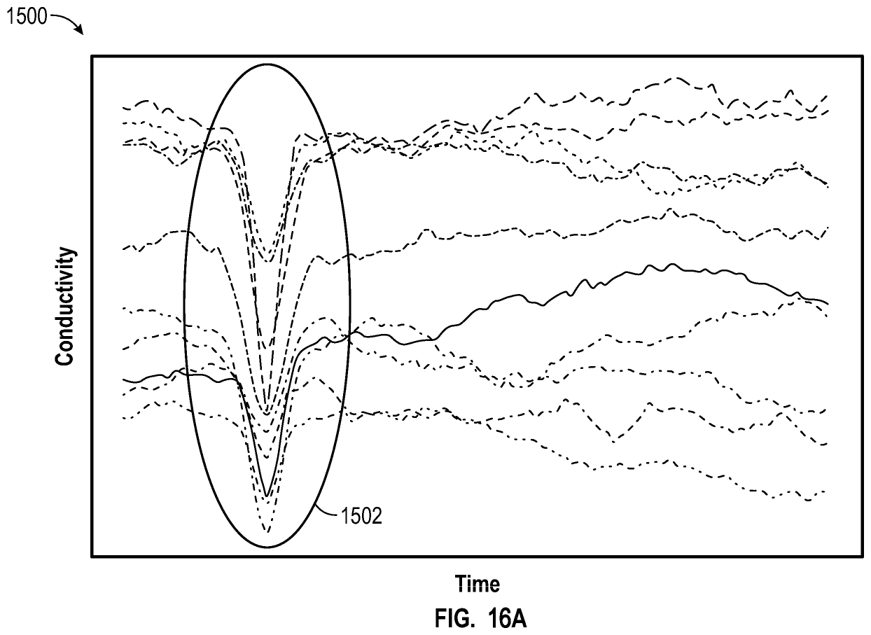

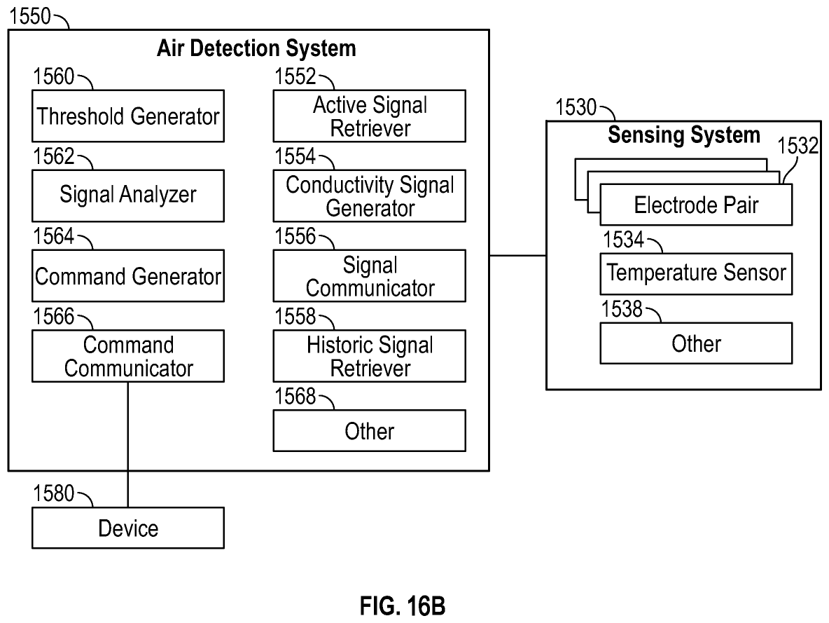

FIGS. 16A-16B illustrates air bubble detection for a material dispensing system in accordance with embodiment herein. FIG. 16A illustrates an example graph of conductivity sensed over time for a number of sensors. As illustrated in chart 1500, by measuring conductivity over time an air bubble can be detected as a spike 1502. The spike may look different depending on raw materials, mixing ratio and the size of the air bubble. For example, as illustrated, a spike may entail conductivity dropping from a first level to a second level, with the amount of drop varying. Additionally, the time frame over which a drop is experience may vary. For example, a larger bubble may take more time to pass through a slot in a PCB sensor and, therefore, may experience a drop over a longer period of time. It is noted that the data presented in chart 1500 is exemplary only, illustrating qualitative air bubble detection, not quantitatively.

Air bubble detection, therefore, may benefit from using relative thresholds instead of absolute thresholds. Base levels may be important to measure to have a more accurate relative threshold. For example, if a conductivity measurement drops below a proportionate factor to the base level (e.g. to 50% of the base level) then an air bubble is detected. Relative thresholds may be helpful to reduce waste of material on accidental purges. FIG. 16B illustrates a system for detecting air bubbles in a material dispensing system. Air detection system 1550 may be implemented by a suitable computing device in communication with a sensing system 1530 associated with a material dispensing system. Sensing system 1530 may include one or more electrode pairs 1532 in direct contact with a material flow. Sensing system 1530 may also include a temperature sensor 1534. Electrode pairs 1532 may be part of a printed circuit board, for example, formed within apertures machined or built into the printed circuit board. The apertures may be closed on both ends, or open on one end, in a comb-like structure, for example. Temperature sensor 1534 may be shielded from direct contact with a material flow, in some embodiments. Sensing system 1532 may include other features 1538.

Sensor signals from sensing system 1530 are received by an air detection system 1550 using an active signal retriever 1552. Active signal retriever 1552 may receive signals from sensing system 1530 periodically or continuously. Received sensor signals may be impedance signals, conductivity signals, dielectric constant signals, or a combination thereof. In embodiments where a conductivity value is used to detect an air bubble, a conductivity signal generator 1554 may convert a received signal to a conductivity value. The signal value, and/or the conductivity value, may be provided to a data store, for example using signal communicator 1556.

A historic signal retriever 1558 may communicate with a data store to retriever previously captured signal values. Historic signal values of interest may include signal values retrieved in a recent period of time, from the same batch or mixture of materials. For example, values retrieved over a previous number of seconds or minutes may be important. As illustrated in chart 1500, signal values may drift over longer periods of time due to changes in temperature, material aging, mixture ratio fluctuations, etc. But a bubble is detectable as a rapid change in conductivity. Threshold generator 1560, in some embodiments, generates a relative threshold either periodically or continuously, based on historic signals. The relative threshold may be an absolute value, for example specifying that an increase or decrease of X % over Y time indicates a bubble. If conductivity values have fluctuated more significantly, the threshold change value may be larger, while if conductivity values have not fluctuated significantly, the threshold change value may be smaller.

Signal analyzer 1562 compares the received signal, or calculated conductivity, to the threshold and, if a deviation outside the allowed threshold is detected, command generator 1564 generates a command, which is communicated, using command communicator 1566, to a device 1580.

Device 1580 may, in some embodiments, include a display component, and the generated command may be an update to a graphical user interface, presented on the display component, indicating the detected air bubble. Device 1580 may, in some embodiments, include a feedback component, such as audio, visual or haptic feedback that indicates to a controller that an air bubble is detected. Device 1580 may also be a valve controller, and command generator 1564 may generate a command to purge the flow line in which the bubble was detected. Device 1580 may also be a motor speed controller, and controller may generate a new motor speed to compensate for the change in mix ratio expected based on the bubble detection.

System 1550 may include other features 1568.

In some embodiments, threshold generator includes a machine learning model to forecast the conductivity time series data into the future from historical data. This forecast may include a so-called confidence intervals. The training may be done upfront on a reference data set without air bubbles. Signal analyzer 1562 then compares a received signal to determine whether it falls within, or outside of, the confidence interval.

In some embodiments, at regular intervals (e.g., 10 ms, 100 ms, etc.), threshold generator generates a prediction for the conductivity value, with confidence bands based on the historic signals retrieved by historic signal retriever. If the actual value measured drops below a lower confidence band, or goes above a higher confidence band, signal analyzer detects a bubble. If the conductivity measurement is within the confidence bands, signal analyzer 1562 provides an output that no bubble has been detected. Command generator 1564 may provide an indication that a GUI of device 1580 does not require updating.

A relative threshold is an important component of an air detection system because of the noise present in the data. The statistical concept of confidence bands can account for this-if data are more noisy, the confidence bands are further away from the current value and the bubble detection algorithm will not yield wrong detections just because of noisy data, where a simple thresholding approach can suffer from this in this case.

While conductivity is discussed herein as the value of interest, it is expressly contemplated that other material parameters, such as the amount of electrical current and the relative permittivity (er), could be used instead or as well for the detections algorithm.

Described herein thus far are sensor systems that are based on a single PCB board. Such systems are relatively inexpensive and, therefore, cost effective to use and replace. However, one disadvantage of designs described thus far is the large stray field compared to the main field present between each electrode pairs. The stray field effect is caused by the short distance between material flow input and output, e.g. the thickness of the PCB. One way to reduce the stray field effect is to solder multiple PCBs, each with electrode-containing apertures, into a PCB stack.

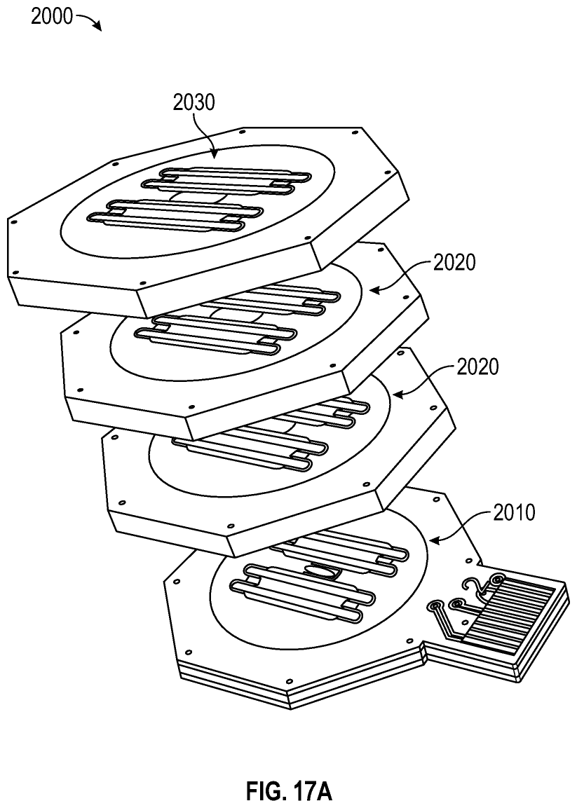

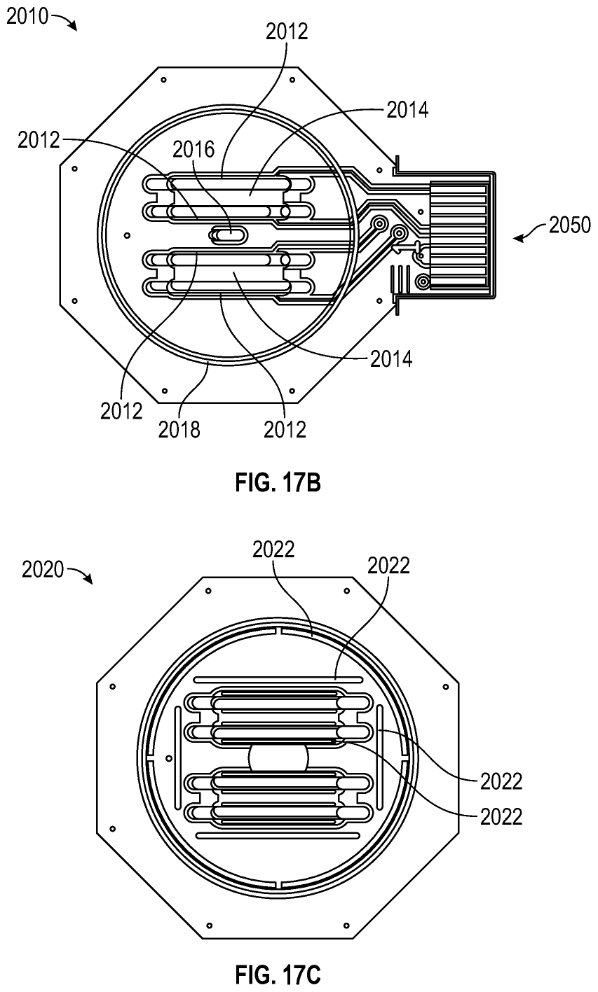

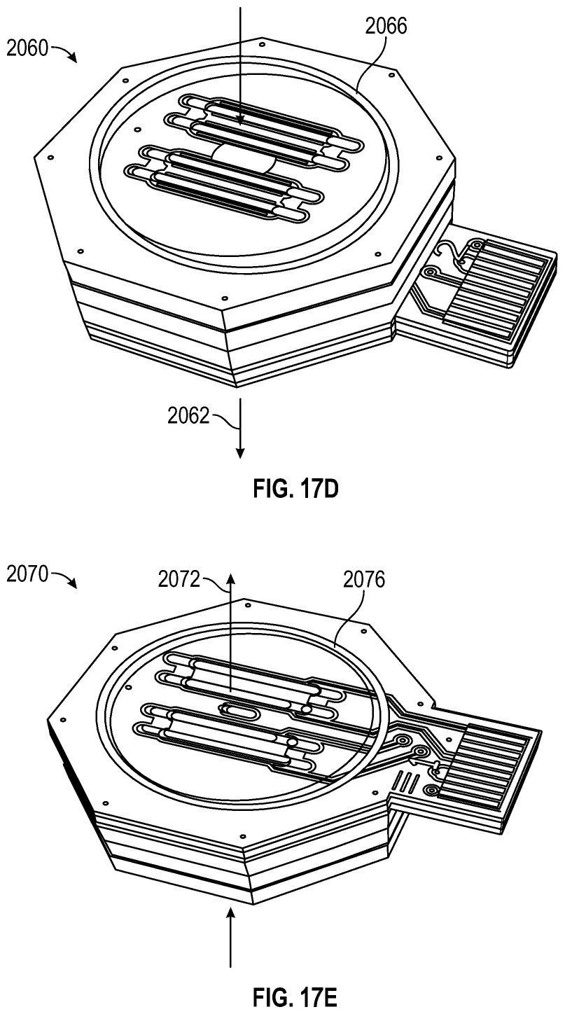

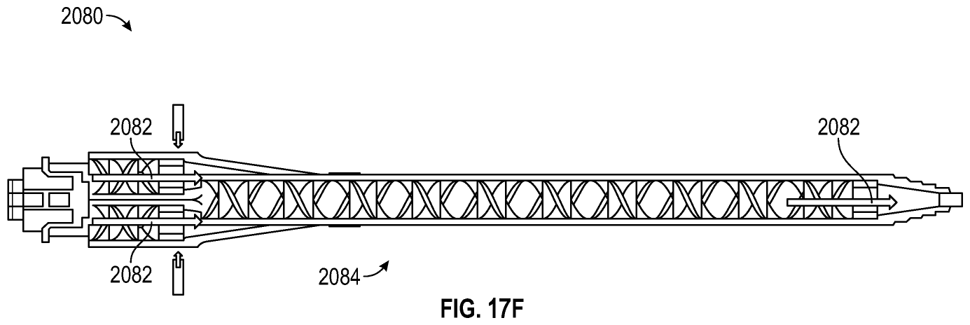

FIGS. 17A-17F illustrate a sensor stack in accordance with an embodiment of the present invention. As illustrated, in one embodiment, sensor stack 2000 may include four PCB sensors, with one 4-layer PCB 2010, two stacking PCBs 2020, which are provided to get the required sensitivity by increasing the electrode surface area, and a top PCB 230. While the embodiment of FIGS. 17A-17F illustrate a four-layer sensor stack, it is expressly contemplated that fewer, or more PCB sensors, may be coupled together. For example, as few as two PCBs or as many as five, six, seven, eight, nine, ten or more PCBs.

Stacked sensor 2000 provides the benefits of a single PCB sensor with reduced stray field effects. The compact design also improves the shielding of the sensitive electrodes, and may also be used as an electrode cartridge without needing additional housing as the sensitive area can be internally sealed. In some embodiments, the sensitive area is internally sealed by soldering, and can withstand applied pressure from a material sensor without requiring an additional housing.

Further, stacked sensor 2000 can utilize smaller electrodes, allowing for sensor stack 2000 to be integrated into an active or passive mixing nozzle at the material inputs as well as the material output.

FIG. 17B illustrates a view of the base sensor 2010. Base sensor 2010 is a four-layer PCB, and includes an edge connector interface 2050. Base sensor includes transmitting electrodes 2014, each paired with a receiving electrode 2012. Sensor 2010 includes a temperature sensor 2016, which is sealed within an aperture of PCB 2010 such that it does not directly contact a fluid flowing through sensor stack 2000. Electrodes 2012, 2014 in contrast, directly contact a fluid as it flows through stack 2000. In embodiments where sensors 2010, 2020 and 2030 are sealed together, sensor 2010 may include a sealing ring space 2018, which may receive solder or another sealing material, such as a sealing ring.

FIG. 17C illustrates an internal PCB sensor 2020. Connection areas 2022 are indicated, which may receive solder or another adhesive. Internal PCB sensors 2020 may be 2-layer PCBs, instead of 4-layer PCBs, which may allow for cost savings, as the additional shielding layers are not necessary for internal sensors 2020. Connection areas 2022 may be soldered, or sealed using another material which allows for communicative coupling between adjacent sensors 2020, 2030, 2010.

FIGS. 17D and 17E illustrate views of a stacked sensor from a material input side 2060 and a material output side 2070. Fluid flows in the direction illustrated by arrows 2062, 2072. A sealing ring 2066, 2076 may be present to seal the PCB sensors to a material flow line. After sealing is complete between all PCB sensors, the sensor stack can be inserted into the material flow by using a sealing ring at sealing points 2066, 2076.

As illustrated in FIGS. 17A-17E, a 4 channel Material-Impedance-Sensor with additional Temperature-Sensor is shown. However, it is expressly contemplated that more, or fewer, channels may be present in some embodiments. Additionally, in some embodiments, no temperature sensor is provided.

FIG. 17F illustrates how a stacked sensor system as illustrated in FIGS. 17A-17E can be utilized in a material dispensing system. A material dispensing system 2080 may have a mixer 2084 with a stacked sensor 2082 at each of a material inlet and a stacked sensor 2082 at the mixer outlet. As described, for example with respect to FIGS. 10 and 12, a material dispenser with a sensing system such as that illustrated in FIG. 17F can allow for improved characterization of the material being dispensed, including detecting batch variations for either input material, verifying mixing ratio, detecting air bubbles, etc. While FIG. 17F illustrates a static mixing system, it is expressly contemplated that embodiments herein would be equally applicable to an active mixer as well.

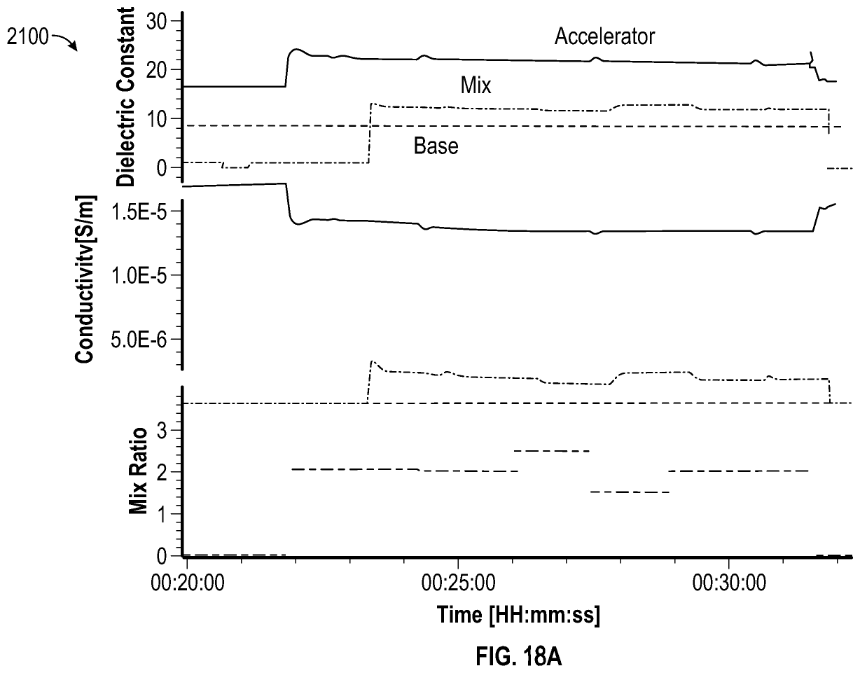

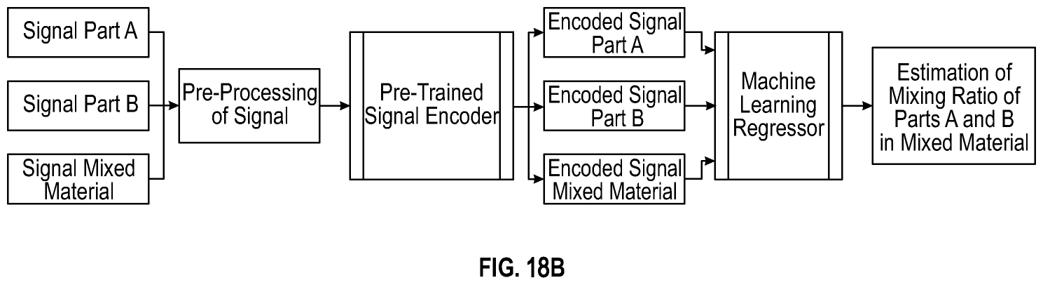

FIGS. 18A-18B illustrate an example batch detail detection for a material dispensing system. As observed in wide exploration of batches, there can be significant variations in conductivities of the A and B parts of a mixture. Therefore, it can be helpful, or even necessary, to conduct calibration measurements each time a new material lot is introduced. It is desired to be able to avoid extensive a-priori characterization of produced materials. By using a system such as that of FIG. 10, 10 or 16F, three signals can be obtained—from each input and the output—and can be fused together to generate one measurement. The input signals and output signal may be corrected for time delay. Each signal has, as illustrated by graph 2100 of FIG. 18A, a conductivity and dielectric constant at various frequencies (e.g. 32 Hz-8 KHz) and a temperature signal at each sensor location. This produces a data vector for each sensor location at a time step. This allows for extraction of mixing ratios at varying operating conductions as a dispensing operation proceeds.

FIG. 18B illustrates an example model for estimating mixing ratio based on received signals from each of a Part A component, a Part B component and a Mixture. In some embodiments, the signal encoder is a pre-trained generative model, e. g. a Variational Autoencoder (VAE), that is trained to encode all signals into a representation and to decode the original signal from this representation. However other models may also be suitable. A VAE may ensure that the representation of the signal includes all information that is needed to reconstruct it. The encoder takes one signal as an input and outputs the representation in the latent space of that signal. The decoder takes one representation as an input and outputs the reconstructed signal.

The machine learning model that estimates the mixing ratio of Part A and Part B in the mixed material then takes the three pre-processed and encoded signals from Part A, Part B and the mixed material as inputs and outputs the mixing ratio in the mixed material.

Signal encoder and regressor may operate locally, for example using a computer processing device associated with a material dispensing system. Alternatively, either encoder or regressor, or both, may be deployed in a cloud-based storage system.

The output of encoder may be directly used to apply pressure changes on the cartridges associated with components A and B to ensure that the mixture meets a predefined mixing ratio. E.g., if the mixed material contains too much of Part A, the pressure on the cartridge containing Part A is reduced and the pressure on the cartridge that contains Part B increased.

A regressor may then take the encoded signals and produce a mixing ratio signal. The regressor may be a machine learning based algorithm that can be trained in any suitable way.

A first training option is a separate training option where the Encoder-Decoder model is trained on a set of signals of a variety of parts for Part A, Part B, and diverse mixtures. The Machine Learning Regressor is trained in a second step afterwards on the encoded signals and the corresponding mixing ratios.

A second training option is an alternating training option, where one batch of signals is used for one training step in the Encoder-Decoder and then used for one training step in the Encoder-Machine Learning Regressor part. A training step consists of a forward pass of the data in a batch, the calculation of the gradient, and an application of the gradient to optimize the weights in the model.

A third training option is a combined training option where the triplet of Encoder-Decoder pair and Machine Learning model are optimized simultaneously. This means that a batch is forward through the Encoder, and the representation obtained is forwarded through the Decoder and the Machine Learning Regressor. Then the gradients calculated with both outputs are applied in a weighted combination in the backwards pass.

Alternating or combined training may provide a benefit in that the representation of the signals is learned in a way that it has a positive effect on the performance of the Regressor which can lead to a lower error when estimating the mixing ratio. Learning a representation of signals on a variety of materials and mixing ratios also allows the models to be used on previously unseen materials of the same chemical family.

In difference to a system which only uses a single signal from the mixed material, this novel approach allows adaption for lot-to-lot variation of the raw material, where a change in one of the parts can lead to a change in the mixed signal for the same mixing ratio. It also enables tracking the mixing ratio of the new materials of the same family be learning to fuse the signals of two parts into a mixed signal. Additionally, data traces collected from a sensor system can be processed to provide other information than just a mixing ratio. As described herein, in some embodiments, a sensor includes four electrode pairs. A time series of conductivity can be analyzed from the four sensor capacitors:

σᵢ(t),i∈{1,2,3,4} Equation 1

Incomplete mixing, for example from using a static mixer that is too short, appears in the sensor output as high volatility. The volatility can be quantified by calculating the variance over a time window, e.g. 10 seconds. The time window may vary based on the speed of the process and mixer throughput.

$${V}_{i}^{10 s} ( t ) = \frac{1}{10 s} {\int }_{t - 10 s}^{t} {{σ}_{i} ( τ )}^{2} - {{\overline{σ}}_{l} ( τ , 10 s )}^{2} d τ \qquad Equation 2$$

With

$${\overline{σ}}_{l} ( t , Δ t ) = {\int }_{t - Δ t}^{t} {σ}_{i} ( τ ) d τ \qquad Equation 3$$

If the mixer is adequate, the variance of each sensor, once flow is stable, will drop below a threshold that can be determined experimentally.

Mixing may also take time to reach a steady state. For example, when starting a mixing operation, backpressure and different viscosities of components can cause mixing to start off poorly and gradually stabilize. The same variance can be used to track the stabilization and indicate when the dispenser can dispense material on a workpiece or to a receiving container. The trend of the variance can be analyzed using Equation 4.

$${V}_{i} ( t ) - {V}_{i} ( t - Δ t ) < {V}_{thresh} \qquad Equation 4$$

The threshold Vₜₕᵣₑₛₕ is specific for each material. Instead of determining a threshold, the signal can be tested for stationarity using the augmented Dickey-Fuller test. The advantage with this is that manual thresholds often need to be tuned for a new batch, but the ADF test is adaptable.

Inhomogeneity can also be detected using sensors described herein. The four electrode pairs should also record similar readings. Some constant offset is possible due to manufacturing tolerances, but in a stable mixing process, the variations of the four signals should be synchronous. To check for this, calculate the covariance of the signals without time shift:

$${C}_{i , j}^{Δ t} ( t ) = {\int }_{t - Δ t}^{t} ( {σ}_{i} ( τ ) - \overline{{σ}_{l}} ( τ , Δ t ) ) \cdot ( {σ}_{j} ( τ ) - {\overline{σ}}_{j} ( τ , Δ t ) ) d τ \qquad Equation 5$$

Once each signal has stabilized, the four sensors should have a high covariance. Negative covariance indicates a persisting anti-correlated behavior and signifies spatial inhomogeneity.

Similarly, a single component of the 2K adhesive can also be inhomogeneous, e.g., because of settling in the barrel or insufficient mixing during manufacturing. An augmented Dickey-Fuller test can again be used to confirm stationarity over a longer time. The relevant time frame would be determined by the time it takes to empty the container.

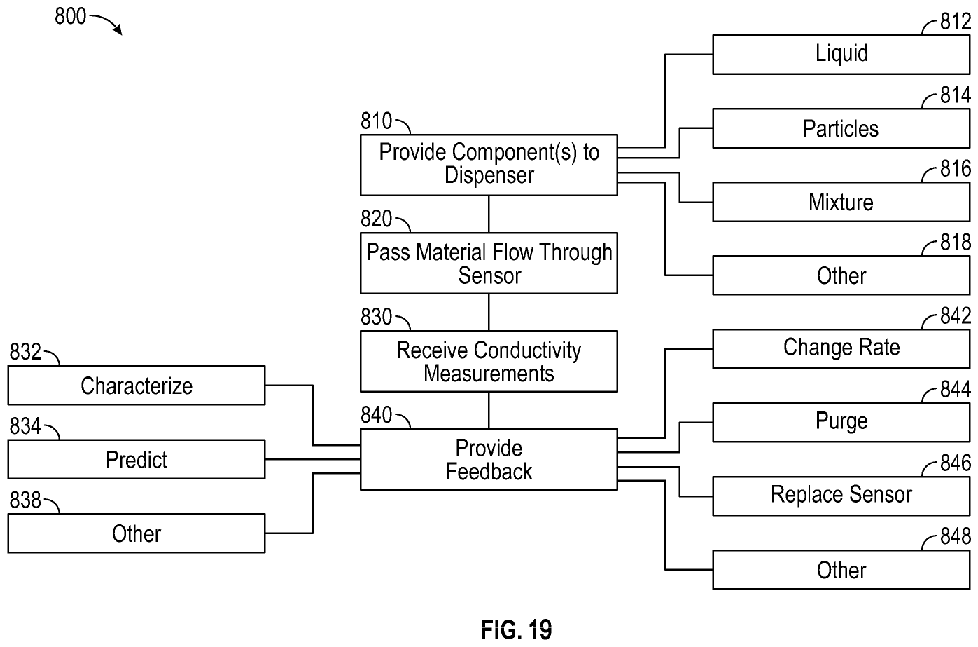

FIG. 19 illustrates a method of controlling a material dispensing system in accordance with embodiments herein. Method 700 may be used with the dispensers described herein, or another suitable sensing system.

In block 810, one or more components to be dispensed are provided to a dispenser. For example, a dispenser may dispense a liquid 812, particles 814 either in suspension or otherwise. The material may also be a mixture 816 of materials. For example, an adhesive may be formed of an A and B component provided at a desired mix ratio. Other components 818 may also be provided to a dispenser for dispensing.

In block 820, the material passes through a sensing system before being dispensed onto a worksurface. Passing through a sensing system may entail passing through a portion of a sensing body such that the material directly contacts a sensor. For conductivity sensors, direct contact between a material and an electrode pair ensures accurate measurements.

In block 830, conductivity measurements are received from the sensing system. The sensing system may have multiple sensors, for example a plurality of electrode pairs that, when a sufficient voltage is passed through them, detects a conductivity of the material. Based on the conductivity readings, a number of things may be determined for the material. For a mixture, a mixing ratio may be determined. For a curable material, a curing progressing may be detected. Aging may also be detectable, as well as differences between batches of materials. Entrained air may also be detectable. Conductivity measurements may be taken serially, for example one signal received every second, or more frequently. Conductivity measurements may also be taken in parallel, for example from each of a plurality of electrode pairs. The electrode pairs may be coplanar with each other, in some embodiments.

In block 840, feedback is provided based on the conductivity measurements. Feedback may include characterization of the material, as indicated in block 832. For example, a mix ratio may be detected, or entrained air, or an age indication may be provided. A prediction may also be provided, as indicated in block 834. For example, based on a trend of previous conductivity sensor readings, it may be possible to predict future behavior. A conductivity reading trending in one direction may indicate that a mix ratio is moving toward an edge of an acceptable range and, therefore, that a mix rate should be changed, as indicated in block 842. Similarly, a conductivity reading may indicate that a curable component is curing. Feedback may therefore indicate that a purge of one component, multiple components, or a mixture, is needed, as indicated in block 844. In embodiments where a material has corrosive effects, or cures over time, predictive feedback may provide an indication that the sensor needs to be replaced, as indicated in block 846. Other predictive information may also be provided, as indicated in block 838, that may trigger other actions, as indicated in block 848.

In some embodiments, as illustrated herein, providing feedback may also include providing conductivity readings, material characterizations or predictions to a customer, controller of a dispenser, or other useful information such as material source, batch number, material name, dispensing temperature, dispensing pressure, material concentration(s), mix ratio, or any other information.

FIG. 20 illustrates a material dispensing system in accordance with embodiments herein. System 900 may include a dispenser 910 with one or more cartridges 912 containing a material to be dispensed. A cartridge 912 may dispense material at a rate based in part on a speed of a corresponding motor 914. A dispenser controller 916 may provide a control signal to motor(s) 914 to drive material flow from each cartridge 912 by increasing or decreasing a speed of corresponding motors 914. Dispenser 910 may have other features 918, such as a heating or cooling element if material is dispensed at an elevated temperature or if heat needs to be provided or removed from an exothermic or endothermic reaction of reactive components.

Dispensing system 900 may also include a sensing system 920, with one or more conductivity sensors 922 arranged on a PCB board 924. The PCB board 924 may include one or more ground planes, one or more contact points to connect to a system controller 930 or to power source 940, or another source. Sensors 922 may be coplanar on PCB 924, for example formed within slots of PCB 924, either by metallization or another process. Sensors 922 may be decoupled from each other such that independent conductivity signals are received from each sensor. Sensors 922 may each comprise a positive and negative electrode, decoupled from one another.

A controller 930 may receive sensor signals from sensing system 920, using signal receiver 932. Signals may be received as a conductivity signal or a dielectric constant signal, but may also be received as an impedance signal. In embodiments where a received signal is an impedance signal, a conductivity calculator 933 may calculate a conductivity value based on the impedance signal. similarly, a dielectric constant calculator 935 may calculate a dielectric constant value based on the impedance signal. Based on received sensor signals, controller 930 may trigger a number of calculations and/or predictions. For example, a mixing analyzer 934 may calculate a mixing ratio of a mixture of components being dispensed. A mixing ratio 934 may be calculated based on calibration data 982, stored in a datastore 980, which may be indicative of conductivity data from pure components and/or known mixtures of components. As described above, sensors may be placed at both the inlets and outlet of a mixer and, therefore, mixing analyzer 934 may receive sensor signals from all sensors associated with a material dispensing system. Mixing analyzer 934 may correct for the time delay between the sensors.

A curing analyzer 936 may also, based on the conductivity signals, detect that curing is occurring and a progression of the curing. For example, if curing progresses significantly, then a purge trigger 942 may need to trigger a purge of one or more components, or of a mixture of components. Similarly, an indication may be provided that PCB 924 should be replaced based on curing that could damage or render sensor 922 inaccurate. Based on a comparison of contemporaneous conductivity signals against calibration data 982, or historic data from system 900 or another system, aging analyzer 938 may detect an age of one or more components, or a mixture, and provide an indication as to whether the material should be discarded. It may also be possible, based on conductivity sensor signals, to detect entrained air using an entrained air detector 939. These, and other parameters 948, may also be detectable.

Controller 930 may also be able to, using historic data 984 from a current dispensing operation or historic dispensing operations, analyze a trend using signal trend analyzer 944 Curing may begin anytime that dispensing is not occurring and material sits within the dispenser, e.g. in between flowing cycles. Similarly, it is possible to detect that a purge can end, e.g. if conductivity is below about 6 or about 5.5, purging may be finished. Curing progress may also be explicitly tracked to verify that the cure progresses in line with expectations. Curing may have some volume dependency, but sensor system 920 may provide an indication that a material meets specifications based on a curing profile.

Controller 930 may also be able to, based on sensor signals, use a composition drift analyzer 937 to detect a change in composition over time. Controller 930 may also be able to, using homogeneity analyzer 943, determine whether input material are homogeneous when entering the mixer.

At start up, controller 930 may cause start up analyzer 941 to monitor incoming material streams and the mixer output to determine when the mixing process has stabilized.

Controller 930 may also be in communicable contact with other devices, such that a command generator 942 can generate a device command, and command communicator 944 to communicate the device command. For example, if mixing analyzer 934 detects that a mixing ratio is off, a motor signal may be generated, by command generator, to adjust a speed of a motor 914 before a mixing ratio exceeds or drops below an acceptable threshold. Similarly, a purge of a cartridge 912 maybe triggered or ended by command generator 942, based on detected curing or aging of material using curing analyzer 936. For example, it may be known, for a given material, that if conductivity increases by another X %, that the material will no longer be dispensable, and a purge may be triggered.

Other information 988 may be stored in datastore 980 and accessible by controller 930 for analysis and improved operation of dispenser 910 or sensing system 920. For example, material information 987 may be stored in datastore 980. Datastore 980 may be local to controller 930, or may be accessible through a cloud-based network. Similarly, while controller 930 is illustrated in FIG. 19 as local to dispensing system 930, it is expressly contemplated that controller 930 may be remote from material dispensing system and may receive signals, and send commands, using a wireless or cloud-based network.

A GUI generator 950 may generate a graphical user interface for display on a display component 960 based on some or all of the information gathered or generated by controller 930. For example, conductivity sensor data may be presented. A calculated mixing ratio may also be presented, as well as dispensing parameters, including target mixing ratio, motor speed, pressure, temperature, etc.

Another component that a dispenser 910 may have is a mixing element with one or more mixing elements. It is desired to have the minimum possible mixing elements to reduce complexity of dispenser 910, and associated cost. Similarly, the more internal surface area within the dispenser, the more material must be wasted or purged at the end of an operation time. Mixing may be considered sufficient, in some embodiments, if the standard deviation between a number of coplanar conductivity sensors is below 0.1. If a conductivity of a material varies by more than that across a sensing plane, then the mixing element may need to be elongated. For a new adhesive or mixture, sensing systems herein may be useful for designing a suitable static mixer. For active mixers, sensors herein may be useful for sensing and adjusting a rotation speech until a material mixture is satisfactory.

Systems and methods are described herein that take advantage of machine learning algorithms. Machine learning models may be preferred because they can better handle noisy data, make predictions about future signal trends, and make adjustments before mix quality significantly shifts. Systems and methods described herein can calculate the mix ratio real time. With machine learning techniques, the mix ratio could be predicted ahead of time. This allows quicker adjustments which keeps the mix ratio closer to the target value more of the time. With some current dispensers, a lot of material is entrained in the static mixer, such that, by the time a shift in mix ratio is detected, the material already in the mixer will continue to have the wrong mix ratio for at least a mixer's worth of adhesive, so identifying mix ratio issues earlier can save material and a potential purge.

Similarly, machine learning models, as described herein, may receive information from multiple systems, such as multiple sensors within a dispensing system including conductivity sensors, temperature sensors, motor speed signals, material information, etc. In some embodiment, multiple machine learning models are used simultaneously, each by an individual system such that each system's model can learn and the overall model can be improved. However, it is also expressly contemplated that non-machine learning models may also be used.

Controller 930 is described as having the functionality of receiving and sending communicable information to and from other devices. This may be done through an application program interface, for example, such that controller 930 can receive and communicate with pump controllers, line pressure sensors, movement controllers for portions of dispensing system, temperature sensors, heating elements, datastores having information for any of the materials being dispensed or the mixture being generated, etc.

In embodiments where machine learning models are used, datastore may also include an analyzer that learns usage behavior of a particular dispensing system in order to improve operation and predictions. Similarly, frequency and patterns of dispensing may provide information about curing and improve mixing models. For example, usage data such as frequency of dispense, purging frequency, pattern of dispense, change out of the sensor, etc, can be collected and used to enable a model to learn about adhesive curing. This additional data can be included in the adhesive characterization and improve the predictive power of models build on the sensor data. Curing is dependent on many factors including length, width, and other geometry of the static mixer, the exothermic properties of the adhesive, the reaction kinetics, downstream attachments such as tubes or tips, time, and other factors. It is not enough to only know about the reaction kinetics of the adhesive itself. With this amount of complexity, collecting the usage data and training a machine learning model is the best way to enable higher quality predictions which in turn enables higher quality feedback and control over the process.

In embodiments where inventory information is also stored in a datastore 980, or otherwise accessible by controller 930, controller 930 may indicate that inventory is low or order material based on low inventory.

Similarly, as described herein, display 960 may display a GUI created by generator 950 that is updated periodically with information that controller 930 has access to, such as any sensor data received, any analysis results generated by analyzers 934, 936, 938, 939, 937, 941, 943, any information retrieved from datastore 980, etc. Information may be passively updated, or provided with an alert or notification as it is updated, for example current status information may be presented and an alert (visual, audio, or haptic) may be provided if the mixing ratio is drifting toward an unacceptable range. Additionally, or alternatively, notifications may be provided when a device command is generated, or when operator intervention is needed. For example, in embodiments where command generator 942 is not able to communicate with another device, command communicator 944 may send a message to display 960, or to a speaker, or another notification device, to indicate to the operator that a purge is needed, that a motor speed needs to be changed, that the temperature is too high or low, etc.

In some embodiments herein, it is envisioned that controller 930 may generate commands, using command generator 942, to maintain a mixture output within desired parameter ranges, such as purging a detected bubble, adjusting motor speeds to maintain mixing ratio, increasing or decreasing heating elements to maintain desired viscosity, etc. Fine tuning may be provided automatically. However, there are situations where controller 930 may not be able to use fine tuning to maintain a desired mixture output-such as the presence of bubbles, line blockages or material running out. Controller 930 may be able to address bubbles as described herein. Controller 930 may also be able to detect blockages or low material based on historic behavior of dispensing system 900. In situations where controller 930 cannot maintain desired mixture parameters, it may trigger an alarm, notification, or otherwise indicate that the mixture provided is not on-spec.

### Handheld Applicators

Typical applicator such as 3M Scotch-Weld™ EPX™ Plus II Applicator for 48.5 mL & 50 mL Duo-Pak Cartridges (Part No. 7100148764, 3M Inc., St. Paul MN).

This invention describes methods, devices, and kits for applying and using structural adhesives. Traditional methods of manual application use hand-held “Dispensing Guns” which can accommodate a variety of different adhesive cartridge sizes. The smaller adhesive cartridges (e.g., 50 to 200 ml) tend to use human powered mechanisms to push the adhesive component(s) through nozzles which also can include the ability to mix separate adhesive elements to the point where the user applies the adhesive. For larger cartridge sizes (e.g., 200 to 600 ml) powered mechanisms are typically used which tend to be either pneumatic or battery powered to drive the adhesive being dispensed. These systems have limited control and the dispensing outcome is fundamentally down to the skill of the operator. The larger powered “Dispensing Guns” are also physically challenging to use and are often very bulky and heavy which make them difficult to use for long periods for many users.

This disclosure discloses a chamber that houses flexible containment vessels for at least two (but optionally more) components of an adhesive for a handheld dispenser that enables the adhesive components(s) to be mixed and the release of the adhesive applied without the use of complex and bulky mechanical drive systems. It also considers the possibility of reversing the flow of material into the storage system such that it could potentially offer the option of a reusable vessel(s).

By reducing the bulk and mass of the adhesive storage system due to the inclusion of the pressurized design, the ergonomics for the user may be significant improved by eliminating the need for restrictive pneumatic supply airlines and/or complex mechanical piston drive systems. Additionally, the ability to refill the flexible containment vessels enables the potential for a significant reduction in its environmental footprint.

Typically to pump high viscosity liquids in a peristaltic (traditional rotational or linear) system, the following methods would be employed: the stiffness of the tube wall would be increased to increase the recovery force (this also increases torque requirements); the pump rotation would be slowed to allow recovery of the tube (limits pumping rate); or the roughness of the inner pipe would be decreased (most pipes are very smooth anyway). Each of these methods have drawbacks which limit the application of a low-cost energy efficient handheld adhesive dispenser.

### Handheld Dispensing System

Systems as disclosed herein include at least two flexible containment vessels (which can be referred to as a first and a second containment vessel for the sake of convenience and clarity) holding at least a Part 1 and a Part 2. In some embodiments, additional flexible containment vessels holding additional parts can also be utilized. The flexible containment vessels can be made of any suitable material. A suitable material would be one that can contain the relevant composition and offers the ability to transfer the pressure within the chamber to the composition contained within the flexible containment vessel necessary for use in the disclosed device. Useful materials can include lightweight flexible laminates which may additionally contain structural layers, layers to reduce moisture transmission or to be resistant to ultraviolet (UV) rays in order to extend the useable life of the adhesive elements inside the containment vessels.

The specific material(s) that is chosen can depend at least in part on the adhesive being packaged. For example, some acrylic adhesives require oxygen for the stabilizer chemistry to work in order to provide desirable shelf lives, for example. In such circumstances, the package may have to have a desired level or range of oxygen permeability. As another example, some of the components in an acrylic adhesive can diffuse through packaging material that would be workable for an epoxy or urethane adhesive, for example.

Illustrative materials for the at least two flexible containment vessels can include, for example high density polyethylene (HDPE), polypropylene (PP), polyamide (PA), Nylon, polyethylene terephthalate (PET), polybutylene terephthalate (PBT), co-extrusion of ethylene-vinyl alcohol copolymer (EVOH) with another polymer, thermoplastic polyurethane (TPU), metalized polypropylene, metalized polyethylene terephthalate (PET), metalized polyester, aluminum films, and coated foils. Additional materials may also include uncoated metals and coated metals (both uncoated and coated metals may both be classified UN 1A2/Y/100/ . . . ) that may include an inner-liner made from PP, polyvinyl chloride (PVC), or combinations thereof. Additionally, materials may be powder coated for use with certain formulations.

In some embodiments, polyethylene or polypropylene materials may be utilized.

In some embodiments, a clear multilayer polymer film made by extrusion can be utilized. Specific, selected compositions can include polyamide/polyethylene (PA/PE) bilayer films having thicknesses from 120 to 130 μm can be useful. Such films can be suitable for the packaging of polyurethane resins (polyol/isocyanate). Such films may provide the resistance against any possible impacts of polyols and isocyanates.

In some embodiments, a co-extruded film that includes a first nylon layer (e.g., a 1.35 mil nylon layer) and a second linear low-density polyethylene (LLDPE) layer (e.g., a 3.15 mil LLDPE) can be utilized. In some embodiments, a PA/polyethylene (PE) bilayer film (e.g., 125 μm) can be utilized. In some embodiments, a PA/PE coextruded layer film (e.g., 130 μm having eleven (11) layers) can be utilized.

Useful flexible containment vessels may have different sizes and shapes, which may be able to hold different volumes of material, depending on the final requirements and configuration of the dispensing system they are connected to. The shape of the flexible containment vessels can depend at least in part on the device or system in which they are intended to be used. In some embodiments, useful flexible containment vessels can be tubular in shape. In some embodiments, two different size flexible containment vessels can be utilized in one dispensing system or device. In some embodiments, useful flexible containment vessels can hold from 1000 mL to 10 mL, 800 mL to 25 mL, or even 600 mL to 50 mL for example.

The at least two flexible containment vessels can connect (e.g., directly) to at least two adhesive delivery channels (each flexible containment vessel connects to its own adhesive delivery channel) or one or more outlet manifolds of a chamber. In some embodiments where the at least two flexible containment vessels connect to its own adhesive delivery channel, the flexible containment vessel and its respective adhesive delivery channel can be co-continuous in that they can be made from, e.g., extrusion molded, from a single (or multiple) material(s), or can be made separately (from the same or different materials) and can be connected by a user.

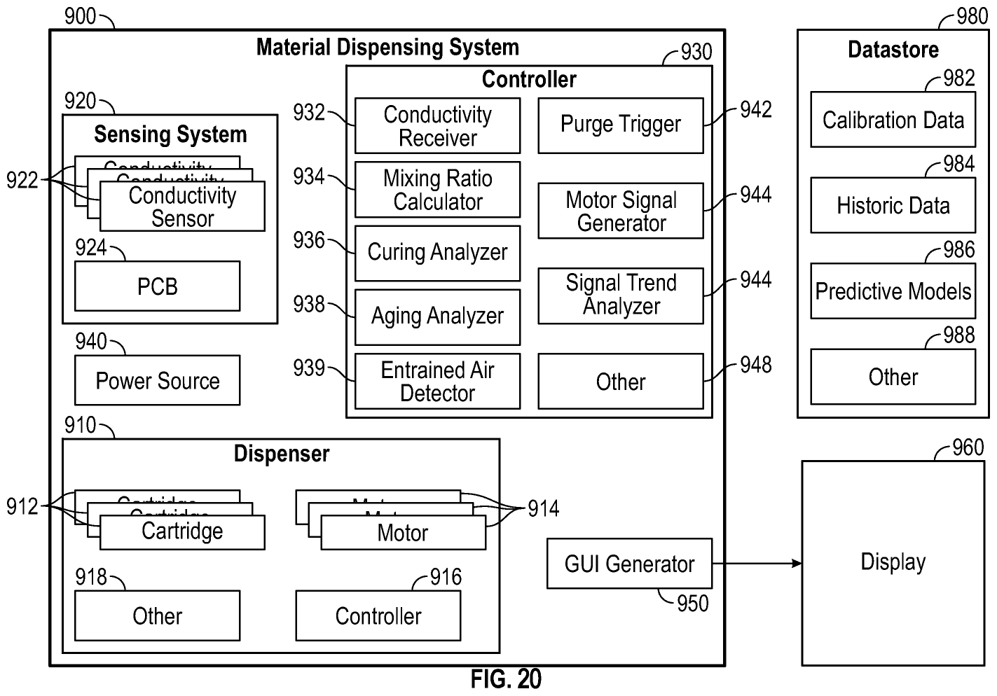

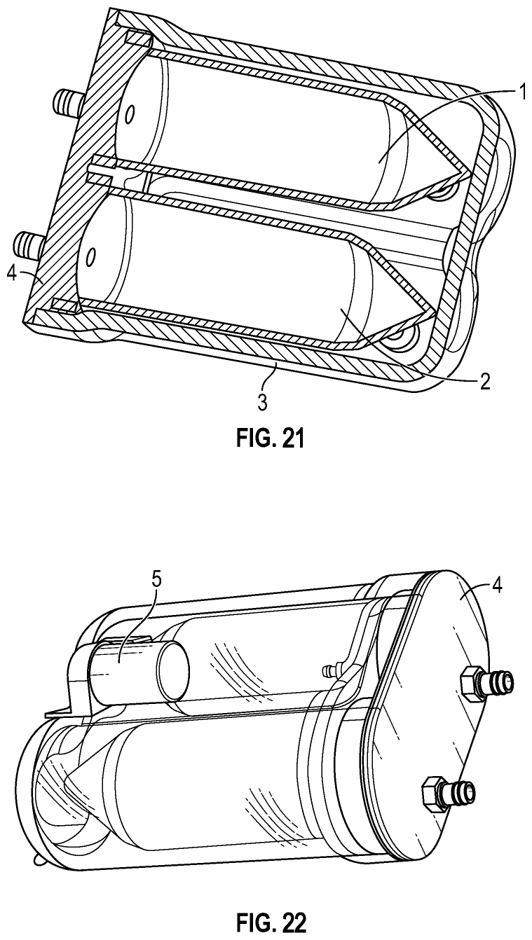

In some embodiments, each flexible containment vessel will have a single outlet that is configured to be accepted by an outlet manifold of a chamber. The chamber is configured to hold the at least two flexible containment vessels. FIG. 8 shows an illustrative example of a chamber 3 that houses a first flexible containment vessel 1 and a second flexible containment vessel 2. The chamber 3 also includes an outlet manifold 4. The particular shape and configuration of the chamber is at least somewhat dependent on the shape and configuration of the flexible containment vessels as well as how many flexible containment vessels it is configured to hold. The illustrative chamber 3 in FIG. 21 is configured to hold two flexible containment vessels, but disclosed devices are in no way intended to be limited to use with only two flexible containment vessels. The outlet manifold 4 is fluidly connected to the outlets of the at least first and second flexible containment vessels once the first and second flexible containment vessels are loaded into the chamber.

In embodiments where the at least two flexible containment vessels connect to at least two adhesive delivery channels, at least some portion of the adhesive delivery channels may be contained in the chamber. In embodiments where the at least two flexible containment vessels connect to at least two adhesive delivery channels, a chamber may have a substantially open end where the adhesive delivery channels exit.

In embodiments where the at least two flexible containment vessels connect to an outlet manifold of the chamber, the outlet manifold may be disposable, may be able to be cleaned by a user, or both. In some embodiments where the at least two flexible containment vessels connect to an outlet manifold of the chamber, the chamber may be disposable.

Disclosed systems or devices that utilize disclosed flexible containment vessels allow separate parts of an adhesive to be stored separately in individual flexible containment vessels and then loaded into the chamber that includes an optional connecting manifold or connecting adhesive delivery channels to link the contents of the flexible containment vessels to a pump/metering element of a disclosed adhesive dispensing system. The configuration of the flexible containment vessels, chamber and outlet manifold contribute to enabling a lightweight system or device that can function as a portable handheld dispensing system.

The system or device may also include a compressive element configured to apply external positive pressure to the at least two flexible containment vessels in the chamber to force the contents from the at least two flexible containment vessels through the optional outlet manifold or into the connecting adhesive delivery channels. In some embodiments, use of the optional compressive element may only be necessary or desired in embodiments where high viscosity materials are present in one or more of the flexible containment vessels. FIG. 22 shows a chamber having an outlet manifold 4 and including an external compressive element 5.

The compressive element may be configured to apply uniform pressure over the entire surfaces of the at least two flexible containment vessels. By applying a uniform pressure over the entire flexible containment vessel, the viscous components therein can be gently squeezed through the optional outlet manifold or to the connecting adhesive delivery channel to the next pumping/metering stage. The amount of pressure applied, and outlet manifold or adhesive delivery channel dimensions can be tailored such that the next stage in the dispensing system does not need to generate negative pressure to meter and flow the viscous components. This can be achieved by using pressure transducers to control and maintain correct pressures in the system during use. In some embodiments, useful compressive elements have a linear relationship of flow rate (e.g., milliliters (mL) per second(s) (mL/s) versus pressure in Pascals (Pa).

An advantage of using this pressurized system is that it will require lower power to drive the pumping system compressor element. The system may also use low pressure gas (air) which may minimize safety concerns over construction and control if high pressures were used. The design also need not be bulky, heavy or have complex mechanical drive mechanisms to cause the viscous materials to flow and therefore enable a handheld version of a dispensing system allowing disclosed devices to be smaller, lighter and more ergonomic to use. Use of the external compressive element generally provides a consistent flow rate (mL/s) versus dispensed volume (e.g., mL) through the entire contents of the flexible containment vessel, thereby assuring the next stage of the pumping/metering system a stable input of material.

Another advantage of using the compressive element is that the flexible containment vessels could be refilled and reused. In some embodiments, reversal of the pressure applied via the compressive element could be utilized (e.g., in a separate system) to refill the flexible containment vessels from a bulk system. In some embodiments, reversal of the pumps/motors can be utilized to re-inflate or refill a flexible containment vessel to push material back into it. In some embodiments, the mixing tip (discussed below) can be removed and the flexible containment vessels can be refilled from a separate external container containing the component of the multipart adhesive. In some such refillable embodiments, the flexible containment vessels could even be maintained in place in the application device. Such uses would reduce cartridge waste and provide the possibility of multiple re-uses to reduce the environmental impact of the overall adhesive system.

The flexible containment vessels may also be surrounded by a collapsible structure within the chamber that assists in controlling the collapse and encourages removal of the entire contents of the flexible containment vessels.

Disclosed systems also include an adhesive delivery channel for each flexible containment vessel. Inclusion of an adhesive delivery channel in disclosed systems minimizes the number of surfaces within the system that come into contact with the materials from the at least two flexible containment vessels, an adhesive formed by mixing the materials from the at least two flexible containment vessels, or both. Specifically, use of adhesive delivery channels can ensure that materials from the flexible containment vessel, adhesive formed by mixing said materials or both don't come into contact with any of the mechanical pump components. As such, the portion of the system irrespective of the flexible containment vessels are reusable and do not need to be cleaned (e.g., remove adhesive or adhesive components from surfaces of the application device) or replaced before reuse or when switching from one adhesive or component thereof to another. Adhesive delivery channels can be made of any useful material, including for example various polymeric materials. In some embodiments, the at least two adhesive delivery channels can be made of materials that are the same as or similar to those that make up the flexible containment vessels. In some embodiments, the at least two adhesive delivery channels can be made of materials that are substantially different than those that make up the flexible containment vessels.

Illustrative materials for the at least two adhesive delivery channels can include, for example high density polyethylene (HDPE), polypropylene (PP), polyamide (PA), Nylon, polyethylene terephthalate (PET), polybutylene terephthalate (PBT), co-extrusion of ethylene-vinyl alcohol copolymer (EVOH) with another polymer, thermoplastic polyurethane (TPU), metalized polypropylene, metalized polyethylene terephthalate (PET), metalized polyester, aluminum films, and coated foils. Additional materials may also include uncoated metals and coated metals (both uncoated and coated metals may both be classified UN 1A2/Y/100/ . . . ) that may include an inner-liner made from PP, polyvinyl chloride (PVC), or combinations thereof. Additionally, materials may be powder coated for use with certain formulations.

In some embodiments, polyethylene or polypropylene materials may be utilized.

In some embodiments, a clear multilayer polymer film made by extrusion can be utilized. Specific, selected compositions can include polyamide/polyethylene (PA/PE) bilayer films having thicknesses from 120 to 130 μm can be useful. Such films can be suitable for the packaging of polyurethane resins (polyol/isocyanate). Such films may provide the resistance against any possible impacts of polyols and isocyanates.

In some embodiments, a co-extruded film that includes a first nylon layer (e.g., a 1.35 mil nylon layer) and a second linear low-density polyethylene (LLDPE) layer (e.g., a 3.15 mil LLDPE) can be utilized. In some embodiments, a PA/polyethylene (PE) bilayer film (e.g., 125 μm) can be utilized. In some embodiments, a PA/PE coextruded layer film (e.g., 130 μm having eleven (11) layers) can be utilized.

In some embodiments, adhesive delivery channels do not need to prevent the components of the flexible containment vessel or an adhesive formed therefrom from coming into contact with the pump if the pump is a simple, low cost pump. Illustrative pumps can be manufactured from injection molded components, for example. Pumps manufactured from injection molded components could also be utilized in systems where the adhesive delivery channel does not prevent the materials from the flexible containment vessel, an adhesive formed therefrom, or both from coming into contact with the pump or portions thereof.

In some embodiments, the at least two adhesive delivery channels can include at least first and second tubes where the at least two adhesive delivery channels are in contact with at least a portion of the pump. In some embodiments, the relative ratios of the inner diameters of at least the first and second tubes can be changed to allow for different ratios of materials from the at least first and second flexible containment vessels respectively. In some embodiments, even though they allow for different ratios of materials, the wall thickness of the first and second tubes are constant.

In some embodiments, the entire fluid pathway, which includes both the adhesive delivery channels as well as the pathway once the two components are mixed, is self-contained with no direct contact between the pump components and the materials. In such embodiments, the pathway that runs through the pump is intended to form part of a low-cost disposable (or reusable via cleaning, for example) packaging of the adhesive components. In some embodiments, the other components of the fluid pathway include at least two (two in the case of a first and second flexible containment vessels) tubes (e.g., silicone or a similar material) upon which the pump acts on. Loading the at least two flexible containment vessels as well as the other components of the fluid pathway into the system or dispenser can be made relatively simple. In some embodiments, a hinged door (or cap) can be opened to allow access to the tubing, which can then be removed or inserted.

Disclosed systems also include at least one motor. In some embodiments, disclosed systems can include a single motor, and, in some embodiments, disclosed systems can include more than one motor. In some embodiments, disclosed systems can include one motor per pump and in some embodiments, more than one pump can be run by a single motor. In some embodiments, utilization of a motor for each flexible containment vessel can provide a system that offers the advantage of continuously variable control of the components. For example, one motor can be configured to run multiple pumps using multiple gear box(es). In some embodiments, at least four components can be run using a single motor by using three gear boxes for example. In some embodiments, useful motors can include direct current (DC) gearmotors. In some embodiments, one motor can control the pumping and mixing of materials from two flexible containment vessels to form an adhesive.

Disclosed systems also include at least a first pump that is actuated by the at least one motor. In some embodiments, the pump can be a variable positive displacement pump. Useful types of variable positive displacement pumps can include for example rotary peristaltic pumps, linear peristaltic pumps, rotary lobe pumps, progressive cavity pumps, rotary gear pumps, piston pumps, diaphragm pumps, screw pumps, gear pumps, hydraulic pumps, and rotary vane pumps.

In some embodiments, disclosed herein is a peristaltic pumping system that is designed for accurate dispensing of high viscosity fluids (e.g., adhesives) in a relatively low-cost package where in some embodiments, the fluid does not contact the mechanical components allowing quick and safe swapping of the liquid (e.g., the components as well as adhesives formed thereby) with no cleaning. Such systems may be particularly suited to high viscosity adhesives but could also have applications within other markets including wound care, dental and automatic aftermarkets for example. The dispensing system can be incorporated into an electric hand dispenser or robotic application system where the cost of the dispenser needs to be low and/or the fluid needs to be changed regularly (as there is no contact with the fluid and hence no cleaning required).

Additional advantages of using these types of peristaltic pumps can include, for example, they are self-priming, they can dispense fluids having broad ranges of viscosities, the output of the pumps are proportional to rotations, they have a relatively compact size, there will be a relatively low volume of adhesive left in the pump at the end of the life of the flexible containment vessels (thereby leading to lower wasted amounts), they can generate good pressures and the capability to hold such pressures, they can operate in forward and reverse, at rest the fluid pathway is occluded (which may prevent or at least minimize oozing of adhesive at the end of a dispense operation), or any combinations thereof.

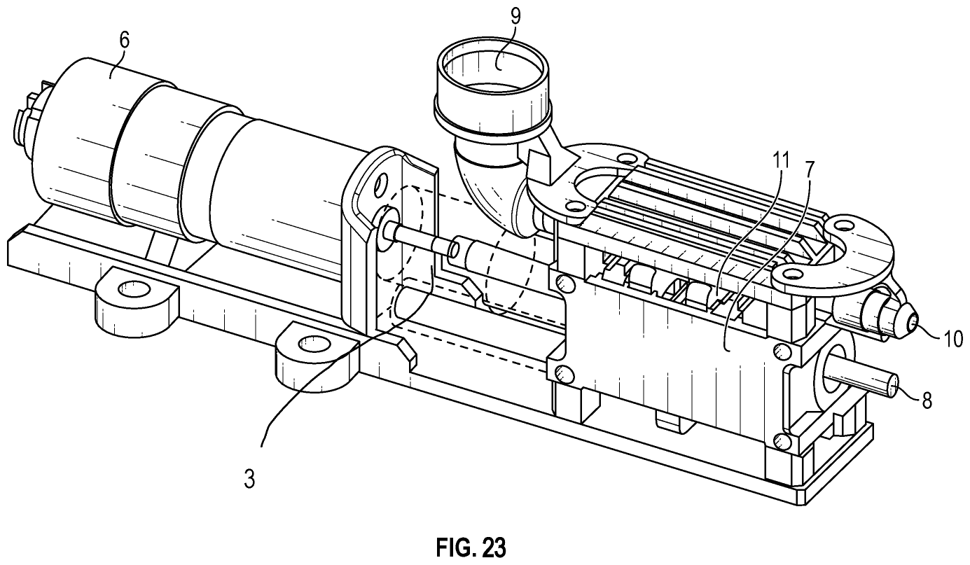

FIG. 23 shows some of the components of an illustrative embodiment of disclosed systems. The system includes a motor 6, for example a DC gear motor a fluid inlet 9 (to which the outlet manifold of the chamber and therefore the material from the at least first and second flexible containment vessel would be fluidly connected), a pump 7 that in the illustrated case includes a linear peristaltic pump having disks 11 surrounding a drive shaft 8 and a fluid outlet 10. FIG. 23 illustrates only a single component entering the fluid inlet for the sake of simplicity. In such an embodiment, the component from the first flexible containment vessel would have already been combined before entering the fluid inlet 9. It will be understood that even though FIG. 23 only illustrates a single component, an additionally flexible containment vessel can be utilized in the illustrated system. In such an illustrated system, the drive shaft 8 runs all the way through the pump 7 for connection to a dynamic mixer (not pictured). The disks 11 are configured to depress onto a peristaltic tube that makes up part of the adhesive delivery channel. This embodiment also depicts a coupler 3 between the motor and the pump which is optional.

In some embodiments, the components of useful pumps can be injection molded, three-dimensionally (3D) printed then assembled or can be commercially obtained.

In some embodiments systems can include at least one linear peristaltic pump. Linear peristaltic pumps function, whereby a flexible resilient tube is collapsed along the working length to push out fluid within the tube, and during recovery to draw in the next portion of fluid. Linear peristaltic pumps can include a cam shaft that is configured to be driven by the at least one motor through the center of a housing that rotates to actuate moving elements that drive the material of the at least first and second flexible containment vessels. In embodiments where only one peristaltic pump is utilized to pump materials from two flexible containment vessels (for the sake of example only), the pump and the tubing through the pump may be configured so that opposite sides of the disks that make up the pump act on the two tubes respectively. More specifically, for example, a system may be configured so that a first tube is acted upon by the top of the disks that are within the pump and a second tube is acted upon by the bottom of the disks that are within the pump.

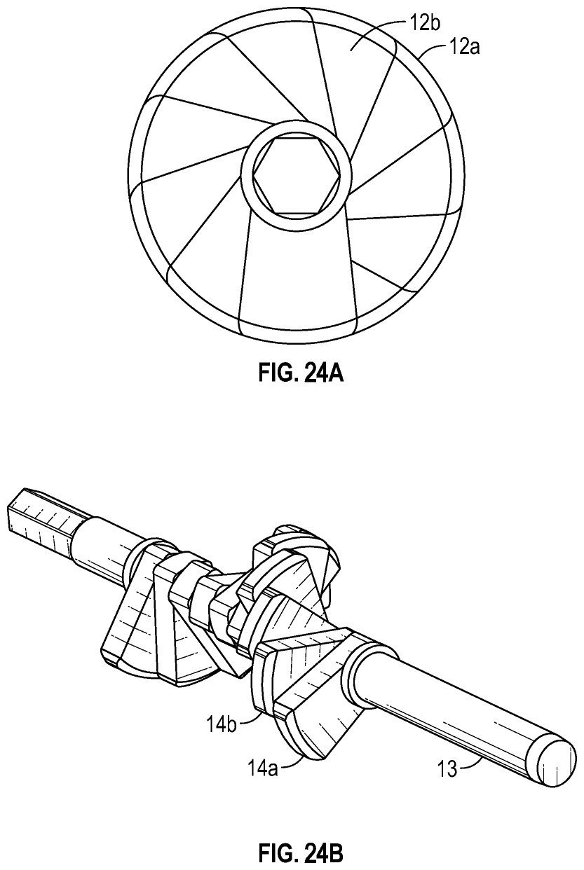

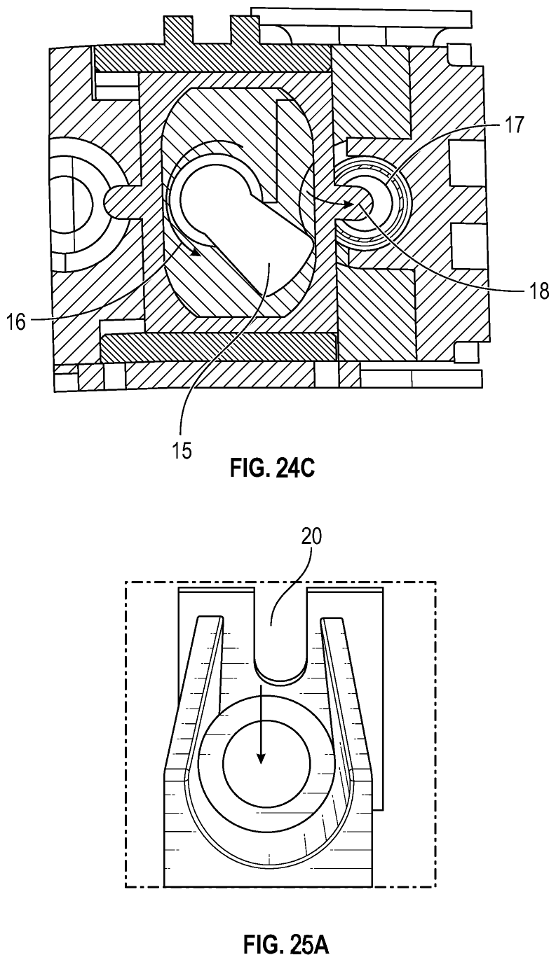

Operation of an illustrative peristaltic pump can be explained as follows with specific regard to FIGS. 24A, 24B and 24C. A cam shaft 13 in FIG. 23B and 15 in FIG. 24C driven by a gearmotor though the center of the housing rotates (direction shown by arrow 16 in FIG. 24C) to actuate moving elements (which for the purpose of this prototype are disks 12a, 12b, etc. in FIG. 24A) in a sequence that forces (see direction of force given by arrow 18) the sidewalls of the tube 17 together, the pinching action evacuating the tube and preventing flow in this section of the tube. The tube always has at least one section completely closed to prevent backflow/leakage and generate the pressures required for self-priming and dispensing. In some embodiments, each cam lobe may be designed with a constant radius that keeps each disk fully depressed until the next is in position, and there is a small overlap whereby adjacent disks are both fully depressed to prevent loss of pressure/leak through the pipe.

The operation of the concept has been proven using individual disks, of which a minimum of 3 may be utilized for operation, but in embodiments about 10 may be utilized. A specific illustrative pump described later uses 11 disks. Alternatives that may be better for manufacturing could include flexible spring members, which could be made out of various materials, including for example flexible plastics, metals, etc., between the camshaft and the peristaltic tube. Or other moving elements with similar profiles. The camshaft design is shown from the end in FIG. 24A and from a perspective view in FIG. 24B. The 11 cams operate individual disks, with one revolution pressing all of the disks in turn. At the start/end of the revolution the disks transition and the one at the end is depressed. The camshaft and operation are demonstrated by examining FIGS. 24A, 24B and 24C.

A standard conventional peristaltic pump may have inherent disadvantages when compared to a linear peristaltic pump for this system. Principally they may include: the tube must bend around the casing which limits the ability to expand and pump high viscosity fluids (the tighter the radius—smaller pump—the worse the impact); the longer the pathway though the pump will lead to more adhesive in the system and potentially waste, also increased pressure requirements due to increased drop over the length of tube with high viscosity fluids; and the system would be larger as the fluid pathway cannot be arranged in line with the motor and container.

In some embodiments, especially those utilizing a linear peristaltic pump, the portion of the adhesive delivery channel that is acted upon by the pump may utilize standard silicone peristaltic tubing with a constant profile and wall thickness. The advantage of using constant circular profile tubes is the lower cost and ease of attachment to a manifold for inlet and outlet flows, and no alignment required in assembly. In some embodiments, the tube was compressed between a flat section of the moving element and housing cap, resulting in a flat profile when fully compressed. This is the conventional way a peristaltic pump operates. One disadvantage of this approach may become apparent when the inlet fluid is pressurized. Pressurizing the inlet fluid helps to feed a high viscosity fluid into the pump from a containment area, but in a peristaltic where the tube is flexible it tends to expand the tube and therefore increase the dispensed amount per rotation, leading to drift in accuracy.

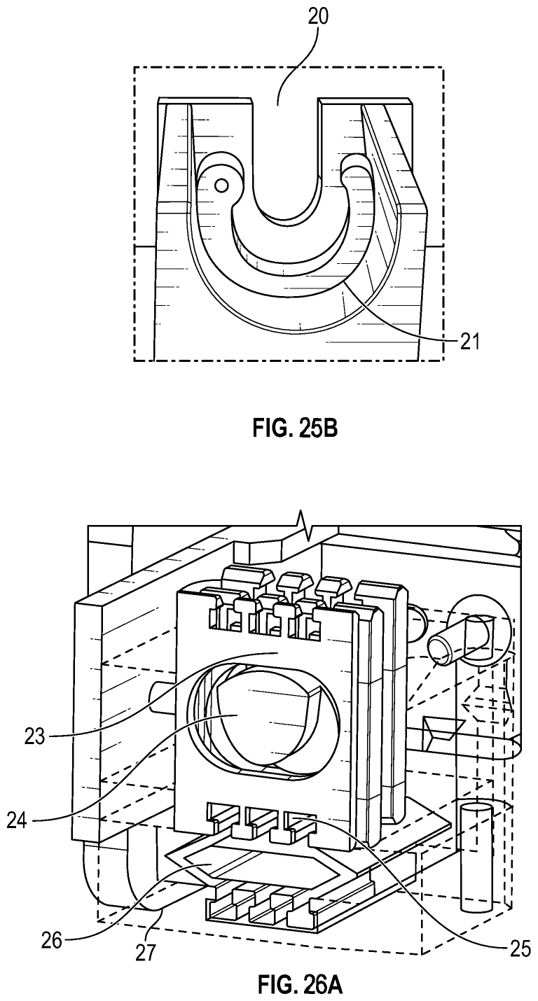

For this reason, a different compression profile may be advantageous to both increase the flow rate and also allow the tube to be constrained from expanding outwards when the fluid is under pressure. In FIGS. 25A and 25B a piece was manufactured to demonstrate the profile of the tube holder and compression applicator 20 which may be part of the disk. In the illustrated embodiment, the compression applicator and semi-circular form 21 (in FIG. 25B) are complementary to compress the tube uniformly (in some embodiments to 3.2 mm) at full extension. This form of compression into a profiled section may provide a higher flow rate and reduced speed dependence, both of which may be advantages for some of the intended use cases for this pump.

Linear peristaltic pumps, as well as any positive displacement pumps are able to be adapted to different mix ratios from the at least two flexible containment vessels. Specifically, there are a number of ways of adapting linear peristaltic pumps to dispense adhesives with mix ratios different than 1:1. One such method includes adjusting the relative flow between the material from the first flexible containment vessel and the second flexible containment vessel and hence the mix ratio, by choosing a set of tubes with internal volume ratios that match the desired mix ratio. The wall thickness must be kept constant as this determines how the pipe collapses and the compression is fixed by the pump disks/wall position (in some embodiments, these could be altered with inserts). Silicone extruded pipes which are commonly used in peristaltic tubing can be manufactured at relatively low cost using custom dies to achieve the control of the inner diameter.

A specific illustrative example of how the two tubes for materials from the first flexible containment vessel and the second flexible containment vessel respectively, could be chosen to provide a desired mix ratio for a product is as follows. A 10:1 mix ratio could pair a 6 mm inside diameter (ID) tube for the material from the first flexible containment vessel and a 1.90 mm ID tube for the material from the second flexible containment vessel. This specific configuration could be used for the commercially available 3M™ Scotch-Weld™ Low Odor Acrylic Adhesive DP8810NS (3M Co., St. Paul MN) for example. Additional examples could utilize 6 mm ID and a 4.24 mm ID for an adhesive that had a 2:1 mix ratio, and a 3.46 mm ID and a 2 mm ID for an adhesive that had a mix ratio of 3:1.

In some embodiments, useful pumps, such as linear peristaltic pumps do not require the use of disks such as those depicted, in such embodiments, the cam shaft of the pump itself could press on the tubing going therethrough. In some embodiments that include disks in the pumps, there can be a small overlap in adjacent disks to prevent loss of pressure/leak through the first and second tubes. In some embodiments that include disks, there can be at least three disks, at least 5 disks, at least 8, or even at least 10 disks. In some embodiments, the noted disks can be flexible plastic spring members. In some embodiments, a single revolution of the shaft presses all of the disks against the tube. In some embodiments, a single revolution of the shaft presses less than all of the disks against the tube.

Disclosed systems can be utilized for mixing and dispensing materials (e.g., the components to be mixed from the first and second flexible containment vessels) that have relatively high viscosities as well. The range of viscosity and thixotropic behavior of components of adhesives make them difficult to pump accurately. Disclosed systems and devices can dispense both lower relative viscosity adhesives (e.g., 3M™ Scotch-Weld™ Urethane Adhesive DP620NS Black) and higher viscosity adhesives (e.g., 3M™ Structural Adhesive SA9820).

In some embodiments, a unique geometry of tubing (e.g., the portion of the fluid pathway that is acted upon by the pump) is employed to both control the compression and expansion of the tube to allow the pumping of higher viscosity fluids. In this embodiment, the tube has a mechanical (e.g., a lock and key type connection) connects to the moving elements in the pump which compress (as a conventional linear peristaltic) but uniquely also attach to pull the tubing open as the moving element translates away from the tubing, forcing it to open with greater force than the material properties of the tube alone. Therefore, the pump can handle fluids of a higher viscosity than conventional designs.

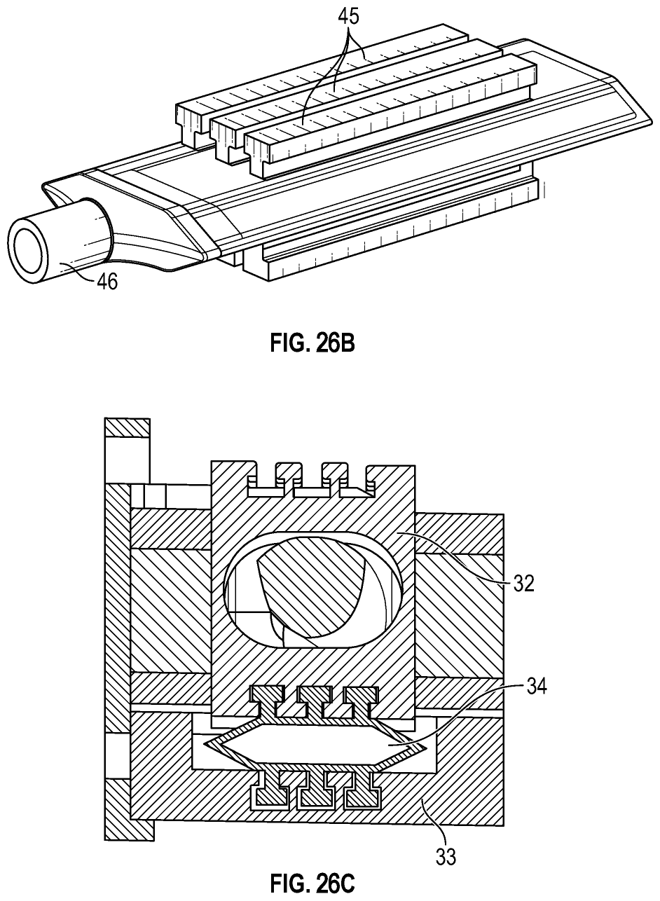

One specific embodiment of such a design can be seen in FIG. 26A. FIG. 26A depicts a single pump for pumping of the material from a first flexible containment vessel, for example. In FIG. 26A, 23 is an actuator element that is designed to engage with the tubing 26 and be acted upon by the pump itself through the rotating cam shaft 24 that translates to the actuator element (e.g., the disk in the linear peristaltic pump that moves) 23. The tubing 26 in this embodiment has interlocking features 25 between the actuator element 23 and the tubing 26. The actuator element 23 in this specific embodiment only undergoes movement in the vertical direction (normal to the base of the housing 27), but it should be noted that such movement is not the only direction in which various actuator elements can move.

FIG. 26B shows an illustrative configuration of the tubing that traverses the pump region of the system. This specific embodiment includes three ribs 45 that are present on both the top and bottom surfaces of the tubing. The ribs 45 are configured to engage with specifically designed voids in the actuator elements. The tubing also includes a rigid inlet 46 and rigid outlet (not shown in FIG. 26B). The rigid inlet 46 is fluidly connected to the outlet manifold of the chamber and the rigid outlet is fluidly connected to a mixing nozzle. In this embodiment, the ribs are inserted into grooves in the actuator elements that will be above the tubing and the lower housing of the pump. It should be noted that the ribs in FIG. 26B are not uniform along the length but could certainly be uniform along the length of the tubing. At each end a rigid coupler to the inlet and outlet is inserted or joined to the tubing. Alternatively, the inlet and outlet could be welded on, push fit on, or some other method of attachment. As the tubing is inserted into the housing and the pump is run, the tubing is forced to either open or close to fluid flow. In some embodiments, the housing and actuator elements could open to allow the tubing to be dropped in.

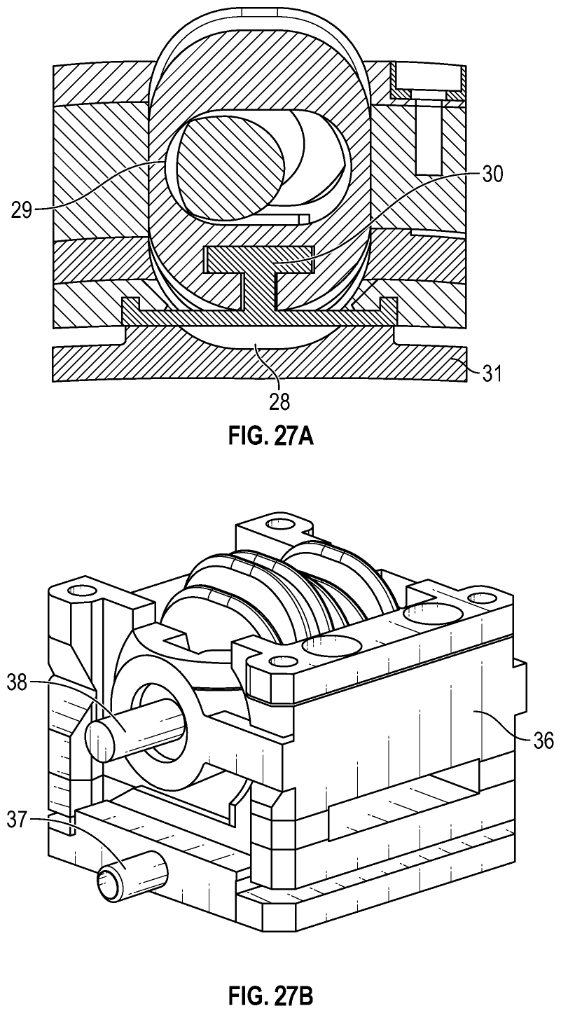

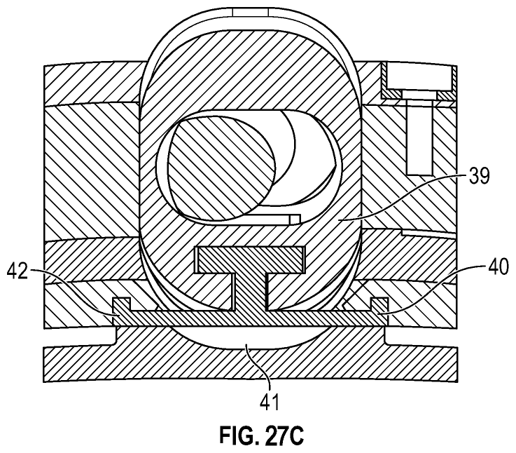

Another specific embodiment that may be useful for high viscosity components can be seen in FIG. 27A. The components of the system shown in FIG. 27A include the actuator elements 29 (e.g., the disk in the linear peristaltic pump that moves) that acts on the inner volume 28 of the tubing, a flexible membrane 30 that is both sealed on the tubing that runs through the pump and is attached to the bottom of the actuator elements 29 and the rigid housing 31 that is sealed to the membrane 30.

The mode of operation of the embodiments in FIGS. 26A and 27A are similar and are illustrated by FIGS. 27B and 27C showing a single actuator element. As the moving disk is translating upwards (relative to FIG. 27A) the membrane or extrusion is connected in such a way that the top surfaces are pulled away from the lower surfaces causing an increase in the inner volume of the tubing. This expansion will create a negative pressure pulling in the next section of fluid from the inlet. Normally this expansion is limited by the properties of the tube but in disclosed embodiments is greatly enhanced by the cam driven moving disk. FIG. 27B shows the inlet 37 into the pump, the camshaft 38 and the housing or main body 36. FIG. 27C shows the membrane 42 clamped into the housing, the actuator element 39 and the silicone extrusion 40 that ultimately forms the inner volume 41. The membrane is sealed to the rigid housing which forms the lower fluid pathway and inlet and outlet ports. The rigid housing would therefore contact the fluid and become a disposable component. In the prototype the housing was sealed to a 3D printed flexible membrane using adhesive. A commercial solution could weld the components together or seal them by clipping together. When inserted into the housing and slid into the disks the membrane is fully compressed (occluded) at some point. The disk, membrane geometry and rigid housing are designed together to ensure the fluid pathway is fully closed when the disk is in full depression state.

Disclosed devices or systems also include a mixing tip. As the materials from the first and second flexible containment vessels are drawn out of the first and second flexible containment vessels via the negative pressure applied by the pump(s), they come out of the chamber via the outlet manifold and then enter the pump (e.g., through some fitting that connects the outlet manifold to an inlet or inlets into the pump or pumps. After the pump has acted on the material, it is forced through the pump and eventually both materials reach the outlet of the pump(s). The mixing tip is then fluidly connected to the outlet of the pump(s) (e.g., through some fitting(s) that connects the outlet of the pump(s) to the mixing tip). It is at the mixing tip that the at least two materials are mixed to form the adhesive to be applied by the device or system.

Whether the amounts of Part 1 and Part 2 (as well as any additional parts) are provided via an electronically controlled or handheld type dispenser, the two parts still must be mixed before being utilized. Alternatively, or additionally, two or more sub-Parts may have to be combined and mixed thoroughly. Often two component epoxy adhesives have one color for the resin and another color for the hardener—in these cases it is fairly easy to visualize when you've mixed the adhesive thoroughly. When both the resin and hardener are the same color, it may be more difficult.

Mixing nozzles or mixing tips may be useful to provide mixing of the at least two Parts (as well as any sub-Parts that need to be mixed to form the Parts or additional Parts). The mixing tip is designed and/or configured to receive the two parts from the at least two adhesive delivery channels and mix the two parts together to form the adhesive. The mixing tip also functions to deliver, dispense, or both the adhesive through a dispensing end.

In general, any type of mixing nozzle can be utilized. For example, static mixers, dynamic mixers, turbo mixers (also known as Quadro mixers) can all be utilized herein. In the case of using dynamic mixers, the motor that is already built into the device can drive the dynamic mixer. Static mixers are the oldest technology in two-part adhesive dispensing. These nozzles are round and come in a wide range of connection types. Standard mixers typically require longer nozzles and more mixing elements to create the same mixing quality as Quadro mixers.

Quadro mixers are generally square in shape. Quadro mixers allow for more complete mixing in a shorter nozzle. The advantage of Quadro style nozzles is that there is less wasted adhesive left over in the nozzle and users can get closer to their substrates when dispensing.

Dynamic mixers are generally motor driven. Devices disclosed herein can utilize the motor previously discussed (that runs the at least one pump) to run the dynamic mixing nozzle or can utilize a separate motor.

Static mixers can take any number of forms, each suited to particular applications and with unique advantages and disadvantages. These include in-line mixers, where components are placed as a permanent part of the dispensing line, and static dynamic mixers, which have moving parts but are not powered. Disposable bayonet mixers, however, are by far the most common and widely applicable. Disposable static mixers take the form of a nozzle that attaches to either meter mix and dispense (MMD) or handheld dispensing equipment. Their internal components can vary greatly depending on the needs of the application. The most common are the helical type and the box chamber type. Disposable static mixers are designed to be thrown away after use which can be cost effective compared to the flushing and cleaning necessary in non-disposable mixers. They also make sense for equipment which will handle multiple adhesive types.

There are many different varieties of static mix nozzles. It is important to use the one specified by the manufacturer to ensure proper mixing occurs. The number of elements in the nozzle dictate the number of stirs the adhesive gets while passing. Nozzles can range from 24 to 56 elements so the nozzle with 24 elements only stirs the adhesive 24 times—the one with 56 has more than double the number of stirs, for example.

### Handheld Device

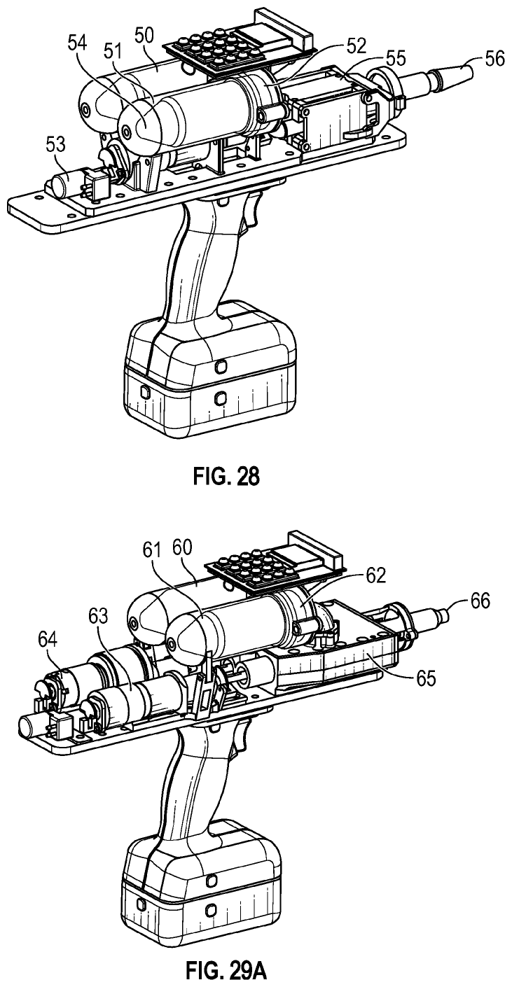

FIG. 28 depicts a possible embodiment of a handheld device or system for mixing of two components to form an adhesive and deliver the same to a substrate. The applicator in FIG. 28 includes a chamber 54 that holds a first flexible containment vessel 50 and a second flexible containment vessel 51 and has an outlet manifold 52. Compressing element 53 provides compression for the flexible containment vessels. The motor driving pump 55 is located beneath first flexible containment vessel 50 and a second flexible containment vessel 51. In this embodiment, a single pump is utilized to pump material from both the first flexible containment vessel 50 and the second flexible containment vessel 52. The device also includes a mixing tip 56. This device could also include a processor (not called out in figure) to which input can be provided by the user through the keyboard 57. Such a processor can also be utilized to control a metering element that controls the pump(s). Integration and configuration of the noted components as well as power, etc. to enable the device would be known to those of skill in the art having read this specification.

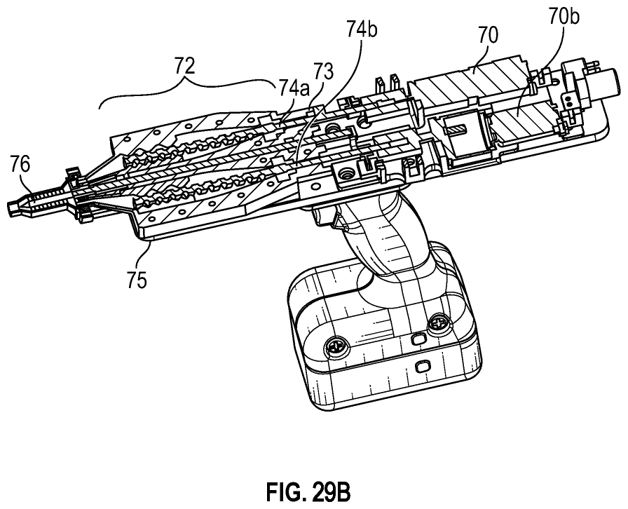

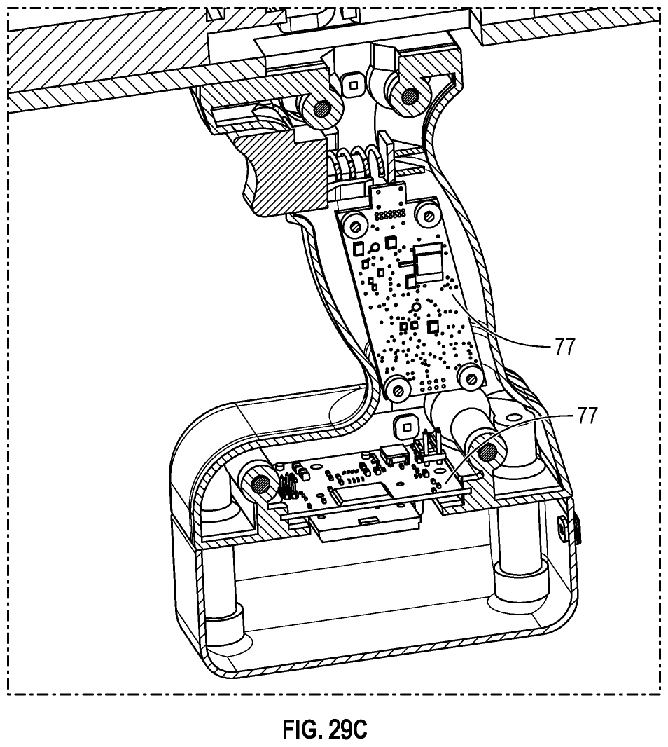

FIG. 29A shows another possible embodiment of a handheld device or system for mixing of two components to form an adhesive and deliver the same to a substrate. The applicator in FIG. 29A includes a first flexible containment vessel 60 and a second flexible containment vessel 61 housed within a chamber having an outlet manifold 62. The device also includes two side by side pumps of which one is specifically noted as pump 65. In this embodiments, these are progressive cavity pumps. This device includes two motors 63 and 64 that run the first pump 65 and the other pump. The device also includes a mixing tip 66. FIGS. 29B and 29C show cutout portions of the device in FIG. 29A. In FIG. 29B, the first and second motors are shown by 70 and 71. The first 70 and second 71 motors act on the first and second shafts 74a and 74b. The region 72 indicates where a disposable or cleanable element would exist in order to enable reuse of the entire system. The pumps are enclosed with a pump casing 73 and the entire device is disposed within an outer housing 75. The device also includes the mixing tip 76. FIG. 28C shows electronics 77 within the grip area of the devices outer housing.

### Kits

Disclosed herein are also kits that include handheld delivery devices such as those discussed above and at least two flexible containment vessels containing a Part 1 composition and a Part 2 composition, as discussed above. The amounts, ratios or both of the Part 1 and the Part 2 compositions are controlled by the handheld delivery device, and the amounts, ratios, or both of the Part 1, and the Part 2 affect one or more properties of the multipart structural adhesive composition.

Different types of components could be packaged together in kits to provide a consumer access to adhesives having variable types of properties depending on the particular application that the consumer may want to use the adhesive for.

For example, a particular illustrative kit could provide a consumer with a single handheld delivery device and a sufficient number and types of materials within flexible containment vessels that could be utilized for any of the structural adhesive needs that a consumer engaged in a particular industry might need. Alternatively, another particular illustrative kit could provide a consumer a sufficient number and types of materials within flexible containment vessels that could be utilized for any of the structural adhesive needs that a consumer engaged in a particular industry might need, the assumption being that the consumer already has the handheld delivery device. Alternatively, another particular illustrative kit could provide a consumer with a single handheld delivery device, a sufficient number and types of materials within flexible containment vessels that could be utilized for any of the structural adhesive needs that a consumer engaged in a particular industry might need, spare parts for the handheld delivery device, optional mixing tips, additional adhesive delivery channels, additional outlet manifolds, carrying cases for the handheld delivery device, carrying cases for the handheld delivery device and other optional components, or any combinations thereof.

### Additional Components

The disclosed methods, systems and devices can be very useful to high volume applications requiring larger quantities. In these applications, handheld dispensers may be impractical due to large quantities used or being part of an automated manufacturing line. Automated dispensing equipment can be used to control the amounts of the two parts and then the two parts can be dispensed through a mixing tip to form the two-part (for example) adhesive. Any or all of these concepts could be incorporated into handheld delivery devices as disclosed herein.

Various companies can provide various components, systems, etc. that can be capable of electronically controlling and mixing Parts 1 and 2 (or more) of a two-part structural adhesive and could additionally provide for mixing of one or more of those Parts that may have sub-Parts that need to be mixed as well. For example, a system can be configured and programmed to control the dispense time (e.g., milliseconds), the volume of the materials (e.g., in milliliters), or the weight of the material (e.g., in grams), or any combination thereof. Additionally, the ratios of Part 1 and Part 2 (for example) can also be controlled, programmed, or both. In some embodiments, the amounts, ratios, or both of the various Parts, sub-Parts, or both being dispensed can be controlled to +1% (volumetric, for example). Any or all of these concepts could be incorporated into handheld delivery devices as disclosed herein.

In some embodiments, piston pumps can be utilized. Piston pumps can be useful because they can be fitted and designed to include both metering and mixing dispensing equipment. Piston pumps can also be electronically controlled using a programmable or programmed controller. Any or all of these concepts could be incorporated into handheld delivery devices as disclosed herein.

Illustrative commercially available systems can include, for example Nordson EFD's 797PCP-2K series progressive cavity pump system (Nordson Corporation Inc., Wixom, MI, USA), which provides volumetric meter mix dispensing for two-part fluids. Various optional components that can be utilized with the Nordson EFD cavity pumps can include, for example mixers (e.g., Series 190 Spiral Bayonet Mixers, Series 295 Square Turbo Bayonet Mixers), controllers (e.g., 7197PCP Controllers), and additional components not specifically disclosed or referred to herein. An additional optional component that can be utilized along with the pump system above, or other pump systems can include a bulk unloader, for example for loading a Part 1 and a Part 2 into a pump system such as that noted above as being commercially available can include Rhino Bulk Unloader (Nordson Corporation Inc., Wixom, MI, USA)

In some embodiments, gear pump metering and mixing dispensing equipment may be preferable for lower viscosity adhesives and may be especially useful in fully automated high production environments. Any or all of these concepts could be incorporated into handheld delivery devices as disclosed herein.

Automated or programmable pumps such as piston pumps, gear pumps, etc. can also be useful because they can optionally be controlled to vary the amounts, ratios, or components as the structural adhesive is being formed and utilized. For example, the amount of one Part (or vice versa) can be varied during application by an automated system to account for various environmental parameters (e.g., temperature, humidity, etc.), to form a structural adhesive having at least one different property than the structural adhesive that was formed before varying the amount, ratio or both of the specific Part of the composition, to create a structural adhesive that has at least one changing property for use in a specific application, or any combination thereof (or for other reasons not specifically indicated herein). Any or all of these concepts could be incorporated into handheld delivery devices as disclosed herein.

In some embodiments, illustrative systems that can be used along with disclosed structural adhesives to control, vary, or both various amounts of components (e.g., Part 1, Part, 2, sub-Parts 1, sub-Parts 2, additives, etc.) can include devices, components, systems, etc. disclosed in EP Application Serial No. 20186305.7 (also PCT application number IB2021/056362). Such systems can offer the advantage of changing one or more properties of the structural adhesive while it is being dispensed. Some such systems can additionally utilize sensors that measure one or more properties of the adhesive and utilize such measurements, at least in part, to control the amounts, ratios, or both of the various components. Any or all of these concepts could be incorporated into handheld delivery devices as disclosed herein.

In some disclosed embodiments, such systems can include, for example: property sensors for determining a property value of a property of a liquid, such as a two-component curable adhesive, the property sensor comprising a channel comprising a sensing zone through which—in use—the liquid flows; two electrodes for generating an electric field of one or more sensing frequencies in the sensing zone; a data storage device comprising a pre-stored set of calibration data representing calibration impedance responses measured previously at the one or more sensing frequencies and at different property values of the property of an identical liquid; and a property value deriver, electrically connected to the electrodes, and operable to repeatedly generate, while the liquid flows through the sensing zone, between the electrodes an electric field of the one or more sensing frequencies in the sensing zone; sense between the electrodes, at the one or more sensing frequencies, while the liquid flows through the sensing zone and while the electric field is present, a response impedance; and derive from the response impedance a property value of the property of the liquid, using the pre-stored set of calibration data representing calibration impedance responses. Any or all of these concepts could be incorporated into handheld delivery devices as disclosed herein.

In some embodiments, the channel can comprise a first longitudinal section having a first open cross section available for the flow of the liquid, and a second longitudinal section, downstream from the first longitudinal section, having a second open cross section available for the flow of the liquid, wherein the second open cross section is larger than the first open cross section, and wherein the sensing zone is comprised in the second longitudinal section. In some embodiments, the channel may comprise a bypass, arranged such that a first portion of the liquid flows through the sensing zone, and a second portion of the liquid flows through the bypass bypassing the sensing zone. Any or all of these concepts could be incorporated into handheld delivery devices as disclosed herein.

In some embodiments, one or both of the electrodes is/are arranged such as to be in contact with the liquid when the liquid flows through the sensing zone. In some such embodiments, the sensing zone can be arranged between the electrodes. In some such embodiments, one of the electrodes is arranged between the sensing zone and the bypass. Any or all of these concepts could be incorporated into handheld delivery devices as disclosed herein.

In some embodiments such a system can comprise a temperature sensor for sensing a temperature of the liquid in the channel or in the sensing zone. In some embodiments such a system can comprise a flow speed sensor for sensing a flow speed of the liquid through the channel or through the sensing zone. Any or all of these concepts could be incorporated into handheld delivery devices as disclosed herein.

Some such systems can provide sensor enabled mixing by utilizing a system that comprises a mixing device for mixing two or more components (A, B) to produce a mixed liquid at a mixer output, and a property sensor such as those described above, in fluid communication with the mixer output such that the mixed liquid can flow from the mixer output through the sensing zone. Any or all of these concepts could be incorporated into handheld delivery devices as disclosed herein.

Also provided herein and by such systems are processes of determining a property value of a property of a liquid, comprising the steps, in this sequence, of providing a liquid and a property sensor such as those described above, and having the liquid flow through the sensing zone; generating, while the liquid flows through the sensing zone, between the electrodes an electric field of the one or more sensing frequencies in the sensing zone; sensing between the electrodes, at the one or more sensing frequencies, while the liquid flows through the sensing zone and while the electric field is present, a response impedance; and deriving from the response impedance a property value of the property of the liquid, using the pre-stored set of calibration data representing calibration impedance responses. Any or all of these concepts could be incorporated into handheld delivery devices as disclosed herein.

In some embodiments, such processes can utilize sensing frequencies at a frequency of between 1 Hertz and 10000 Hertz, and wherein the amplitude of the electric field is between 100 Volt per meter and 20000 Volt per meter. Any or all of these concepts could be incorporated into handheld delivery devices as disclosed herein.

In some such embodiments, the liquid has a dynamic viscosity of between 10 Pascalseconds and 40,000.0 Pascalseconds, measured at 25° C. according to standard ASTM D7042-12a in its version in force on 1 Jul. 2020.

Additionally, such methods, systems or both may provide a set or sets of calibration data. Illustrative sets of calibration data representing calibration impedance responses for use in the process described above can include those wherein the set of calibration data further represents a property value of a property of a calibration liquid at which property value one of the calibration impedance response was sensed. In some such cases, the set of calibration data representing calibration impedance responses discussed immediately above, wherein the set of calibration data further represents a sensing frequency at which sensing frequency one of the calibration impedance responses was sensed, and/or wherein the set of calibration data further represents a temperature of the liquid in the sensing zone at which temperature one of the calibration impedance responses was sensed. Any or all of these concepts could be incorporated into handheld delivery devices as disclosed herein.

Processor Controlled System and Method for formulating Multiple Structural Adhesives using a limited number of Components

Disclosed systems and methods could be controlled and/or programmed, for example by a programmable logic controller (PLC) to dispense the desired adhesive formulation based on a customer's requirements—for example, desired physical properties for an application (i.e. working life, adhesion, strength, etc.). The dispensing system could be supplied with multiple Parts 1, Parts 2, sub-Parts 1, sub-Parts 2, compatible additives, or any combinations thereof based on the specific adhesive system, application requirements, or combinations thereof. Once the required properties were selected, the PLC could determine a formulation that would provide those properties based on the right combination of Parts, sub-Parts, compatible additives, or any combinations thereof. The combination could be based on past design of experiment (DOE) results, Neural Network Modelling, and artificial intelligence and machine learning (AI/ML) technology, for example. Because structural adhesive performance is impacted by chemistry and stoichiometry of the adhesive, the computer would control the amount of each of the components needed to provide the desired adhesive performance properties and then determine the right amounts of each to have the right stoichiometry. These components would be dispensed and thoroughly mixed in the right amounts for the desired adhesive performance properties. Any or all of these concepts could be incorporated into handheld delivery devices as disclosed herein.

The structural adhesive performance properties are based on the Part 1 and Part 2 compositions used. Part 1 can be made up of a combination of two or more compatible sub-part 1s, Part 2 could be made up of two or more compatible sub-parts 2, or any combination thereof. In some embodiments, each of the parts (sub-parts, or any combination thereof) can provide and impact one or more specific performance properties. In addition, other additives could be added based on the specific application needs and requirements such as color/pigments, UV and antioxidant stabilizers, fillers, etc., for example. Therefore, the adhesive formulation could be formed by combining more than three components based on the application requirements. For more complicated structural adhesive applications, the dispensing system could allow even additional inputs to meet all customer needs. Any or all of these concepts could be incorporated into handheld delivery devices as disclosed herein.

### EMBODIMENTS

Embodiment 1 is a method of tuning one or more properties of a multipart structural adhesive composition, the method comprising: providing a Part 1 of the multipart structural adhesive; providing at least a first sub-Part 2 and a second sub-Part 2 of the multipart structural adhesive; and causing to be formed the multipart structural adhesive by combining the Part 1, the first sub-Part 2, and the second sub-Part 2, wherein the amount, ratio, or both of the first sub-Part 2 and the second sub-Part 2 impact the one or more properties of the multipart structural adhesive composition, wherein the amounts or ratios of the Part 1, the first sub-Part 2 and the second sub-Part 2 affect the one or more properties of the multipart structural adhesive composition, and wherein the multipart structural adhesive has an overlap shear strength of at least about 0.75 MPa (109 psi).

Embodiment 2 is a method according to Embodiment 1, wherein the first sub-Part 2 and the second sub-Part 2 are combined to form a Part 2 before being combined with the Part 1.

Embodiment 3 is a method according to Embodiment 2, wherein the first sub-Part 2 and the second sub-Part 2 are combined to form the Part 2 in automated dispensing equipment.

Embodiment 4 is a method according to Embodiment 2, wherein the first sub-Part 2 and the second sub-Part 2 are combined to form the Part 2 in a handheld dispenser.

Embodiment 5 is a method of any of Embodiments 2 to 4, wherein the first sub-Part 2 and the second sub-Part 2 are mixed in a mixing nozzle.

Embodiment 6 is a method according to any of Embodiments 1, 2, 3, or 5, wherein the Part 1 and the Part 2 are combined in automated dispensing equipment.

Embodiment 7 is a method according to any of Embodiments 1, 2, 4, or 5, wherein the Part 1 and the Part 2 are combined in a handheld dispenser.

Embodiment 8 is a method according to Embodiment 1, wherein the Part 1, the first sub-Part 2 and the second sub-Part 2 are simultaneously combined.

Embodiment 9 is a method according to Embodiment 8, wherein the Part 1, the first sub-Part 2 and the second sub-Part 2 are combined in automated dispensing equipment.

Embodiment 10 is a method according to Embodiment 8, wherein the Part 1, the first sub-part 2 and the second sub-Part 2 are combined in a handheld dispenser.

Embodiment 11 is a method of Embodiment 1, wherein the Part 1 comprises a first sub-Part 1 and a second sub-Part 1.

Embodiment 12 is a method of Embodiment 11, wherein the first sub-Part 1, the second sub-Part 1, and the Part 2 are simultaneously combined.

Embodiment 13 is a method according to Embodiment 12, wherein the first sub-Part 1, the second sub-Part 1, and the Part 2 are combined to form the structural adhesive in automated dispensing equipment.

Embodiment 14 is a method according to Embodiment 12, wherein the first sub-Part 1, the second sub-Part 1, and the Part 2 are combined to form the structural adhesive in a handheld dispenser.

Embodiment 15 is a method according to any of the preceding Embodiments, wherein the ratio of the first sub-Part 2 to the second sub-Part 2 is from 100:1 to 1:1, from 10:1 to 1:1, from 4:1 to 1:1, or even from 2:1 to 1:1

Embodiment 16 is a method according to any of Embodiments 11 to 15, wherein the ratio of the first sub-Part 1 to the second sub-Part 1 is from 100:1 to 1:1, from 10:1 to 1:1, from 4:1 to 1:1, or even from 2:1 to 1:1.

Embodiment 17 is a method according to any of the preceding Embodiments, wherein the ratio of the Part 1 to the Part 2, the ratio of the first sub-Part 1 to the second sub-Part 1, the ratio of the first sub-Part 2 to the second sub-Part 2, or any combination thereof is controlled by a PLC controller.

Embodiment 18 is a method according to any of the preceding Embodiments, further comprising adding one or more additives to the one or more of the Part 1, the Part 2, the first sub-Part 2, the second sub-Part 2, the first sub-Part 1, the second sub-Part 1, or any combination thereof.

Embodiment 19 is a method according to Embodiment 18, wherein the additive is selected from: UV Stabilizers, Antioxidants, color/pigments, impact modifiers, plasticizers, fillers, and any combination thereof.

Embodiment 20 is a method according to any of Embodiments 1 to 19, wherein the Part 1 comprises a curable resin and the Part 2 comprises a curing agent.

Embodiment 21 is a method according to any of Embodiments 1 to 19, wherein the Part 1 comprises a curing agent and the Part 2 comprises a curable resin.

Embodiment 22 is a method according to any of the preceding Embodiments, wherein the one or more properties to be impacted is work life, shelf life, pot life, elastic modulus, shear strength, rate of strength build up, structural strength, overlap shear strength, adhesion, elongation, creep resistance, impact resistance, temperature performance, moisture resistance, color, or some combination thereof.

Embodiment 23 is a method according to any of the preceding Embodiments, wherein the one or more properties to be impacted is work life.

Embodiment 24 is a method according to any of the preceding Embodiments, wherein the one or more properties to be impacted is work life and it is being extended.

Embodiment 25 is a method according to any of the preceding Embodiments, wherein the ratio of Part 1 to the combination of the first sub-Part 2 and the second sub-Part 2 is from 100:1 to 1:1, from 10:1 to 1:1, from 4:1 to 1:1, or even from 2:1 to 1:1.

Embodiment 26 is a method according to any of the preceding Embodiments, wherein the structural adhesive composition is a multipart epoxy adhesive, a multipart methyl methacrylate adhesive, a multipart urethane adhesive, or a multipart silicone structural adhesive.

Embodiment 27 is a method according to any of Embodiments 1 to 26, wherein the Part 1 comprises an epoxy curable resin and the Part 2 comprises an amine curing agent.

Embodiment 28 is a method according to any of Embodiments 1 to 26, wherein the Part 1 comprises an amine curing agent and the Part 2 comprises an epoxy resin.

Embodiment 29 is a method according to any of Embodiments 1, 2, 4, 5, 7, 8, 10-12, and 14-20, wherein the handheld device comprises at least first and second flexible containment vessels and at least two adhesive delivery channels, a first adhesive delivery channel connected to the first containment vessel to receive Part 1 and a second adhesive delivery channel connected to the second containment vessel to receive Part 2.

Embodiment 30 is a method according to Embodiment 29, wherein the handheld device further comprises at least a first variable positive displacement pump wherein the first variable positive displacement pump is actuated by a motor.

Embodiment 31 is a method according to any of Embodiments 29 or 30, wherein the handheld device further comprises an outlet manifold, wherein the at least two flexible containment vessels are fluidly connected to the outlet manifold.

Embodiment 32 is a method according to any of Embodiments 29 to 31, wherein the handheld device further comprises a mixing tip comprising a dispensing end and designed to receive part 1 and part 2 from the at least two adhesive delivery channels, mix at least part 1 and part 2 together and dispense the adhesive through the dispensing end.

Embodiment 33 is a method according to any of Embodiments 29 to 32, wherein when in operation, the at least Part 1, Part 2, or mixtures thereof are only in contact with the at least two flexible containment vessels, the outlet manifold, the at least two adhesive delivery channels and the mixing tip, wherein the at least one variable positive displacement pump forces the at least Part 1 and at least Part 2 respectively through the first adhesive delivery channel and the second adhesive delivery channel between the outlet manifold and the dispensing end of the mixing tip.

Embodiment 34 is a property sensor (1) for determining a property value of a property of a liquid (10), such as a two-component curable adhesive, the property sensor comprising
a) a channel (20) comprising a sensing zone (50) through which—in use—the liquid flows;
b) two electrodes (30, 40) for generating an electric field of one or more sensing frequencies in the sensing zone;
c) a data storage device (230) comprising a pre-stored set of calibration data representing calibration impedance responses measured previously at the one or more sensing frequencies and at different property values of the property of an identical liquid; and
d) a property value deriver (220), electrically connected to the electrodes (30, 40), and operable to repeatedly
   i) generate, while the liquid (10) flows through the sensing zone (50), between the electrodes (30, 40) an electric field of the one or more sensing frequencies in the sensing zone;
   ii) sense between the electrodes (30, 40), at the one or more sensing frequencies, while the liquid (10) flows through the sensing zone (50) and while the electric field is present, a response impedance;
   iii) derive from the response impedance a property value of the property of the liquid (10), using the pre-stored set of calibration data representing calibration impedance responses.

Embodiment 35 is a property sensor according to any of the preceding Embodiments, wherein the channel (20) comprises a first longitudinal section (180) having a first open cross section available for the flow of the liquid (10), and a second longitudinal section (260), downstream from the first longitudinal section (180), having a second open cross section available for the flow of the liquid, wherein the second open cross section is larger than the first open cross section, and wherein the sensing zone (50) is comprised in the second longitudinal section (260).

Embodiment 36 is a property sensor according to any of the preceding Embodiments, wherein one or both of the electrodes (30, 40) is/are arranged such as to be in contact with the liquid (10) when the liquid flows through the sensing zone (50).

Embodiment 37 is a property sensor according to any of the preceding Embodiments, wherein the sensing zone (50) is arranged between the electrodes (30, 40).

Embodiment 38 is a property sensor according to any of the preceding Embodiments, wherein the channel (20) comprises a bypass (290, 310), arranged such that a first portion (270) of the liquid (10) flows through the sensing zone (50), and a second portion (280, 300) of the liquid flows through the bypass (290, 310) bypassing the sensing zone.

Embodiment 39 is a property sensor according to any of the preceding Embodiments, wherein one of the electrodes (30, 40) is arranged between the sensing zone (50) and the bypass (290, 310).

Embodiment 40 is a property sensor according to any of the preceding Embodiments, further comprising a temperature sensor (350) for sensing a temperature of the liquid (10) in the channel (20) or in the sensing zone (50).

Embodiment 41 is a property sensor according to any of the preceding Embodiments, further comprising a flow speed sensor (360) for sensing a flow speed of the liquid (10) through the channel (20) or through the sensing zone (50).

Embodiment 42 is a sensored mixer, comprising a mixing device (120) for mixing two or more components (A, B) to produce a mixed liquid (10) at a mixer output (170), and a property sensor (1) according to any one of the preceding claims, in fluid communication with the mixer output (170) such that the mixed liquid (10) can flow from the mixer output (170) through the sensing zone (50).

Embodiment 43 is a process of determining a property value of a property of a liquid (10), comprising the steps, in this sequence, of
i) providing a liquid (10) and a property sensor (1) according to any one of claims 1 to 8, and having the liquid (10) flow through the sensing zone (50);
ii) generating, while the liquid (10) flows through the sensing zone (50), between the electrodes (30, 40) an electric field of the one or more sensing frequencies in the sensing zone (50);
iii) sensing between the electrodes (30, 40), at the one or more sensing frequencies, while the liquid (10) flows through the sensing zone (50) and while the electric field is present, a response impedance;
iv) deriving from the response impedance a property value of the property of the liquid (10), using the pre-stored set of calibration data representing calibration impedance responses.

Embodiment 44 is a process according to any of the preceding Embodiments, wherein at least one of the one or more sensing frequencies is a frequency of between 1 Hertz and 10000 Hertz, and wherein the amplitude of the electric field is between 100 Volt per meter and 20000 Volt per meter.

Embodiment 45 is a process according to any of the preceding Embodiments, wherein the liquid (10) is an adhesive or a curable adhesive or a two-component adhesive or a multi-component adhesive or a curable two-component adhesive.

Embodiment 46 is a process according to any of the preceding Embodiments, wherein the liquid (10) has a dynamic viscosity of between 10 Pascalseconds and 40,000.0 Pascalseconds, measured at 25° C. according to standard ASTM D7042-12a in its version in force on 1 Jul. 2020.

Embodiment 47 is a set of calibration data representing calibration impedance responses for use in the process according to any of the preceding Embodiments, wherein the set of calibration data further represents a property value of a property of a calibration liquid at which property value one of the calibration impedance response was sensed.

Embodiment 48 is a set of calibration data representing calibration impedance responses according to any of the preceding Embodiments, wherein the set of calibration data further represents a sensing frequency at which sensing frequency one of the calibration impedance responses was sensed, and/or wherein the set of calibration data further represents a temperature of the liquid (10) in the sensing zone (50) at which temperature one of the calibration impedance responses was sensed.

Embodiment 49 comprises a system for dispensing an adhesive, the system comprising: a chamber that holds at least two flexible containment vessels, the at least two flexible containment vessels holding at least a Part 1 and a Part 2; at least two adhesive delivery channels, a first adhesive delivery channel connected to the containment vessel to receive Part 1 and a second adhesive delivery channel connected to the containment vessel to receive Part 2; a motor; at least a first variable positive displacement pump wherein the first variable positive displacement pump is actuated by the motor; and a mixing tip designed to receive Part 1 and Part 2 from the at least two adhesive delivery channels, mix at least Part 1 and Part 2 together and dispense the adhesive through a dispensing end, wherein when in operation, the at least Part 1, Part 2, or mixtures thereof are only in contact with the at least two flexible containment vessels, the at least two adhesive delivery channels and the mixing tip, wherein the at least one variable positive displacement pump forces the at least Part 1 and at least Part 2 respectively through the first adhesive delivery channel and the second adhesive delivery channel to the dispensing end of the mixing tip.

Embodiment 50 is a system according to Embodiment 49 further comprising a compressive element configured to apply external positive pressure to the at least two flexible containment vessels in the chamber to force the part 1 and part 2 from the at least two flexible containment vessels through the adhesive delivery channel.

Embodiment 51 is a system according to any of the preceding Embodiments, wherein the chamber holds more than two flexible containment vessels, or even four flexible containment vessels.

Embodiment 52 is a system according to any of the preceding Embodiments, wherein the chamber further comprises an outlet manifold, wherein the at least two flexible containment vessels are fluidly connected to the outlet manifold.

Embodiment 53 is a system according to any of the preceding Embodiments further comprising a compressive element that applies uniform pressure over the entire surfaces of the at least two flexible containment vessels.

Embodiment 54 is a system according to any of the preceding Embodiments, wherein the amount of pressure applied and dimensions of the outlet manifold are designed so that negative pressure is not needed to meter and flow Part 1 and Part 2 from the first and second flexible containment vessels.

Embodiment 55 is a system according to any of the preceding Embodiments, wherein there is a linear relationship between flow rate in milliliters (mL)/second(s) (ml/s) versus pressure (Bars).

Embodiment 56 is a system according to any of the preceding Embodiments, the chamber further comprising pressure transducers to control and maintain desired pressure in the chamber during use of the system.

Embodiment 57 is a system according to any of the preceding Embodiments, wherein the first adhesive delivery channel and the second adhesive delivery channel comprise a first and a second tube respectively upon with the at least first variable positive displacement pump acts.

Embodiment 58 is a system according to any of the preceding Embodiments, wherein the relative ratios of the inner diameters of the first and second tubes can be changed to allow for different ratios of Part 1 and Part 2, respectively.

Embodiment 59 is a system according to any of the preceding Embodiments, wherein the outer wall thickness of the first and second tubes are constant.

Embodiment 60 is a system according to any of the preceding Embodiments, wherein the outer wall thickness of the first and second tubes vary.

Embodiment 61 is a system according to any of the preceding Embodiments, wherein the first and second tube always have at least one section completely squeezed shut to prevent back flow during operation of the at least first variable positive displacement pump.

Embodiment 62 is a system according to any of the preceding Embodiments, wherein dispensing is prevented when the pump is not acting upon the first and second tube.

Embodiment 63 is a system according to any of the preceding Embodiments, wherein the first and second tubes are constrained by a first and second tube holder in the at least first variable positive displacement pump when acted upon by the pump.

Embodiment 64 is a system according to any of the preceding Embodiments, wherein the first and second tubes are acted upon by a compression element.

Embodiment 65 is a system according to any of the preceding Embodiments, further comprising a second variable positive displacement pump to act on the second adhesive delivery channel.

Embodiment 66 is a system according to any of the preceding Embodiments, wherein a metering element controls the first and the second variable positive displacement pumps and the metering element is controlled by an electronic processor.

Embodiment 67 is a system according to any of the preceding Embodiments, wherein the variable positive displacement pump(s) are selected from: rotary peristaltic pumps, linear peristaltic pumps, rotary lobe pumps, progressive cavity pumps, rotary gear pumps, piston pumps, diaphragm pumps, screw pumps, gear pumps, hydraulic pumps, and rotary vane pumps.

Embodiment 68 is a system according to any of the preceding Embodiments, wherein the variable positive displacement pump(s) are a linear peristaltic pump.

Embodiment 69 is a system according to any of the preceding Embodiments, wherein the linear peristaltic pump comprises a cam shaft driven by the at least one motor through the center of a housing that rotates to actuate moving elements within.

Embodiment 70 is a system according to any of the preceding Embodiments, wherein the moving elements are disks.

Embodiment 71 is a system according to any of the preceding Embodiments, wherein there is a small overlap in adjacent disks to prevent loss of pressure/leak through the first and second adhesive delivery channels.

Embodiment 72 is a system according to any of the preceding Embodiments, wherein there is at least three disks, at least 5 disks, at least 8 disks, or at least 10 disks.

Embodiment 73 is a system according to any of the preceding Embodiments, wherein a single revolution of the shaft presses all of the disks against the tubes.

Embodiment 74 is a system according to any of the preceding Embodiments, wherein the moving elements are flexible spring members.

Embodiment 75 is a system according to any of the preceding Embodiments, wherein the cam shaft of the linear peristaltic pump acts on the tube(s).

Embodiment 76 is a kit for dispensing multipart structural adhesives, the kit comprising: a system according to any of the preceding Embodiments; and at least a first flexible containment vessel holding a Part 1 composition and a second flexible containment vessel holding a Part 2 composition of a multipart structural adhesive, wherein the amounts, ratios, or both of the Part 1 and the Part 2 are controlled by the dispenser, and wherein the amounts, ratios, or both of the Part 1, and the Part 2 affect one or more properties of the multipart structural adhesive composition.

Embodiment 77 is a kit according to any of the preceding Embodiments further comprising alternative Part 1 compositions, alternative Part 2 compositions, or both.

Embodiment 78 is a kit according to any of the preceding Embodiments further comprising sub-Part 1 compositions, sub-Part 2 compositions, or both.

Embodiment 79 is a kit according to any of the preceding Embodiments further comprising alternative Part 1 compositions, alternative Part 2 compositions, sub-Part 1 compositions, sub-Part 2 compositions, or some combination thereof.

Embodiment 80 is a kit according to any of the preceding Embodiments, wherein the flexible containment vessels comprise a flexible laminate.

Embodiment 81 is a kit according to any of the preceding Embodiments, wherein the flexible containment vessels are continuous with the adhesive delivery channels.

Embodiment 82 is a kit according to any of the preceding Embodiments, wherein the adhesive delivery channels comprise a flexible laminate.

Embodiment 83 is a kit according to any of the preceding Embodiments, wherein the flexible laminate comprises structural layers, moisture blocking layers, UV resistant layers, or combinations thereof.

Embodiment 84 is a kit according to any of the preceding Embodiments, wherein the flexible containment vessels are refillable via application of negative pressure by a compressive element.

Embodiment 85 is a method of tuning one or more properties of a multipart structural adhesive composition, the method comprising: providing a Part 1 of the multipart structural adhesive via a first processor-controlled delivery mechanism; providing at least a first sub-Part 2 and a second sub-Part 2 of the multipart structural adhesive via at least a second processor-controlled delivery mechanism; and causing to be formed the multipart structural adhesive by combining the Part 1, the first sub-Part 2, and the second sub-Part 2, wherein the amount, ratio, or both of the first sub-Part 2 and the second sub-Part 2 impact the one or more properties of the multipart structural adhesive composition, wherein the amounts or ratios of the Part 1, the first sub-Part 2 and the second sub-Part 2 affect the one or more properties of the multipart structural adhesive composition, and wherein the multipart structural adhesive has an overlap shear strength of at least about 0.75 MPa (109 psi).

Embodiment 86 is a method according to any of the preceding Embodiments, wherein the amount, ratio, or both of the first sub-Part 2 and the second sub-Part 2 are determined by a computer PLC based on the desired physical properties of the multipart structural adhesive.

Embodiment 87 is a method according to any of the preceding Embodiments, wherein the amount, ratio, or both of the first sub-Part 2 and the second sub-Part 2 is determined by AI/ML based on DOE or Neural Network Modelling results.

Embodiment 88 is a method according to any of the preceding Embodiments, wherein the first sub-Part 2 and the second sub-Part 2 are combined to form a Part 2 before being combined with the Part 1.

Embodiment 89 is a method according to any of the preceding Embodiments, wherein the first sub-part 2 and the second sub-Part 2 are mixed in a mixing nozzle.

Embodiment 90 is a method according to any of the preceding Embodiments, wherein the Part 1, the first sub-Part 2 and the second sub-Part 2 are simultaneously combined.

Embodiment 91 is a method according to any of the preceding Embodiments, wherein the Part 1 was formed from a first sub-Part 1 and a second sub-Part 1.

Embodiment 92 is a method according to any of the preceding Embodiments, wherein the first sub-Part 1, the second sub-Part 1, and the Part 2 are simultaneously combined.

Embodiment 93 is a method according to any of the preceding Embodiments, wherein the ratio of the first sub-Part 2 to the second sub-Part 2 is from 100:1 to 1:1, from 10:1 to 1:1, from 4:1 to 1:1, or even from 2:1 to 1:1.

Embodiment 94 is a method according to any of the preceding Embodiments, wherein the ratio of the first sub-Part 1 to the second sub-Part 1 is from 100:1 to 1:1, from 10:1 to 1:1, from 4:1 to 1:1, or even from 2:1 to 1:1.

Embodiment 95 is a method according to any of the preceding Embodiments, wherein the ratio of the Part 1 to the Part 2, the ratio of the first sub-Part 1 to the second sub-Part 1, the ratio of the first sub-Part 2 to the second sub-Part 2, or any combination thereof is controlled by a PLC controller.

Embodiment 96 is a method according to any of the preceding Embodiments further comprising adding one or more additives to the one or more of the Part 1, the Part 2, the first sub-Part 2, the second sub-Part 2, the first sub-Part 1, the second sub-Part 2, or any combination thereof.

Embodiment 97 is a method according to any of the preceding Embodiments, wherein the additive is selected from: UV Stabilizers, Antioxidants, color/pigments, impact modifiers and other modifiers, plasticizers, fillers, and any combination thereof.

Embodiment 98 is a method according to any of the preceding Embodiments, wherein the Part 1 comprises a curable resin and the Part 2 comprises a curing agent.

Embodiment 99 is a method according to any of the preceding Embodiments, wherein the Part 1 comprises a curing agent and the Part 2 comprises a curable resin.

Embodiment 100 is a method according to any of the preceding Embodiments, wherein the one or more properties to be impacted is work life, shelf life, pot life, elastic modulus, shear strength, rate of strength build up, structural strength, overlap shear strength, adhesion, elongation, creep resistance, impact resistance, temperature performance, moisture resistance, color, or some combination thereof.

Embodiment 101 is a method according to any of the preceding Embodiments, wherein the one or more properties to be impacted is work life.

Embodiment 102 is a method according to any of the preceding Embodiments, wherein the one or more properties to be impacted is work life and it is being extended.

Embodiment 103 is a method according to any of the preceding Embodiments, wherein the ratio of Part 1 to the combination of the first sub-Part 2 and the second sub-Part 2 is from 100:1 to 1:1, from 10:1 to 1:1, from 4:1 to 1:1, or even from 2:1 to 1:1.

Embodiment 104 is a method according to any of the preceding Embodiments, wherein the structural adhesive composition is a multipart epoxy adhesive, a multipart methyl methacrylate adhesive, a multipart urethane adhesive, or a multipart silicone structural adhesive.

Embodiment 105 is a method according to any of the preceding Embodiments, wherein the Part 1 comprises an epoxy curable resin and the Part 2 comprises an amine curing agent.

Embodiment 106 is a method according to any of the preceding Embodiments, wherein the Part 1 comprises an amine curing agent and the Part 2 comprises an epoxy resin.

### EXAMPLES

The following illustrative examples may aid in understanding the disclosure. However, the disclosure is not necessarily limited to these examples. Embodiments and concepts that are not specifically exemplified may have been disclosed.

Unless otherwise noted, all parts, percentages, ratios, etc. in the examples and the rest of the specification are by weight, and all materials used in the examples were obtained, or are available, from general suppliers such as, for example, Georgia-Pacific, Atlanta, GA, US. The following abbreviations are used herein: g=grams, kg=kilograms, m=meters, in=inches, μm=microns=10-6 m, min=minutes, hr=hours, kPa=kilopascals, MPa=megaPascals, J=Joules,° C.=degrees Celsius, psi=pounds per square inch.

Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows. All references cited in this disclosure are herein incorporated by reference in their entirety.

TABLE 1
Materials

| Abbreviation | Description and Source |
|---|---|
| SR349 | Ethoxylated (3) Bisphenol A Diacrylate, obtained from Sartomer Europe, |
| | Colombes Cedex, France, under the trade designation SR349. |
| SR351 | Trimethyloylpropane Triacrylate, obtained from Sartomer Europe, |
| | Colombes Cedex, France, under the trade designation SR351. |
| SR602 | Ethoxylated (10) Bisphenol A Diacrylate, obtained from Sartomer Europe, |
| | Colombes Cedex, France, under the trade designation SR602. |
| SR9035 | Ethoxylated (15) Trimethyloylpropane Triacrylate, obtained from Sartomer |
| | Europe, Colombes Cedex, France, under the trade designation SR9035. |
| AEP | 1-(2-Aminoethyl)piperazine, obtained from Huntsman Advanced Materials |
| | (Europe) BVBA, Bergkamen, Germany. |
| Epikote 828 | Bisphenol A diglycidyl ether, obtained from Hexion Specialty Chemicals |
| | GmbH, Duisburg, Germany, under the trade designation Epikote 828. |
| ACMBA349 | Acrylate-based masterbatch prepared from SR349 and AEP |
| ACMBA351 | Acrylate-based masterbatch prepared from SR351 and AEP |
| ACMBA602 | Acrylate-based masterbatch prepared from SR602 and AEP |
| ACMBA9035 | Acrylate-based masterbatch prepared from SR9035 and AEP |

### Testing Methods

### Gel Time

Gel times were measured at 25° C. (77° F.). with an ARES LS2 rheometer (TA Instruments), using a parallel plate configuration with 25 mm (0.984 inch) diameter plates and a 0.5 mm (0.0197 inch) gap. Measurements were made in dynamic mode at 1 Hz, starting at 5% strain. The autotension and autostrain settings were used to control the gap and torque during the measurement. After applying samples directly to the bottom plate, the gap was set and the test was started within 30 seconds. The time to reach the crossover point, i.e., the point where the storage modulus (G′) value became greater than the loss modulus (G″) value, was reported as the gel time.

### Overlap Shear Adhesion

Test panels measuring 2.5 cm wide by 10.2 cm long (1 inch by 4 inches) of several different materials were used to evaluate overlap shear adhesion. The bonding surfaces of the panels were cleaned by lightly abrading them using a 3M SCOTCH-BRITE No. 86 scouring pad (green colored), followed by an isopropyl alcohol wipe to remove any loose debris. A bead of adhesive was then dispensed along one end of a test panel, about 6.4 mm (0.25 inch) from the end. The panels were joined together face to face along their length to provide an overlap bond area measuring approximately 1.3 cm long and 2.5 cm wide (0.5 inch by 1 inch). A uniform bond line thickness was provided by sprinkling a small amount of 0.2 mm (0.008 inch) diameter solid glass beads on the adhesive before joining the two test panels together. The bonded test panel samples were allowed to dwell at 23° C. (73.4° F.) . . . (room temperature) for at least 48 hours to ensure full cure of the adhesive. The samples were tested at 22° C. (71.6° F.). for peak overlap shear strength at a separation rate of 2.5 mm/minute (0.1 inch/minute). The reported values represent the average of three samples.

### Rate of Strength Buildup

Six aluminum test panels measuring 10.2 cm long by 2.5 cm wide by 1.6 mm thick ((4 inches by 1 inch by 0.063 inch) were cleaned and bonded as described above in the Overlap Shear Adhesion Test Method with the following modification. Spacer beads having a diameter of between 0.08 and 0.13 mm (0.003 and 0.005 inches) were used to control the bond line thickness. The bonded test panels were held at room temperature (23° C. or 73.4° F.) and evaluated for overlap shear strength at periodic intervals from the time the bonds were made.

### Tensile Test According to DIN EN ISO 527

Tensile Test for the determination of the elongation at break of the uncured structural adhesive film. Sample preparation:

For the preparation of tensile-elongation experiments, the readily mixed curable compositions were transferred into a single-use syringe in such a way, that air entrapments were prevented. Subsequently, the reactive mass was transferred into a negative mold made from PTFE by injection. The mold was machine drilled to the specimen dimensions given in DIN EN ISO 527-2:2012 under 1A on page 7. The curable compositions were allowed to cure for seven days at 23° C. (73.4° F.) before the mold was opened and the specimen were removed.

### Sample Testing:

The tensile test was performed on a tensile testing machine Zwick Z050 bearing a 50 kN (11,240 lbs) load cell, which was equipped with self-tightening clamping jaws. The specimen was clamped in the jaws of the tensile machine, with a gap of L₀=115 mm (4.53 inches), the upper jaw first, followed by the lower one. The testing speed was 10 mm/min (0.394 inches/min). For the monitoring of the elongation of the specimen, an extensometer was used which was set to a measuring length of 50 mm (1.97 inches). The end of the measurement was set to the point where the current force measured by load cell has reached 94% of the maximum force (Fₘₐₓ) measured so far. At this point, the maximum elongation (eₘₐₓ) was recorded as eₘₐₓ=DL₀/L₀ and the maximum tensile stress as s=Fₘₐₓ/A (with A=4 mm*10 mm=40 mm² for DIN EN ISO 527-1A specimen). Additionally, in the early stages of the measurement, the tensile modulus was determined as Et=(s2−s1)/(e2−e1) with e1=0.05% and e2=0.25% as well as s1 and s2 being the stress values measured at e1 and e2 respectively.

### EXAMPLES

Example 1: Table 2 below is based on using two Part As formulated to have a different Work Life (WL). One Part A identified as Sub-Part 1 has a short 2 minute WL and the other identified as Sub-Part 2 has a longer 60 minute WL. The average weight % of the catalyst or accelerator in each Sub-Part A is used to control the working life of the structural adhesive formed using it. The average catalyst level based on volumetrically mixing different amounts of the two Sub-Part As will control the Working Life of a final structural adhesive formed therefrom. These two different Sub-Part A formulations could easily be blended together volumetrically to give a specific WL based on the desired application requirements from 2 minutes to 60 minutes. Once blended and mixed thoroughly, the Part B could be volumetrically dispensed and mixed with the blended two Sub-Part As using an Automated, Robotic Dispensing Equipment.

TABLE 2
Volumetric Blending of Two Sub-Part As to Affect
Work Life of a 2K Structural Adhesive
Volumetric Blending two Sub-Part As to Customize
Work Life of a 2K Structural Adhesive

| | | Two Part Structual |
|---|---|---|
| Part A (Sub-Part 1) | Part A (Sub-Part 2) | Adhesive Estimated |
| (2 min Work Life) | (60 min Work Life) | Work Life (minutes) |
| 100% | 0% | 2 |
| 90% | 10% | 7.8 |
| 80% | 20% | 13.6 |
| 70% | 30% | 19.4 |
| 60% | 40% | 25.2 |
| 50% | 50% | 31 |
| 40% | 60% | 36.8 |
| 30% | 70% | 42.6 |
| 20% | 80% | 48.4 |
| 10% | 90% | 54.2 |
| 0% | 100% | 60 |

### Example 2

### Preparatory Examples

About 300 g (0.66 lbs) of the acrylate-based master batches of accelerators (ACMBA) used here were produced by slowly adding the respective acrylate to the full amount of 1-(2-Aminoethyl) piperazine (AEP) while stirring using a blade stirrer in a 500 mL (0.528 quart) glass container. The addition was conducted in such way, that the overall temperature of the ACMBA was not exceeding 40° C. (104° F.). At the end of the acrylate addition, the mixture was stirred for 60 minutes at room temperature to ensure the full conversion of the reactants.

TABLE 3
Preparation of different ACMBA from
AEP and the respective acrylates

| | | acrylate | |
|---|---|---|---|
| | acrylate | amount | AEP |
| | type | (grams) | (grams) |
| ACMBA349 | SR349 | 193.39 | 106.61 |
| ACMBA351 | SR351 | 130.01 | 169.99 |
| ACMBA602 | SR602 | 225.15 | 74.85 |
| ACMBA9035 | SR9035 | 213.55 | 86.45 |

### Examples

To prepare the described two-part (2K) curable Structural Adhesive compositions, the amounts and type of ACMBA, as given in Table 4, were combined in a 150 mL (0.159 quart) plastic cup and then mixed using a Hauschild SpeedMixer DAC 150.1 FVZ at 3500 rpm for 1 minute to yield thoroughly mixed material.

TABLE 4
Preparation of curable compositions from epoxy resin and ACMBA

| | Epikote | | Amount of |
|---|---|---|---|
| | 828 | | ACMBA |
| | (grams) | ACMBA type | (grams) |
| Example 1 | 30.69 | SR349 | 29.31 |
| Example 2 | 37.52 | SR351 | 22.48 |
| Example 3 | 25.42 | SR602 | 34.58 |
| Example 4 | 27.55 | SR9035 | 32.45 |
| Example 5 | 30.00 | SR349/SR602 | 12.50/17.50 |
| Example 6 | 31.80 | SR351/SR9035 | 9.41/18.82 |

TABLE 5
Results of tensile testing following DIN EN ISO 527

| | tensile | tensile | max. |
|---|---|---|---|
| | modulus | stress s | elongation |
| | Et [MPa] | [MPa] | e [%] |
| Example 1 | 3577 | 23.9 | 0.7 |
| Example 2 | 3410 | 43.7 | 1.3 |
| Example 3 | 230 | 14.3 | 55.0 |
| Example 4 | 6 | 3.52 | 57.3 |
| Example 5 | 1300 | 25.3 | 1.5 |
| Example 6 | 1550 | 35.5 | 2.3 |

What is claimed is:

1. A method of tuning one or more properties of a multipart structural adhesive composition, the method comprising:
providing a Part 1 of the multipart structural adhesive;
providing at least a first sub-Part 2 and a second sub-Part 2 of the multipart structural adhesive; and
causing to be formed the multipart structural adhesive by combining the Part 1, the first sub-Part 2, and the second sub-Part 2, wherein the amount, ratio, or both of the first sub-Part 2 and the second sub-Part 2 impact the one or more properties of the multipart structural adhesive composition, wherein the amounts or ratios of the Part 1, the first sub-Part 2 and the second sub-Part 2 affect the one or more properties of the multipart structural adhesive composition, and wherein the multipart structural adhesive has an overlap shear strength of at least about 0.75 MPa (109 psi).

2. The method of claim 1, wherein the first sub-Part 2 and the second sub-Part 2 are combined to form a Part 2 before being combined with the Part 1.

3. The method according to claim 2, wherein the first sub-Part 2 and the second sub-Part 2 are combined to form the Part 2 in automated dispensing equipment or a handheld dispenser.

4. (canceled)

5. The method of claim 2, wherein the first sub-Part 2 and the second sub-Part 2 are mixed in a mixing nozzle.

6. The method according to claim 1, wherein the Part 1 and the Part 2 are combined in automated dispensing equipment or a handheld dispenser.

7. (canceled)

8. The method of claim 1, wherein the Part 1, the first sub-Part 2 and the second sub-Part 2 are simultaneously combined.

9. The method according to claim 8, wherein the Part 1, the first sub-Part 2 and the second sub-Part 2 are combined in automated dispensing equipment or a handheld dispenser.

10. (canceled)

11. The method of claim 1, wherein the Part 1 comprises a first sub-Part 1 and a second sub-Part 1.

12. The method of claim 11, wherein the first sub-Part 1, the second sub-Part 1, and the Part 2 are simultaneously combined.

13. The method according to claim 12, wherein the first sub-Part 1, the second sub-Part 1, and the Part 2 are combined to form the structural adhesive in automated dispensing equipment or a handheld dispenser.

14. (canceled)

15. The method according to claim 1, wherein the ratio of the first sub-Part 2 to the second sub-Part 2 is from 100:1 to 1:1, from 10:1 to 1:1, from 4:1 to 1:1, or even from 2:1 to 1:1.

16. The method according to claim 11, wherein the ratio of the first sub-Part 1 to the second sub-Part 1 is from 100:1 to 1:1, from 10:1 to 1:1, from 4:1 to 1:1, or even from 2:1 to 1:1.

17-19. (canceled)

20. The method according to claim 1, wherein the Part 1 comprises a curable resin and the Part 2 comprises a curing agent.

21. The method according to claim 1, wherein the Part 1 comprises a curing agent and the Part 2 comprises a curable resin.

22. The method according to claim 1, wherein the one or more properties to be impacted is work life, shelf life, pot life, elastic modulus, shear strength, rate of strength build up, structural strength, overlap shear strength, adhesion, elongation, creep resistance, impact resistance, temperature performance, moisture resistance, color, or some combination thereof.

23. The method according to claim 1, wherein the one or more properties to be impacted is work life.

24. (canceled)

25. The method according to claim 1, wherein the ratio of Part 1 to the combination of the first sub-Part 2 and the second sub-Part 2 is from 100:1 to 1:1, from 10:1 to 1:1, from 4:1 to 1:1, or even from 2:1 to 1:1.

26. The method according to claim 1, wherein the structural adhesive composition is a multipart epoxy adhesive, a multipart methyl methacrylate adhesive, a multipart urethane adhesive, or a multipart silicone structural adhesive.

27. The method according to claim 1, wherein the Part 1 comprises an epoxy curable resin and the Part 2 comprises an amine curing agent.

28. The method according to claim 1, wherein the Part 1 comprises an amine curing agent and the Part 2 comprises an epoxy resin.

29-33. (canceled)
